(19) United States
(12) Patent Application Publication
(10) Pub. No.: US 2016/0258824 A1
(43) Pub. Date: Sep. 8, 2016

(54) STRAIN SENSING ELEMENT, PRESSURE SENSOR, AND MICROPHONE

(71) Applicant: KABUSHIKI KAISHA TOSHIBA, Tokyo (JP)

(72) Inventors: Yoshihiko FUJI, Kawasaki (JP); Akio HORI, Kawasaki (JP); Kei MASUNISHI, Kawasaki (JP); Hideaki FUKUZAWA, Kawasaki (JP); Akiko YUZAWA, Kawasaki (JP); Kazuaki OKAMOTO, Yokohama (JP)

(21) Appl. No.: 14/925,494

(22) Filed: Oct. 28, 2015

(30) Foreign Application Priority Data
Mar. 2, 2015 (JP) 2015-040462

(51) Int. Cl. G01L 1/12

(52) U.S. Cl. CPC G01L 1/12

(57) ABSTRACT

According to one embodiment, a strain sensing element provided at a deformable film part, includes a stacked body, a first electrode, and a second electrode. The stacked body includes a first magnetic layer, a second magnetic layer, and an intermediate layer provided between the first magnetic layer and the second magnetic layer. A magnetization direction of the first magnetic layer changes in accordance with a deformation of the film part. The first electrode includes a first alloy layer including a first alloy including Ta and Mo. The first electrode is electrically connected to the stacked body. The second electrode is electrically connected to the stacked body.

### CROSS-REFERENCE TO RELATED APPLICATIONS

This application is based upon and claims the benefit of priority from Japanese Patent Application No. 2015-040462, filed on Mar. 2, 2015; the entire contents of which are incorporated herein by reference.

### FIELD

Embodiments described herein relate generally to a strain sensing element, a pressure sensor and a microphone.

### BACKGROUND

Pressure sensors using MEMS (microelectromechanical systems) technology include e.g. those of piezoresistance change type and of capacitance type. On the other hand, pressure sensors using spin technology have been proposed. The pressure sensor using spin technology senses resistance change depending on strain. A high-sensitivity pressure sensor using spin technology is desired.

### BRIEF DESCRIPTION OF THE DRAWINGS

FIG. 1 is a schematic cross-sectional view showing a pressure sensor according to the first embodiment;

FIG. 2 is a schematic perspective view showing the strain sensing element according to the first embodiment;

FIG. 3A to FIG. 3E are schematic views showing the operation of the strain sensing element according to the first embodiment;

FIG. 4A to FIG. 4C are schematic perspective views showing g a strain sensing element according to the first embodiment;

FIG. 5 is a schematic perspective view showing a pressure sensor according to the first embodiment;

FIG. 6 is a schematic sectional view showing the pressure sensor according to the first embodiment;

FIG. 7A to FIG. 7F are schematic plan views showing pressure sensors according to the first embodiment;

FIG. 8 is a schematic perspective view showing a model used for simulation;

FIG. 9 is a graph showing the simulation result;

FIG. 10 is a contour diagram showing the simulation result;

FIG. 11A to FIG. 11E are schematic plan views showing alternative pressure sensors according to the first embodiment;

FIG. 12A to FIG. 12D are schematic views showing the wiring pattern of the strain sensing elements according to the first embodiment;

FIG. 13A to FIG. 13E are schematic perspective views showing a method for manufacturing a pressure sensor according to the embodiment;

FIG. 14A to FIG. 14D are schematic sectional views showing the operation of the pressure sensor;

FIG. 15A to FIG. 15D are schematic views showing a pressure sensor used for simulation;

FIG. 16A to FIG. 16F are graphs showing the simulation result of the characteristic of the pressure sensors;

FIG. 17 is a graph showing the simulation result of the characteristic of the pressure sensor;

FIG. 18 shows a table showing the characteristics of materials of the electrode;

FIG. 19 is a graph showing the characteristic of the electrode of the strain sensing element;

FIGS. 20A and 20B are schematic perspective views showing part of a strain sensing element according to a second embodiment;

FIG. 21 is a graph showing the characteristic of the strain sensing element;

FIG. 22 is a graph showing the X-ray diffraction result of the stacked body used for the strain sensing element;

FIG. 23 is a schematic perspective view showing a strain sensing element according to the third embodiment;

FIG. 24 is a schematic sectional view showing part of the strain sensing element according to the third embodiment;

FIG. 25 is a schematic sectional view showing part of the strain sensing element according to the third embodiment;

FIG. 26 is a schematic sectional view showing the strain sensing element according to the third embodiment;

FIG. 27A to FIG. 27C are schematic views showing a method for asperities;

FIG. 28 is a schematic view showing the method of the experiment;

FIG. 29 is a schematic view showing the method of the experiment;

FIG. 30 is a schematic perspective view showing the sample used for the experiment;

FIG. 31 is a schematic perspective view showing the sample used for the experiment;

FIG. 32 is a graph showing the characteristic of the sample;

FIG. 33 is a graph showing the characteristic of the sample;

FIG. 34 is a graph showing the characteristic of the sample;

FIG. 35 is a graph showing the characteristic of the sample;

FIG. 36 is a graph showing the characteristic of the sample;

FIG. 37 is a graph showing the characteristic of the sample;

FIG. 38A to FIG. 38D are transmission electron micrographs of the sample;

FIG. 39A to FIG. 39D are transmission electron micrographs of the sample;

FIG. 40A and FIG. 40B are schematic views showing the composition of the sample;

FIG. 41A and FIG. 41B are schematic views showing the composition of the sample;

FIG. 42 is a graph showing the relationship between the coercivity and the gauge factor;

FIG. 43 is schematic sectional view showing the sample used for the experiment;

FIG. 44 is schematic sectional view showing the sample used for the experiment;

FIG. 45 is schematic sectional view showing the sample used for the experiment;

FIG. 46A to FIG. 46F are graphs showing the characteristics of the samples;

FIG. 47 is a transmission electron micrograph of the sample;

FIG. 48 is a transmission electron micrograph of the sample;

FIG. 49 is a transmission electron micrograph of the sample;

FIG. 50A and FIG. 50B are graphs showing the characteristics of the samples;

FIG. 51A and FIG. 51B are graphs showing the characteristics of the samples;

FIG. 52 is a graph showing the characteristic of the samples;

FIG. 53 is a graph showing the characteristic of the samples;

FIG. 54 is a graph showing the characteristic of the samples;

FIG. 55 is a graph showing the characteristic of the sample;

FIG. 56 is a graph showing the characteristic of the sample;

FIG. 57 is a schematic perspective view showing the sample used for the experiments;

FIG. 58 is a schematic perspective view showing the sample used for the experiments;

FIG. 59 is a graph showing the characteristic of the samples;

FIG. 60 is a graph showing the characteristic of the samples;

FIG. 61 is a schematic sectional view showing part of an alternative strain sensing element according to the third embodiment;

FIG. 62 is a schematic sectional view showing part of an alternative strain sensing element according to the third embodiment;

FIG. 63 is a schematic perspective view showing a strain sensing element according to the embodiment;

FIG. 64 is a schematic perspective view showing a strain sensing element according to the embodiment;

FIG. 65 is a schematic perspective view showing a strain sensing element according to the embodiment;

FIG. 66 is a schematic perspective view showing a strain sensing element according to the embodiment;

FIG. 67 is a schematic perspective view showing a strain sensing element according to the embodiment;

FIG. 68A to FIG. 68D are schematic views showing the operation of the strain sensing element according to the embodiment;

FIG. 69 is a schematic perspective view showing a strain sensing element according to the embodiment;

FIG. 70 is a schematic perspective view showing a pressure sensor according to the fourth embodiment;

FIG. 71 is a block diagram showing the pressure sensor according to the fourth embodiment;

FIG. 72 is a block diagram showing the pressure sensor according to the fourth embodiment;

FIG. 73A and FIG. 73B are schematic views showing a method for manufacturing a pressure sensor according to the fourth embodiment;

FIG. 74A and FIG. 74B are schematic views showing a method for manufacturing a pressure sensor according to the fourth embodiment; FIG. 75A and FIG. 75B are schematic views showing a method for manufacturing a pressure sensor according to the fourth embodiment;

FIG. 76A and FIG. 76B are schematic views showing a method for manufacturing a pressure sensor according to the fourth embodiment;

FIG. 77A and FIG. 77B are schematic views showing a method for manufacturing a pressure sensor according to the fourth embodiment;

FIG. 78A and FIG. 78B are schematic views showing a method for manufacturing a pressure sensor according to the fourth embodiment;

FIG. 79A and FIG. 79B are schematic views showing a method for manufacturing a pressure sensor according to the fourth embodiment;

FIG. 80A and FIG. 80B are schematic views showing a method for manufacturing a pressure sensor according to the fourth embodiment;

FIG. 81A and FIG. 81B are schematic views showing a method for manufacturing a pressure sensor according to the fourth embodiment;

FIG. 82A and FIG. 82B are schematic views showing a method for manufacturing a pressure sensor according to the fourth embodiment;

FIG. 83A and FIG. 83B are schematic views showing a method for manufacturing a pressure sensor according to the fourth embodiment;

FIG. 84A and FIG. 84B are schematic views showing a method for manufacturing a pressure sensor according to the fourth embodiment;

FIG. 85 is a schematic sectional view showing a microphone according to the fifth embodiment;

FIG. 86 is a schematic view showing a blood pressure sensor according to the sixth embodiment;

FIG. 87 is a schematic sectional view showing a blood pressure sensor according to the sixth embodiment;

FIG. 88 is a schematic circuit diagram showing a touch panel according to the seventh embodiment.

### DETAILED DESCRIPTION

According to one embodiment, a strain sensing element provided at a deformable film part, includes a stacked body, a first electrode, and a second electrode. The stacked body includes a first magnetic layer, a second magnetic layer, and an intermediate layer provided between the first magnetic layer and the second magnetic layer. A magnetization direction of the first magnetic layer changes in accordance with a deformation of the film part. The first electrode includes a first alloy layer including a first alloy including Ta and Mo. The first electrode is electrically connected to the stacked body. The second electrode is electrically connected to the stacked body.

According to one embodiment, a pressure sensor includes a film part, a support part, and one or a plurality of strain sensing elements. The support part supports the film part. The strain sensing element is provided at the film part. The strain sensing element includes a stacked body, a first electrode, and a second electrode. The stacked body includes a first magnetic layer, a second magnetic layer, and an intermediate layer provided between the first magnetic layer and the second magnetic layer. A magnetization direction of the first magnetic layer changes in accordance with a deformation of the film part. The first electrode includes a first alloy layer including a first alloy including Ta and Mo. The first electrode is electrically connected to the stacked body. The second electrode is electrically connected to the stacked body.

According to one embodiment, a microphone includes a pressure sensor. The pressure sensor includes a film part, a support part, and one or a plurality of strain sensing elements. The support part supports the film part. The strain sensing element is provided at the film part. The strain sensing element includes a stacked body, a first electrode, and a second electrode. The stacked body includes a first magnetic layer, a second magnetic layer, and an intermediate layer provided between the first magnetic layer and the second magnetic layer. A magnetization direction of the first magnetic layer changes in accordance with a deformation of the film part. The first electrode includes a first alloy layer including a first alloy including Ta and Mo. The first electrode is electrically connected to the stacked body. The second electrode is electrically connected to the stacked body.

Various embodiments will be described hereinafter with reference to the accompanying drawings.

The drawings are schematic or conceptual. The relationship between the thickness and the width of each portion, and the size ratio between the portions, for instance, are not necessarily identical to those in reality. Furthermore, the same portion may be shown with different dimensions or ratios depending on the figures.

In this specification and the drawings, components similar to those described previously with reference to earlier figures are labeled with like reference numerals, and the detailed description thereof is omitted appropriately. In this specification, the state of being “provided on” includes not only the state of being provided in direct contact, but also the state of being provided with another component interposed in between.

### First Embodiment

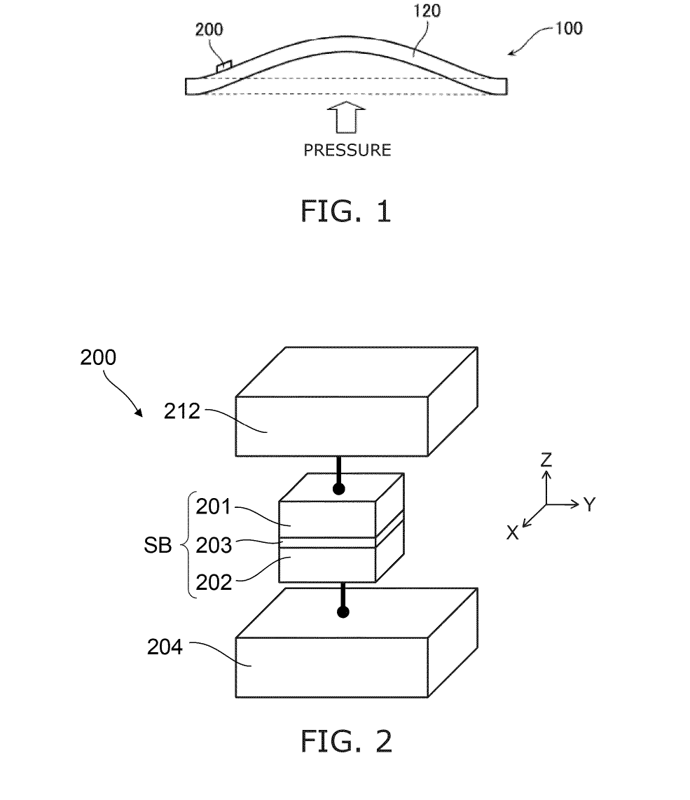

First, the operation of a strain sensing element and a pressure sensor installed therewith according to a first embodiment is described with reference to FIG. 1.

FIG. 1 is a schematic sectional view of a pressure sensor according to the first embodiment.

As shown in FIG. 1, the pressure sensor 100 includes a film part 120 and a strain sensing element 200 provided on the film part 120. The film part 120 is deformable and bends in response to external pressure. The strain sensing element 200 is strained in response to the bending of the film part 120 and changes its electrical resistance in response to this strain. Thus, the external pressure is detected by detecting the change of the electrical resistance of the strain sensing element. Here, the strain sensing element 200 may be directly attached onto the film part 120. Alternatively, the strain sensing element 200 may be indirectly attached by another component, not shown. It is only necessary to fix the positional relationship between the strain sensing element 200 and the film part 120.

Next, the configuration of the strain sensing element 200 is described with reference to FIG. 2.

FIG. 2 is a schematic perspective view illustrating the strain sensing element according to the first embodiment.

In the following, the stacking direction of the first magnetic layer 201 and the second magnetic layer 202 is referred to as Z-direction (stacking direction). A prescribed direction perpendicular to this Z-direction is referred to as X-direction. The direction perpendicular to the Z-direction and the X-direction is referred to as Y-direction.

The strain sensing element 200 according to this embodiment includes a first electrode (e.g., lower electrode 204), a second electrode (e.g., upper electrode 212), and a stacked body SB. As shown in FIG. 2, the stacked body SB includes a first magnetic layer 201, a second magnetic layer 202, and an intermediate layer 203 provided between the first magnetic layer 201 and the second magnetic layer 202. The first magnetic layer 201 and the second magnetic layer 202 are electrically connected to the upper electrode 212 and the lower electrode 204, respectively.

For instance, the stacked body SB is provided between the second electrode and the film part 120. The first electrode is provided between the stacked body SB and the film part 120. The first electrode and the second electrode are each electrically connected to the stacked body SB. A current along e.g. the Z-direction (stacking direction) can be passed in the stacked body SB through these electrodes. Here, a strain occurring in the strain sensing element 200 changes the relative magnetization direction of the magnetic layers 201 and 202. For instance, the magnetization direction of the first magnetic layer 201 changes in response to the deformation of the film part. This results in changing the electrical resistance between the magnetic layers 201 and 202. Thus, the strain occurring in the strain sensing element 200 can be detected by detecting this change of electrical resistance.

In this embodiment, the first magnetic layer 201 is made of a ferromagnet and functions as e.g. a magnetization free layer. The second magnetic layer 202 is also made of a ferromagnet and functions as e.g. a reference layer. The second magnetic layer 202 may be a magnetization fixed layer or a magnetization free layer. In the case where the second magnetic layer 202 is a magnetization fixed layer, the magnetization direction of the first magnetic layer 201 easily changes relative to the magnetization direction of the second magnetic layer 202.

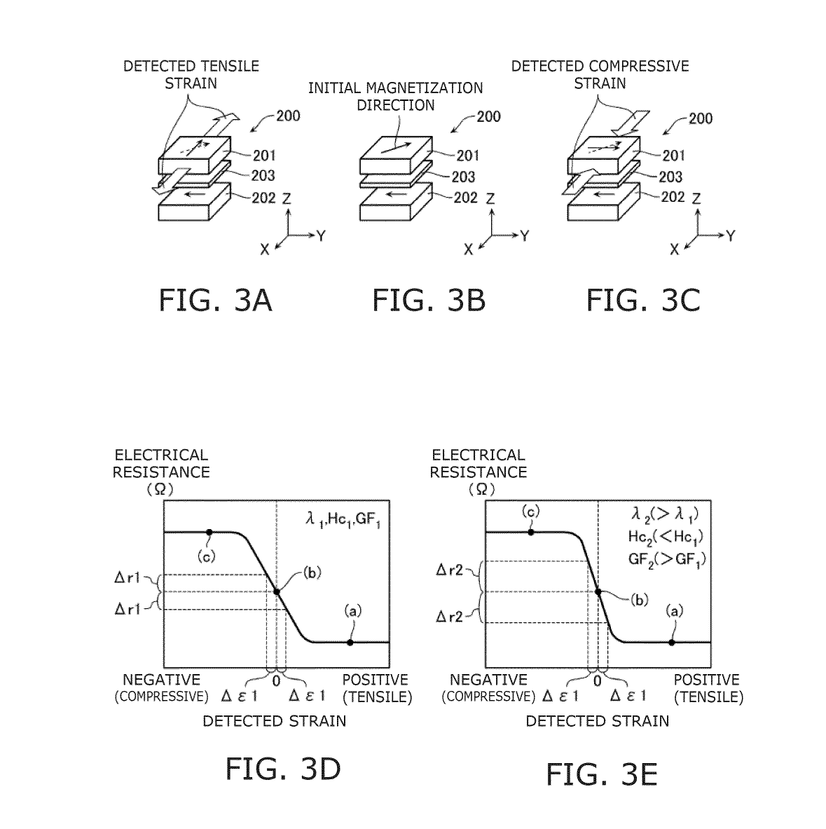

Next, the operation of the strain sensing element 200 according to this embodiment is described with reference to FIG. 3.

FIGS. 3A to 3E are schematic views illustrating the operation of the strain sensing element according to the first embodiment.

FIGS. 3A to 3C are schematic perspective views showing the state of the strain sensing element 200 with a tensile strain, with no strain, and with a compressive strain, respectively. In the following description, it is assumed that the magnetization direction of the second magnetic layer 202 of the strain sensing element 200 is the −Y-direction, and the direction of strain occurring in the strain sensing element 200 is the X-direction. It is also assumed that the second magnetic layer 202 functions as a magnetization fixed layer.

FIG. 3B shows the state (strainless state) in which no strain occurs in the strain sensing element 200 according to this embodiment. In this state, the relative angle of the magnetization direction of the first magnetic layer 201 and the magnetization direction of the second magnetic layer 202 is set to a prescribed angle of mutual crossing. This prescribed angle can be set to larger than 0° and smaller than 180°. In the example shown in FIG. 3B, the magnetization direction of the first magnetic layer 201 is 135° relative to the magnetization direction of the second magnetic layer 202, and 45° (135°) relative to the direction in which the strain occurs. This angle of 135° is illustrative only, and can be set to a different angle. In the following, as shown in FIG. 3B, the magnetization direction of the first magnetic layer 201 in the case of no strain is referred to as “initial magnetization direction”. The initial magnetization direction of the first magnetic layer 201 is set by e.g. hard bias or the shape magnetic anisotropy of the first magnetic layer 201.

Here, as shown in FIGS. 3A to 3C, when a strain occurs in the X-direction in the strain sensing element 200, the “inverse magnetostriction effect” occurs in the first magnetic layer 201. This relatively changes the magnetization direction of the first magnetic layer 201 and the second magnetic layer 202.

The “inverse magnetostriction effect” is a phenomenon in which the magnetization direction of a ferromagnet is changed by strain. For instance, the ferromagnetic material used in the magnetization free layer may have a positive magnetostriction constant. In this case, the magnetization direction of the magnetization free layer is made close to parallel with respect to the direction of a tensile strain, and close to perpendicular with respect to the direction of a compressive strain. On the other hand, the ferromagnetic material used in the magnetization free layer may have a negative magnetostriction constant. In this case, the magnetization direction is made close to perpendicular with respect to the direction of a tensile strain, and close to parallel with respect to the direction of a compressive strain.

In the example shown in FIGS. 3A to 3C, the first magnetic layer 201 of the strain sensing element 200 is made of a ferromagnet having a positive magnetostriction constant. Thus, as shown in FIG. 3A, the magnetization direction of the first magnetic layer 201 is made dose to parallel with respect to the direction of a tensile strain, and close to perpendicular with respect to the direction of a compressive strain. The magnetostriction constant of the first magnetic layer 201 may be negative.

FIGS. 3D and 3E are schematic graphs showing the relationship between the electrical resistance of the strain sensing element 200 and the strain occurring in the strain sensing element 200. In FIGS. 3D and 3E, the strain in the tensile direction is represented as a strain in the positive direction, and the strain in the compressive direction is represented as a strain in the negative direction. Furthermore, in FIG. 3D, the magnetostriction constant of the first magnetic layer 201 is denoted by λ1, the coercivity is denoted by Hc1, and the gauge factor described later is denoted by GF1. In FIG. 3E, the magnetostriction constant of the first magnetic layer 201 is denoted by λ2 (>λ1), the coercivity is denoted by Hc2 (<Hc1), and the gauge factor described later is denoted by GF2 (>GF1).

The magnetization direction of the first magnetic layer 201 and the second magnetic layer 202 may be relatively changed as shown in FIGS. 3A and 3C. Then, as shown in FIG. 3D, the electrical resistance between the first magnetic layer 201 and the second magnetic layer 202 is changed by the “magnetoresistance effect (MR effect)”.

The MR effect is a phenomenon in which the relative change of magnetization direction between magnetic layers results in changing the electrical resistance between these magnetic layers. The MR effect includes e.g. the GMR (giant magnetoresistance) effect or the TMR (tunneling magnetoresistance) effect. The MR effect is developed in e.g. the stacked film composed of the first magnetic layer 201, the intermediate layer 203, and the second magnetic layer 202.

In the case where the first magnetic layer 201, the second magnetic layer 202, and the intermediate layer 203 have a positive magnetoresistance effect, the electrical resistance decreases for a small relative angle of the first magnetic layer 201 and the second magnetic layer 202. On the other hand, in the case of a negative magnetoresistance effect, the electrical resistance increases for a small relative angle.

The strain sensing element 200 has e.g. a positive magnetoresistance effect. As shown in FIG. 3A, when a tensile strain occurs in the strain sensing element 200, the magnetization direction of the first magnetic layer 201 and the second magnetic layer 202 approaches 90° from 135°. This decreases the electrical resistance between the first magnetic layer 201 and the second magnetic layer 202 as shown in FIG. 3D. On the other hand, as shown in FIG. 3C, when a compressive strain occurs in the strain sensing element 200, the magnetization direction of the first magnetic layer 201 and the second magnetic layer 202 approaches 180° from 135°. This increases the electrical resistance between the first magnetic layer 201 and the second magnetic layer 202 as shown in FIG. 3D. The strain sensing element 200 may have a negative magnetoresistance effect.

Here, as shown in FIG. 3D, for instance, a small strain is denoted by Δε1. The resistance change in the strain sensing element 200 in response to the small strain Δε1 applied to the strain sensing element 200 is denoted by Δr1. Furthermore, the amount of change of the electrical resistance per unit strain is referred to as gauge factor (GF). A high gauge factor is desired to manufacture a strain sensing element 200 with high sensitivity. The gauge factor GF is represented by (dR/R)/dε.

As shown in FIG. 3E, the first magnetic layer 201 may have a larger magnetostriction constant and a smaller coercivity. In this case, the inverse magnetostriction effect is developed more significantly in the first magnetic layer 201, and the gauge factor increases. This is because the magnetostriction constant represents the magnitude of strength rotating the magnetization direction in response to strain, and the coercivity represents the magnitude of strength maintaining the magnetization direction. Thus, it is considered that the gauge factor is increased by increasing the magnetostriction constant and decreasing the coercivity of the first magnetic layer 201.

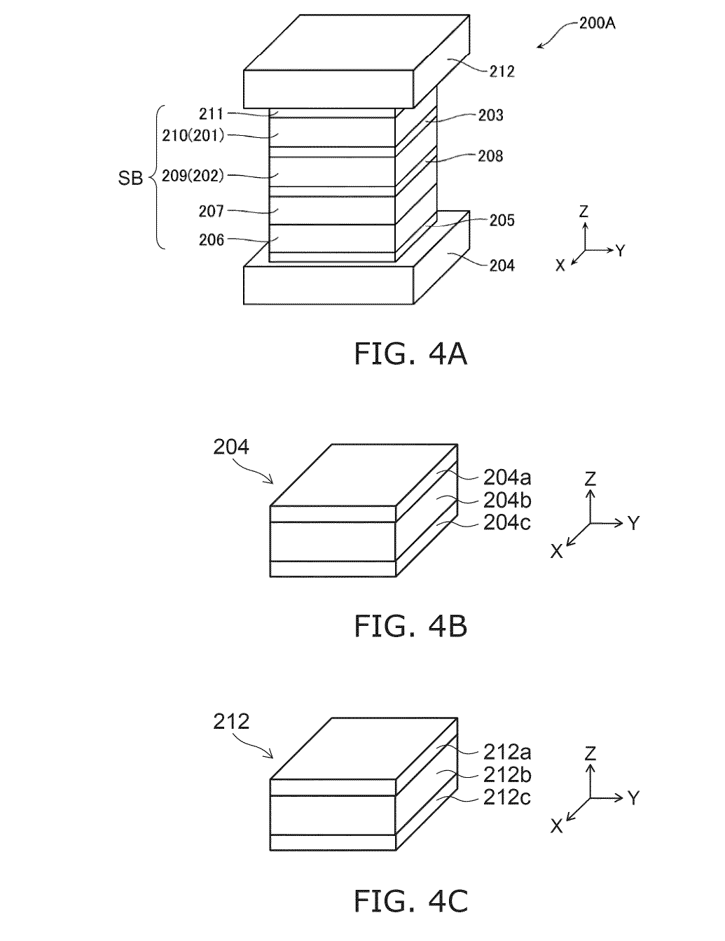

Next, a configuration example of the strain sensing element 200 according to this embodiment is described with reference to FIGS. 4A to 4C.

FIGS. 4A to 4C are schematic perspective views illustrating a strain sensing element according to the first embodiment. In the following, the notation of “material A/material B” represents the state in which a layer of material B is provided on a layer of material A.

FIG. 4A is a schematic perspective view illustrating one configuration example (strain sensing element 200A) of the strain sensing element 200. As shown in FIG. 4A, the strain sensing element 200A includes a lower electrode 204, a stacked body SB provided on this lower electrode 204, and an upper electrode 212 provided on this stacked body.

In this stacked body SB, an underlayer 205, a pinning layer 206, a second magnetization fixed layer 207, a magnetic coupling layer 208, a first magnetization fixed layer 209 (second magnetic layer 202), an intermediate layer 203, a magnetization free layer 210 (first magnetic layer 201), and a cap layer 211 are stacked sequentially from the near side of the lower electrode 204.

The first magnetization fixed layer 209 corresponds to the second magnetic layer 202. The magnetization free layer 210 corresponds to the first magnetic layer 201. The underlayer 205 is located between the second magnetic layer 202 and the lower electrode 204.

The underlayer 205 is made of e.g. Ta/Ru. The thickness (length in the Z-axis direction) of this Ta layer is e.g. 3 nanometers (nm). The thickness of this Ru layer is e.g. 2 nm.

The pinning layer 206 is e.g. an IrMn layer having a thickness of 7 nm.

The second magnetization fixed layer 207 is e.g. a Co₇₅Fe₂₅ layer having a thickness of 2.5 nm.

The magnetic coupling layer 208 is e.g. a Ru layer having a thickness of 0.9 nm.

The first magnetization fixed layer 209 is e.g. a Co₄₀Fe₄₀B₂₀ layer having a thickness of 3 nm.

The intermediate layer 203 includes at least one of oxide, nitride, and oxynitride. The intermediate layer 203 is e.g. a MgO (magnesium oxide) layer having a thickness of 1.6 nm. The magnetization free layer 210 is made of e.g. Co₄₀Fe₄₀B₂₀ with a thickness of 4 nm. The cap layer 211 is made of e.g. Ta/Ru. The thickness of this Ta layer is e.g. 1 nm. The thickness of this Ru layer is e.g. 5 nm. The lower electrode 204 and the upper electrode 212 are made of e.g. metal.

In this embodiment, the lower electrode 204 (first electrode) can be made of a first alloy including Ta and Mo (e.g., Ta—Mo alloy). The upper electrode 212 can be made of a second alloy including Ta and Mo (e.g., Ta—Mo alloy). Use of Ta—Mo alloy including Ta and Mo for the lower electrode 204 (first electrode) or the upper electrode 212 can realize electrodes with low residual stress. This can provide a high-sensitivity pressure sensor.

The Ta—Mo alloy can be Ta₁₀₀₋ₓMoₓ (13 atomic percent (at. %)≦x≦70 at. %). The Ta—Mo alloy can be an alloy having a cubic structure. The Ta—Mo alloy can be e.g. Ta₁₀₀₋ₓMoₓ (13 at. %≦x≦70 at. %) of the body-centered cubic structure.

Each of the lower electrode 204 and the upper electrode 212 may be a monolayer of Ta—Mo alloy.

Each of the lower electrode 204 and the upper electrode 212 may be a stacked layer of a Ta—Mo alloy layer and a layer made of another material. Also in this case, a high-sensitivity pressure sensor can be provided for the reasons described later.

For instance, as shown in FIG. 4B, the lower electrode 204 may have a three-layer structure. In this example, the lower electrode 204 includes a lower electrode cap layer 204a (first alloy layer), a lower electrode intermediate metal layer 204b (first intermediate metal layer), and a lower electrode underlayer 204c (first metal layer). The lower electrode cap layer 204a is provided between the lower electrode intermediate metal layer 204b and the stacked body SB. The lower electrode underlayer 204c is provided between the lower electrode intermediate metal layer 204b and the film part 120.

In this case, the lower electrode cap layer 204a can be made of a first alloy including Ta and Mo (Ta—Mo alloy). The lower electrode underlayer 204c can be made of Ta or a first Ta alloy including Ta and Mo (e.g., Ta—Mo alloy). The lower electrode intermediate metal layer 204b can be made of a metal of low resistivity.

The lower electrode 204 has such a three-layer structure, and the lower electrode intermediate metal layer 204b is made of a metal of low resistivity. This can achieve a lower electrode resistance than in the case where the lower electrode 204 is formed from a monolayer of Ta—Mo alloy. The lower electrode underlayer 204c may be omitted to form a two-layer structure.

As shown in FIG. 4C, the upper electrode 212 may have a three-layer structure. In this example, the upper electrode 212 includes an upper electrode cap layer 212a (second alloy layer), an upper electrode intermediate metal layer 212b (second intermediate metal layer), and an upper electrode underlayer 212c (second metal layer). The upper electrode intermediate metal layer 212b is provided between the upper electrode cap layer 212a and the stacked body SB. The upper electrode underlayer 212c is provided between the upper electrode intermediate metal layer 212b and the stacked body SB.

In this case, the upper electrode cap layer 212a can be made of a second alloy including Ta and Mo (e.g., Ta—Mo alloy). The upper electrode underlayer 212c can be made of Ta or a second Ta alloy including Ta and Mo (e.g., Ta—Mo alloy). The upper electrode intermediate metal layer 212b can be made of a metal of low resistivity.

For instance, the lower electrode intermediate metal layer 204b can be made of e.g. copper (Cu) or an alloy including copper and silver (Ag) (first copper alloy). The first copper alloy is e.g. a copper-silver alloy (Cu—Ag alloy).

For instance, the upper electrode intermediate metal layer 212b can be made of e.g. copper (Cu) or an alloy including copper and silver (Ag) (second copper alloy). The second copper alloy is e.g. a copper-silver alloy (Cu—Ag alloy).

Each of the lower electrode intermediate metal layer 204b and the upper electrode intermediate metal layer 212b can be made of e.g. a metal including at least one element selected from the group consisting of copper (Cu), aluminum (Al), silver (Ag), gold (Au), nickel (Ni), iron (Fe), and cobalt (Co). The metal including such metal has a relatively low electrical resistivity. The metal can be e.g. copper (Cu), copper-silver alloy (Cu—Ag), aluminum (Al), aluminum-copper alloy (Al—Cu), silver (Ag), gold (Au), and nickel-iron alloy (Ni—Fe). The lower electrode 204 and the upper electrode 212 are made of such a material having a relatively low electrical resistivity. Thus, a current can be efficiently passed in the strain sensing element 200. The lower electrode 204 and the upper electrode 212 can be made of a nonmagnetic material. As described later, the lower electrode intermediate metal layer 204b is preferably made of copper-silver alloy (Cu—Ag) from the viewpoint of reducing asperities of the lower electrode 204 and the stacked body SB formed thereon to achieve a high strain sensitivity.

For instance, the lower electrode 204 and the upper electrode 212 can use a three-layer structure of Ta—Mo alloy/Cu—Ag alloy/Ta—Mo alloy or Ta—Mo alloy/Cu alloy/Ta—Mo alloy.

A Ta—Mo alloy layer is used for the underlayer in the lower electrode 204. This improves e.g. adhesiveness between the film part 120 and the lower electrode 204. A Ta—Mo alloy layer is used for the underlayer in the upper electrode 212. This improves adhesiveness between the stacked body SB and the upper electrode 212. From the viewpoint of adhesiveness, the underlayer for the lower electrode 204 and the upper electrode 212 may be made of e.g. tantalum (Ta), titanium (Ti), or titanium nitride (TiN) besides the Ta—Mo alloy layer. From the viewpoint of decreasing the residual stress of the electrode, the underlayer for the lower electrode 204 and the upper electrode 212 is preferably a Ta—Mo alloy layer.

A Ta—Mo alloy layer is used for the cap layer (204a) of the lower electrode 204 and the cap layer (212a) of the upper electrode 212. This can prevent oxidation of the intermediate metal layer (204b or 212b) below the cap layer. From the viewpoint of preventing oxidation of the intermediate metal layer, the cap layer may be made of e.g. tantalum (Ta), titanium (Ti), or titanium nitride (TiN) besides the Ta—Mo alloy. The cap layer of the lower electrode 204 is made of a barrier metal such as Ta—Mo alloy, tantalum (Ta), titanium (Ti), and titanium nitride (TiN). This can suppress element diffusion into the stacked body of the strain sensing element formed thereon. Diffusion of e.g. aluminum (Al), copper (Cu), silver (Ag), and gold (Au) into the stacked body of the strain sensing element may cause degradation of the gauge factor. Thus, the cap layer is preferably made of a barrier metal. In general, the barrier metal can be a high melting point metal, or nitride or carbide of a high melting point metal besides Ta—Mo alloy, tantalum (Ta), titanium (Ti), and titanium nitride (TiN). From the viewpoint of decreasing the residual stress of the electrode, the cap layer for the lower electrode 204 and the upper electrode 212 is preferably a Ta—Mo alloy layer.

The underlayer 205 can use e.g. a stacked structure including a buffer layer (not shown) and a seed layer (not shown). This buffer layer relaxes roughening of the surface of e.g. the lower electrode 204 or the film part 120 and improves the crystallinity of the layer stacked on this buffer layer. The buffer layer is made of e.g. at least one selected from the group consisting of tantalum (Ta), titanium (Ti), vanadium (V), tungsten (W), zirconium (Zr), hafnium (Hf), and chromium (Cr). The buffer layer may be made of an alloy including at least one material selected from these materials.

The thickness of the buffer layer of the underlayer 205 is preferably 1 nm or more and 10 nm or less. More preferably, the thickness of the buffer layer is 1 nm or more and 5 nm or less. If the thickness of the buffer layer is too thin, the buffering effect is lost. If the thickness of the buffer layer is too thick, the thickness of the strain sensing element 200 is excessively thickened. A seed layer can be formed on the buffer layer. The seed layer can have the buffering effect. In this case, the buffer layer may be omitted. The buffer layer is e.g. a Ta layer having a thickness of 3 nm.

The seed layer of the underlayer 205 controls the crystal orientation of the layer stacked on this seed layer. The seed layer controls the crystal grain size of the layer stacked on this seed layer. This seed layer is made of e.g. a metal having the fcc structure (face-centered cubic structure), hcp structure (hexagonal close-packed structure), or bcc structure (body-centered cubic structure).

The seed layer of the underlayer 205 may be made of ruthenium (Ru) having the hcp structure, NiFe having the fcc structure, or Cu having the fcc structure. Thus, for instance, the crystal orientation of the spin valve film on the seed layer can be set to fcc(111) orientation. The seed layer is e.g. a Cu layer having a thickness of 2 nm or a Ru layer having a thickness of 2 nm. In the case of enhancing the crystal orientation of the layer formed on the seed layer, the thickness of the seed layer is preferably 1 nm or more and 5 nm or less. More preferably, the thickness of the seed layer is 1 nm or more and 3 nm or less. This sufficiently develops the function of the seed layer for improving the crystal orientation.

On the other hand, for instance, in the case where there is no need to provide crystal orientation in the layer formed on the seed layer (e.g., in the case of forming an amorphous magnetization free layer), the seed layer may be omitted. The seed layer is e.g. a Ru layer having a thickness of 2 nm.

The pinning layer 206 fixes the magnetization of the second magnetization fixed layer 207 by e.g. providing unidirectional anisotropy to the second magnetization fixed layer 207 (ferromagnetic layer) formed on the pinning layer 206. The pinning layer 206 is e.g. an antiferromagnetic layer. The pinning layer 206 is made of e.g. at least one selected from the group consisting of Ir—Mn, Pt—Mn, Pd—Pt—Mn, Ru—Mn, Rh—Mn, Ru—Rh—Mn, Fe—Mn, Ni—Mn, Cr—Mn—Pt, and Ni—O. The pinning layer 206 may be made of an alloy in which an additive element is further added to Ir—Mn, Pt—Mn, Pd—Pt—Mn, Ru—Mn, Rh—Mn, Ru—Rh—Mn, Fe—Mn, Ni—Mn, Cr—Mn—Pt, and Ni—O. The thickness of the pinning layer 206 is appropriately set in order to provide unidirectional anisotropy of sufficient strength.

The magnetization of the ferromagnetic layer in contact with the pinning layer 206 is fixed by heat treatment under application of magnetic field. The magnetization of the ferromagnetic layer in contact with the pinning layer 206 is fixed to the direction of the magnetic field applied during the heat treatment. The annealing temperature is set equal to or higher than e.g. the magnetization fixation temperature of the antiferromagnetic material used for the pinning layer 206. In the case of using an antiferromagnetic layer including Mn, Mn may diffuse into the layer other than the pinning layer 206 and reduce the MR ratio. Thus, it is desirable to set the annealing temperature equal to or lower than the temperature at which diffusion of Mn occurs. The annealing temperature can be set to e.g. 200 degrees (° C.) or more and 500 degrees (° C.) or less. Preferably, the annealing temperature can be set to 250 degrees (° C.) or more and 400 degrees (° C.) or less.

In the case where the pinning layer 206 is made of PtMn or PdPtMn, the thickness of the pinning layer 206 is preferably 8 nm or more and 20 nm or less. More preferably, the thickness of the pinning layer 206 is 10 nm or more and 15 nm or less. In the case where the pinning layer 206 is made of IrMn, the pinning layer 206 can be provided with unidirectional anisotropy using a thickness thinner than the pinning layer 206 made of PtMn. In this case, the thickness of the pinning layer 206 is preferably 4 nm or more and 18 nm or less. More preferably, the thickness of the pinning layer 206 is 5 nm or more and 15 nm or less. The pinning layer 206 is e.g. an Ir₂₂Mn₇₈ layer having a thickness of 7 nm.

The pinning layer 206 may be a hard magnetic layer. The hard magnetic layer is made of e.g. a hard magnetic material having relatively high magnetic anisotropy and coercivity such as Co—Pt, Fe—Pt, Co—Pd, and Fe—Pd. The hard magnetic layer may be made of an alloy in which an additive element is further added to Co—Pt, Fe—Pt, Co—Pd, and Fe—Pd. The hard magnetic layer may be made of e.g. CoPt (the ratio of Co being 50 at. % or more and 85 at. % or less), (CoₓPt₁₀₀₋ₓ)_{100-y}Cr_{y} (x being 50 at. % or more and 85 at. % or less, and y being 0 at. % or more and 40 at. % or less), or FePt (the ratio of Pt being 40 at. % or more and 60 at. % or less).

The second magnetization fixed layer 207 is made of e.g. CoₓFe₁₀₀₋ₓ alloy (x being 0 at. % or more and 100 at. % or less), NiₓFe₁₀₀₋ₓ alloy (x being 0 at. % or more and 100 at. % or less), or a material in which a nonmagnetic element is added thereto. The second magnetization fixed layer 207 is made of e.g. at least one selected from the group consisting of Co, Fe, and Ni. The second magnetization fixed layer 207 may be made of an alloy including at least one material selected from these materials. Alternatively, the second magnetization fixed layer 207 can be made of (CoₓFe₁₀₀₋ₓ)_{100-y}B_{y} alloy (x being 0 at. % or more and 100 at. % or less, and y being 0 at. % or more and 30 at. % or less). The second magnetization fixed layer 207 may be made of an amorphous alloy of (CoₓFe₁₀₀₋ₓ)_{100-y}B_{y}. This can suppress the variation of characteristics of the strain sensing element 200A even in the case where the size of the strain sensing element is small.

The thickness of the second magnetization fixed layer 207 is preferably e.g. 1.5 nm or more and 5 nm or less. This can further strengthen e.g. the strength of unidirectional anisotropic magnetic field caused by the pinning layer 206. For instance, the strength of the antiferromagnetic coupling magnetic field between the second magnetization fixed layer 207 and the first magnetization fixed layer 209 can be further strengthened via the magnetic coupling layer formed on the second magnetization fixed layer 207. For instance, preferably, the magnetic film thickness (the product (Bs·t) of the saturation magnetization Bs and the thickness t) of the second magnetization fixed layer 207 is substantially equal to the magnetic film thickness of the first magnetization fixed layer 209.

The saturation magnetization of Co₄₀Fe₄₀B₂₀ in a thin film is approximately 1.9 T (tesla). The first magnetization fixed layer 209 may be e.g. a Co₄₀Fe₄₀B₂₀ layer having a thickness of nm. Then, the magnetic film thickness of the first magnetization fixed layer 209 is 1.9 T×3 nm=5.7 Tnm. On the other hand, the saturation magnetization of Co₇₅Fe₂₅ is approximately 2.1 T. The thickness of the second magnetization fixed layer 207 achieving a magnetic film thickness equal to the foregoing is 5.7 Tnm/2.1 T=2.7 nm. In this case, the second magnetization fixed layer 207 is preferably a Co₇₅Fe₂₅ layer having a thickness of approximately 2.7 nm. The second magnetization fixed layer 207 is e.g. a Co₇₅Fe₂₅ layer having a thickness of 2.5 nm.

The strain sensing element 200A uses a synthetic pinned structure made of the second magnetization fixed layer 207, the magnetic coupling layer 208, and the first magnetization fixed layer 209. Instead, the strain sensing element 200A may use a single pinned structure made of a single magnetization fixed layer. In the case of using the single pinned structure, the magnetization fixed layer is e.g. a Co₄₀Fe₄₀B₂₀ layer having a thickness of 3 nm. The ferromagnetic layer used for the magnetization fixed layer of the single pinned structure may be made of the same material as the aforementioned material of the second magnetization fixed layer 207.

The magnetic coupling layer 208 causes antiferromagnetic coupling between the second magnetization fixed layer 207 and the first magnetization fixed layer 209. The magnetic coupling layer 208 forms a synthetic pinned structure. The magnetic coupling layer 208 is made of e.g. Ru. The thickness of the magnetic coupling layer 208 is preferably e.g. 0.8 nm or more and 1 nm or less. The magnetic coupling layer 208 may be made of a material other than Ru as long as the material can cause sufficient antiferromagnetic coupling between the second magnetization fixed layer 207 and the first magnetization fixed layer 209. The thickness of the magnetic coupling layer 208 can be set to a thickness of 0.8 nm or more and 1 nm or less corresponding to the second peak (2nd peak) of the RKKY (Ruderman-Kittel-Kasuya-Yosida) coupling. Alternatively, the thickness of the magnetic coupling layer 208 may be set to a thickness of 0.3 nm or more and 0.6 nm or less corresponding to the first peak (1st peak) of the RKKY coupling. The magnetic coupling layer 208 is made of e.g. Ru with a thickness of 0.9 nm. This stably achieves coupling with high reliability.

The magnetic layer used for the first magnetization fixed layer 209 directly contributes to the MR effect. The first magnetization fixed layer 209 is made of e.g. Co—Fe—B alloy. Specifically, the first magnetization fixed layer 209 can be made of (CoₓFe₁₀₀₋ₓ)_{100-y}B_{y} alloy (x being 0 at. % or more and 100 at. % or less, and y being 0 at. % or more and 30 at. % or less). The first magnetization fixed layer 209 may be made of an amorphous alloy of (CoₓFe₁₀₀₋ₓ)_{100-y}B_{y}. This can suppress e.g. the variation between the elements due to crystal grains even in the case where the size of the strain sensing element 200 is small.

The first magnetization fixed layer 209 can planarize a layer (e.g., tunnel insulating layer (not shown)) formed on the first magnetization fixed layer 209. The planarization of the tunnel insulating layer can reduce the defect density of the tunnel insulating layer. This can achieve a higher MR ratio by a lower area resistance. For instance, the material of the tunnel insulating layer may be Mg—O. In this case, the first magnetization fixed layer 209 may be made of an amorphous alloy of (CoₓFe₁₀₀₋ₓ)_{100-y}B_{y}. This can enhance the (100) orientation of the Mg—O layer formed on the tunnel insulating layer. A higher (100) orientation of the Mg—O layer results in a higher MR ratio. The (CoₓFe₁₀₀₋ₓ)_{100-y}B_{y} alloy is crystallized with the (100) surface of the Mg—O layer serving as a template at the time of annealing. This achieves good crystal matching between Mg—O and the (CoₓFe₁₀₀₋ₓ)_{100-y}B_{y} alloy. Good crystal matching results in a higher MR ratio.

The first magnetization fixed layer 209 may be made of e.g. Fe—Co alloy besides the Co—Fe—B alloy.

If the first magnetization fixed layer 209 is thicker, a higher MR ratio is obtained. For a higher fixed magnetic field, the first magnetization fixed layer 209 is preferably thinner. There is a tradeoff in the thickness of the first magnetization fixed layer 209 between the MR ratio and the fixed magnetic field. In the case where the first magnetization fixed layer 209 is made of Co—Fe—B alloy, the thickness of the first magnetization fixed layer 209 is preferably 1.5 nm or more and 5 nm or less. More preferably, the thickness of the first magnetization fixed layer 209 is 2.0 nm or more and 4 nm or less.

Besides the aforementioned materials, the first magnetization fixed layer 209 is made of Co₉₀Fe₁₀ alloy having the fcc structure, Co having the hcp structure, or Co alloy having the hcp structure. The first magnetization fixed layer 209 is made of e.g. at least one selected from the group consisting of Co, Fe, and Ni. The first magnetization fixed layer 209 is made of an alloy including at least one material selected from these materials. The first magnetization fixed layer 209 may be made of a FeCo alloy material having the bcc structure, a Co alloy having a cobalt composition of 50 at. % or more, or a material having a Ni composition of 50 at. % or more (Ni alloy). This achieves e.g. a higher MR ratio.

The first magnetization fixed layer 209 can be e.g. a Heusler magnetic alloy layer such as Co₂MnGe, Co₂FeGe, Co₂MnSi, Co₂FeSi, Co₂MnAl, Co₂FeAl, Co₂MnGa_{0.5}Ge_{0.5}, and Co₂FeGa_{0.5}Ge_{0.5}. For instance, the first magnetization fixed layer 209 is e.g. a Co₄₀Fe₄₀B₂₀ layer having a thickness of 3 nm.

The intermediate layer 203 breaks e.g. magnetic coupling between the first magnetic layer 201 and the second magnetic layer 202. The intermediate layer 203 is made of e.g. metal, insulator, or semiconductor. This metal is e.g. Cu, Au, or Ag. In the case where the intermediate layer 203 is made of metal, the thickness of the intermediate layer is e.g. approximately 1 nm or more and 7 nm or less. This insulator or semiconductor is e.g. magnesium oxide (such as Mg—O), aluminum oxide (such as Al₂O₃), titanium oxide (such as Ti—O), zinc oxide (such as Zn—O), or gallium oxide (Ga—O). In the case where the intermediate layer 203 is made of insulator or semiconductor, the thickness of the intermediate layer 203 is e.g. approximately 0.6 nm or more and 2.5 nm or less. The intermediate layer 203 may be e.g. a CCP (current-confined-path) spacer layer. In the case where the spacer layer is a CCP spacer layer, the spacer layer uses a structure in which e.g. a copper (Cu) metal path is formed in an insulating layer of aluminum oxide (Al₂O₃). The intermediate layer is e.g. an Mg—O layer having a thickness of 1.6 nm.

The magnetization free layer 210 is made of a ferromagnetic material. In this embodiment, the magnetization free layer 210 is made of a ferromagnetic material of an amorphous structure. This can achieve a high gauge factor. The magnetization free layer 210 can be made of e.g. an alloy including at least one element selected from the group consisting of Fe, Co, and Ni, and an amorphous forming element (e.g., boron (B)). The magnetization free layer 210 can be made of e.g. Co—Fe—B alloy, Fe—B alloy, or Fe—Co—Si—B alloy. The magnetization free layer 210 can be e.g. a Co₄₀Fe₄₀B₂₀ layer having a thickness of 4 nm.

The magnetization free layer 210 may have a multilayer structure (e.g., two-layer structure). The intermediate layer 203 may be a tunnel insulating layer of Mg—O. In this case, a layer of Co—Fe—B alloy or Fe—B alloy is preferably provided in the portion of the magnetization free layer 210 in contact with the intermediate layer 203. This achieves a high magnetoresistance effect.

For instance, the magnetization free layer 210 includes a first portion in contact with or close to the intermediate layer 203, and a second portion in contact with or close to the first portion. The first portion includes e.g. a portion of the magnetization free layer 210 in contact with the intermediate layer 203. This first portion is made of a layer of Co—Fe—B alloy. The second portion is made of e.g. Fe—B alloy. That is, the magnetization free layer 210 is made of e.g. Co—Fe—B/Fe—B alloy. The thickness of this Co₄₀Fe₄₀B₂₀ layer is e.g. 0.5 nm. The thickness of the aforementioned Fe—B alloy layer used for the magnetization free layer 210 is e.g. 6 nm.

The cap layer 211 protects a layer provided below the cap layer 211. The cap layer 211 is made of e.g. a plurality of metal layers. The cap layer 211 uses e.g. a two-layer structure (Ta/Ru) of a Ta layer and a Ru layer. The thickness of this Ta layer is e.g. 1 nm. The thickness of this Ru layer is e.g. 5 nm. Instead of the Ta layer and the Ru layer, the cap layer 211 may be made of another metal layer. The configuration of the cap layer 211 is arbitrary. The cap layer 211 can be made of e.g. a nonmagnetic material. The cap layer 211 may be made of another material as long as it can protect the layer provided below the cap layer 211.

Next, a configuration example of the pressure sensor installed with the strain sensing element 200 is described.

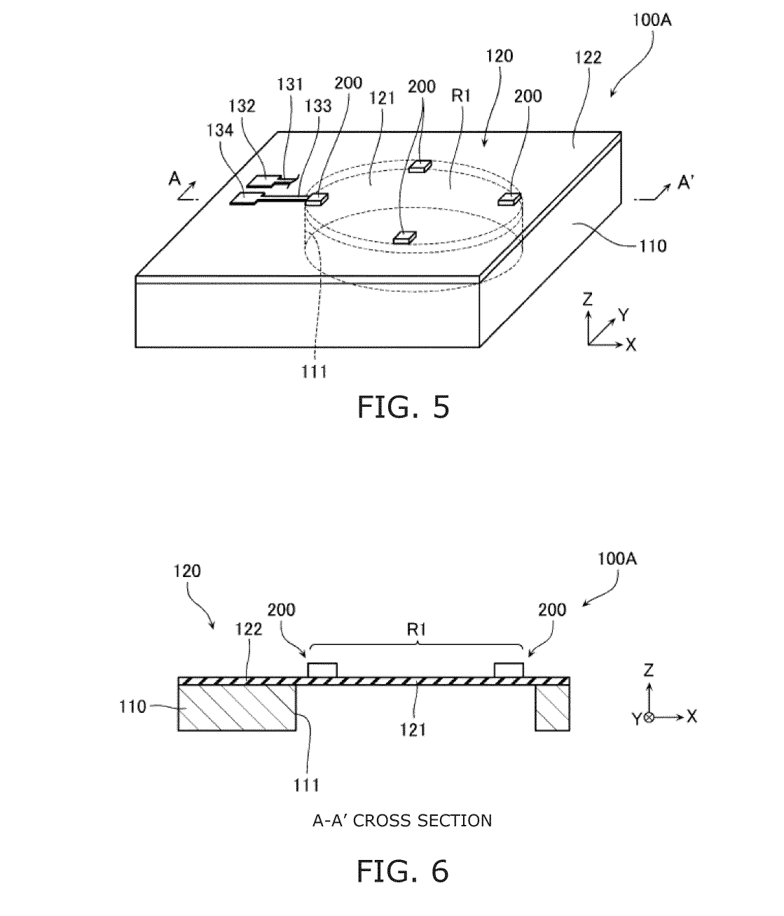

FIG. 5 is a schematic perspective view illustrating a pressure sensor according to the first embodiment.

FIG. 6 is a schematic sectional view illustrating the pressure sensor according to the first embodiment.

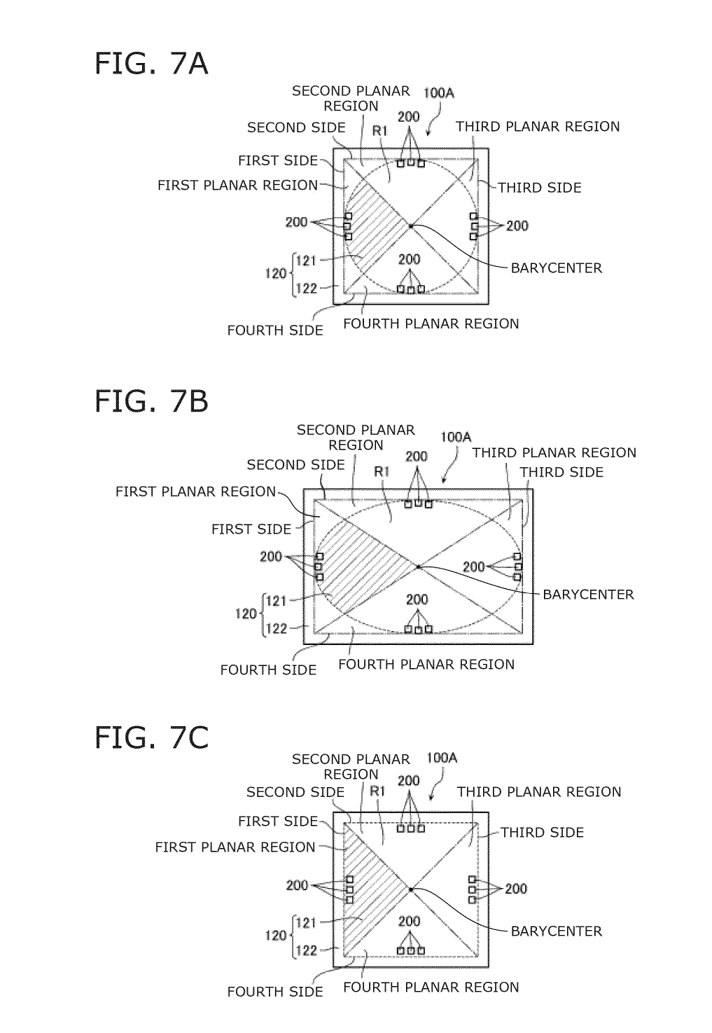

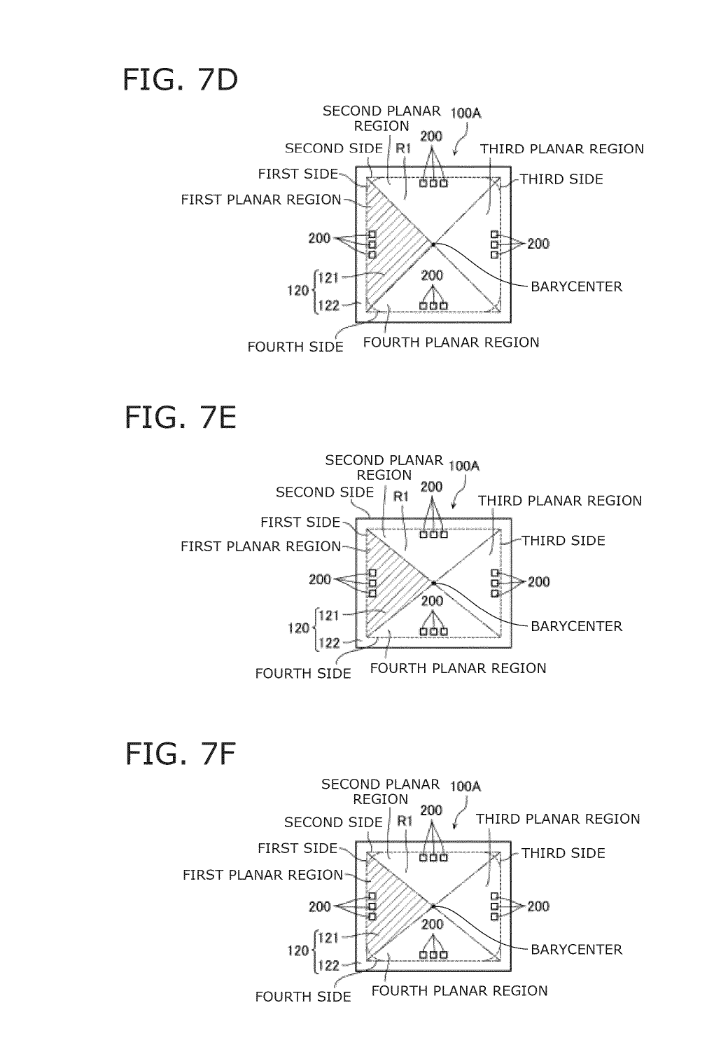

FIGS. 7A to 7F are schematic plan views illustrating pressure sensors according to the first embodiment.

As shown in FIG. 5, the pressure sensor 100 (100A) according to this embodiment includes a substrate 110, a film part 120 provided on one surface of the substrate 110, and a strain sensing element 200 provided on the film part 120. The strain sensing element 200 is provided partly on the film part 120. Furthermore, a wiring 131, a pad 132, a wiring 133, and a pad 134 connected to the strain sensing element 200 are provided on the film part 120.

As shown in FIG. 6, the substrate 110 is a plate-like substrate including a hollow part 111. The substrate 110 functions as a support part for supporting the film part 120 so that the film part 120 bends in response to external pressure. In this embodiment, the hollow part 111 is a cylindrical hole penetrating through the substrate 110. The substrate 110 is made of e.g. a semiconductor material such as silicon, a conductive material such as metal, or an insulating material. The substrate 110 may include e.g. silicon oxide or silicon nitride.

The inside of the hollow part 111 is designed so as to be able to bend the film part 120. For instance, the inside of the hollow part 111 may be in a reduced-pressure state or a vacuum state. Alternatively, the inside of the hollow part 111 may be filled with a gas such as air, or a liquid. Furthermore, the hollow part 111 may communicate with the outside.

As shown in FIG. 6, the film part 120 is formed thinner than the substrate 110. The film part 120 includes a vibration part 121 and a supported part 122. The vibration part 121 is located directly above the hollow part 111 and bends in response to external pressure. The supported part 122 is formed integrally with the vibration part 121 and supported by the substrate 110. The strain sensing element 200 is provided on part of the vibration part 121. For instance, as shown in FIG. 7A, the supported part 122 surrounds the vibration part 121. In the following, the region of the film part 120 located directly above the hollow part 111 is referred to as first region R1.

The first region R1 can be formed in various forms. For instance, as shown in FIG. 7A, the first region R1 may be formed in a generally circular shape. As shown in FIG. 7B, the first region R1 may be formed in an elliptical (e.g., flat circular) shape. As shown in FIG. 7C, the first region R1 may be formed in a generally square shape. As shown in FIG. 7E, the first region R1 may be formed in a rectangular shape. In the case where the first region R1 is formed in e.g. a generally square shape or generally rectangular shape, the four corner portions can be rounded as shown in FIG. 7D or 7F. Furthermore, the first region R1 can be a polygon or a regular polygon.

The material of the film part 120 may be e.g. an insulating material like SiOₓ, SiNₓ, and a flexible plastic material such as polyimide or paraxylylene-based polymer. The material of the film part 120 may include e.g. at least one of silicon oxide, silicon nitride, and silicon oxynitride. The material of the film part 120 may be e.g. a semiconductor material such as silicon, or a metal material such as Al.

The film part 120 is formed thinner than the substrate 110. The thickness (Z-direction width) of the film part 120 is e.g. 0.1 micrometers (μm) or more and 3 μm or less. The thickness of the film part 120 is preferably 0.2 μm or more and 1.5 μm or less. The film part 120 may be a stacked body of a silicon oxide film having a thickness of 0.2 μm and a silicon film having a thickness of 0.4 μm. The diameter (planar dimension) of the film part 120 can be 50 μm or more and 1000 μm or less.

As shown in FIGS. 7A to 7F, a plurality of strain sensing elements 200 can be placed in the first region R1 on the film part 120. The strain sensing elements 200 are each placed along the outer edge of the first region R1. That is, in the example shown in FIGS. 7A to 7F, the distance between each of the plurality of strain sensing elements 200 and the outer edge of the first region R1 (shortest distance Lmin) is mutually equal. The number of strain sensing elements 200 placed in the first region R1 on the film part 120 may be one.

As shown in e.g. FIGS. 7A and 7B, the outer edge of the first region R1 may be a curve. In this case, the strain sensing elements 200 are placed along the curve. As shown in e.g. FIGS. 7C and 7D, the outer edge of the first region R1 may be a straight line. In this case, the strain sensing elements 200 are linearly placed along the straight line.

As described later in detail, in FIGS. 7A to 7F, a rectangle circumscribing the film part 120 (the rectangle composed of first to fourth sides in the figure, hereinafter referred to as “smallest circumscribing rectangle”) and diagonals of this rectangle are shown by dot-dashed lines. The regions on the film part 120 divided by the smallest circumscribing rectangle and the dot-dashed lines are referred to as first to fourth planar regions. Thus, a plurality of strain sensing elements 200 are placed along the outer edge of the first region R1 in the first to fourth planar regions.

The strain sensing element 200 is connected to the pad 132 through the wiring 131 shown in FIG. 5, and to the pad 134 through the wiring 132. In the case of detecting pressure by the pressure sensor 100, a voltage is applied to the strain sensing element 200 through these pads 132 and 134 to measure the electrical resistance of the strain sensing element 200. An interlayer insulating layer may be provided between the wiring 131 and the wiring 133.

The strain sensing element 200 may be configured to include the lower electrode 204 and the upper electrode 212 like e.g. the strain sensing element 200A shown in FIGS. 4A to 4C. In this case, for instance, the wiring 131 is connected to the lower electrode 204, and the wiring 133 is connected to the upper electrode 212. On the other hand, the strain sensing element 200 may be configured to include e.g. two lower electrodes 204 with no upper electrode, or to include two upper electrodes 212 with no lower electrode. In this case, the wiring 131 is connected to one lower electrode 204 or upper electrode 212, and the wiring 133 is connected to the other lower electrode 204 or upper electrode 212. The plurality of strain sensing elements 200 may be connected in series or parallel through a wiring, not shown. This can increase the SN ratio.

The size of the strain sensing element 200 may be very small. The area of the strain sensing element 200 in the XY-plane can be made sufficiently smaller than the area of the first region R1. For instance, the area of the strain sensing element 200 can be set to ⅕ or less of the area of the first region R1. For instance, the area of the first magnetic layer 201 included in the strain sensing element 200 can be set to ⅕ or less of the area of the first region R1. The plurality of strain sensing elements 200 may be connected in series or parallel. This can achieve a high gauge factor or high SN ratio even in the case of using strain sensing elements 200 sufficiently smaller than the area of the first region R1.

For instance, in the case where the diameter of the first region R1 is approximately 60 μm, the first dimension of the strain sensing element 200 (or first magnetic layer 201) can be set to 12 μm or less. For instance, in the case where the diameter of the first region R1 is approximately 600 μm, the dimension of the strain sensing element 200 (or first magnetic layer 201) can be set to 120 μm or less. In view of e.g. processing accuracy of the strain sensing element 200, there is no need to excessively reduce the dimension of the strain sensing element 200 (or first magnetic layer 201). Thus, the dimension of the strain sensing element 200 (or first magnetic layer 201) can be set to e.g. 0.05 μm or more and 30 μm or less.

In the example shown in FIGS. 5, 6, and 7A to 7F, the substrate 110 and the film part 120 are configured as separate bodies. However, the film part 120 may be formed integrally with the substrate 110. The film part 120 may be made of the same material as the substrate 110, or made of a different material. In the case where the film part 120 is formed integrally with the substrate 110, the portion of the substrate 110 thinly formed constitutes the film part 120 (vibration part 121). Furthermore, the vibration part 121 may be supported continuously along the outer edge of the first region R1 as shown in FIGS. 5, 6, and 7A to 7F. Alternatively, the vibration part 121 may be supported by part of the outer edge of the first region R1.

In the example shown in FIGS. 7A to 7F, a plurality of strain sensing elements 200 are provided on the film part 120. However, for instance, only one strain sensing element 200 may be provided on the film part 120.

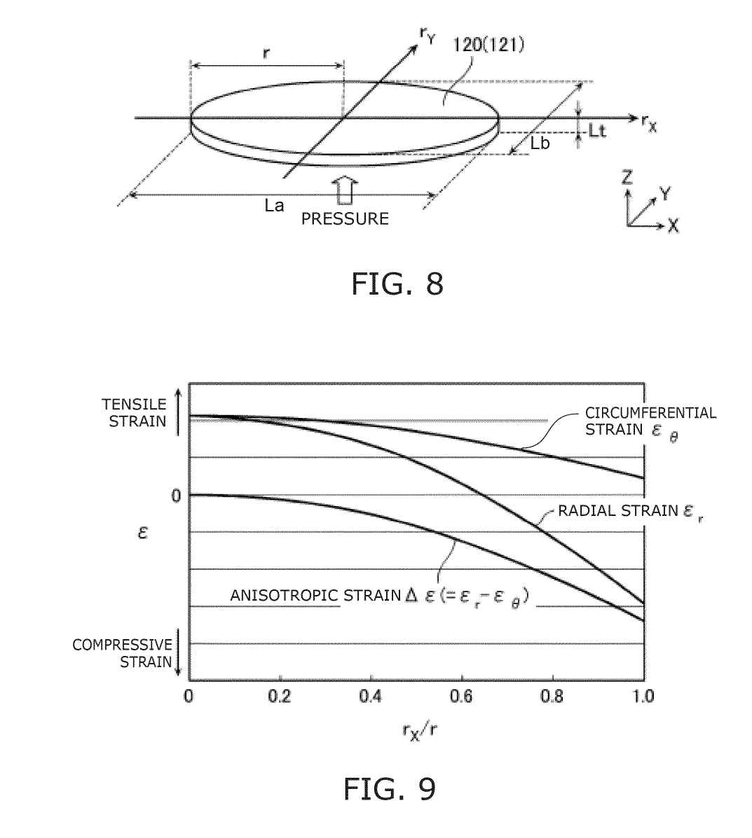

Next, the result of a simulation performed on the pressure sensor 100 is described with reference to FIGS. 8 to 10. This simulation calculates strain ε at each position on the film part 120 when the film part 120 is subjected to pressure. This simulation is performed by finite element analysis. More specifically, the surface of the film part 120 is partitioned into a plurality. Hooke's law is applied to each partitioned element.

FIG. 8 is a schematic perspective view illustrating a model used for simulation.

As shown in FIG. 8, in the simulation, the vibration part 121 of the film part 120 is circular. The diameter La (diameter Lb) of the vibration part 121 is 500 μm. The thickness Lt of the film part 120 is 2 μm. Furthermore, the outer edge of the vibration part 121 is a completely constrained fixed end.

In the simulation, it is assumed that the material of the film part 120 is silicon. Thus, the Young's modulus of the film part 120 is 165 gigapascals (GPa), and the Poisson's ratio is 0.22.

Furthermore, as shown in FIG. 8, the pressure is applied to the film part 120 from the lower surface. The magnitude of the pressure is 13.33 kPa, and the pressure is applied uniformly to the vibration part 121. In the finite element method, the vibration part 121 is partitioned in the XY-plane with a mesh size of 5 μm, and in the Z-direction with a spacing of 2 μm.

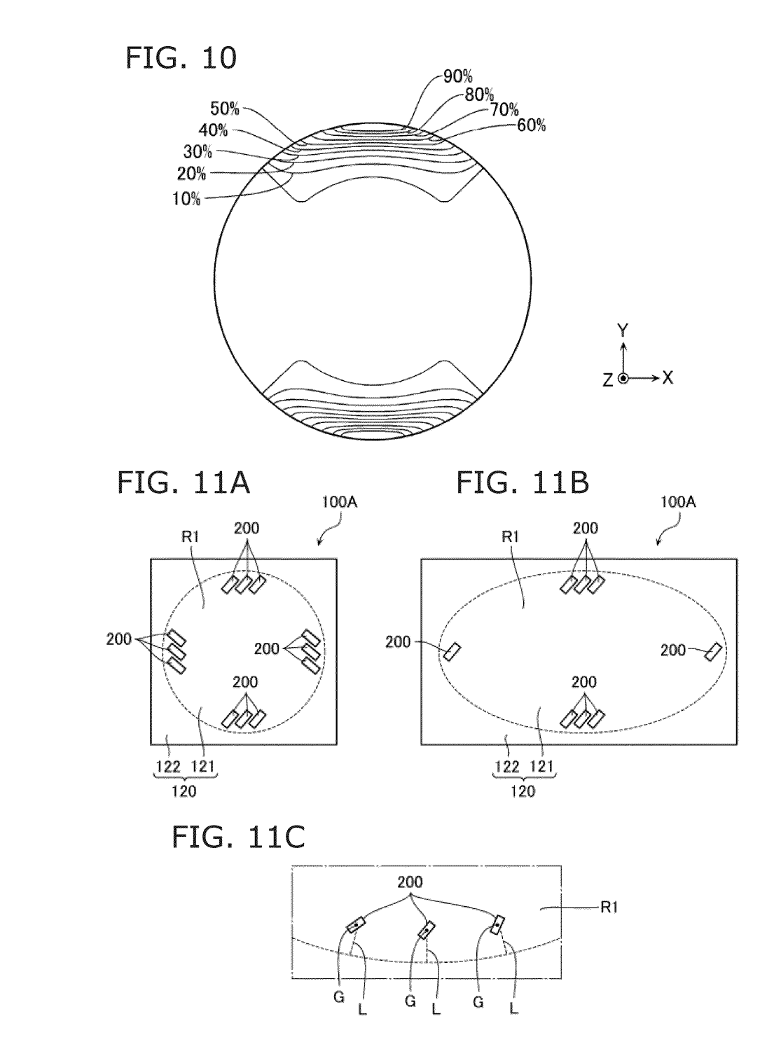

Next, the result of the simulation is described with reference to FIGS. 9 and 10.

FIG. 9 is a graph illustrating the simulation result. The vertical axis represents strain ε. The horizontal axis represents the value rₓ/r, defined as the distance rₓ of the vibration part 121 from the center normalized by the radius r. In FIG. 9, the strain in the tensile direction is represented as a strain in the positive direction, and the strain in the compressive direction is represented as a strain in the negative direction.

FIG. 9 shows the radial (X-direction) strain εᵣ, the circumferential strain ε_{θ}, and the anisotropic strain Δε (=εᵣ−ε_{θ}) defined as the difference between these strains. This anisotropic strain Δε contributes to the change in the magnetization direction of the first magnetic layer 201 due to the inverse magnetostriction effect as described with reference to FIGS. 3A to 3E.

As shown in FIG. 9, the radial strain εᵣ and the circumferential strain ε_{θ} are tensile around the center of the vibration part 121 where the bending is convex. In contrast, the radial strain εᵣ and the circumferential strain ε_{θ} are compressive near the outer edge where the bending is concave. The anisotropic strain Δε is zero around the center, indicating an isotropic strain. The anisotropic strain Δε exhibits a compressive value near the outer edge. The largest anisotropic strain is obtained in the immediate vicinity of the outer edge. In the circular vibration part 121, this anisotropic strain Δε is always similarly obtained in the radial direction from the center. Thus, the strain can be detected with high sensitivity by placing the strain sensing element 200 near the outer edge of the vibration part 121. Accordingly, the strain sensing element 200 can be placed partly near the outer edge of the vibration part 121.

FIG. 10 is a contour diagram illustrating the simulation result.

FIG. 10 shows the distribution in the XY-plane of the anisotropic strain Δε occurring in the vibration part 121. The anisotropic strain Δε in the polar coordinate system (Aε_{r-θ}) shown in FIG. 9 is transformed to the anisotropic strain Δε in the Cartesian coordinate system (Aε_{X-Y}) and analyzed on the entire surface of the vibration part 121. FIG. 10 illustrates the result of this analysis.

In FIG. 10, the lines labeled with “90%”−“10%”, respectively, represent the position where the obtained anisotropic strain Δε is “90%”−“10%” of the value (absolute value) of the largest anisotropic strain Aε_{X-Y} in the immediate vicinity of the outer edge of the vibration part 121. As shown in FIG. 10, the anisotropic strain Aε_{X-Y} with a similar magnitude is obtained in a limited region.

Here, a plurality of strain sensing elements 200 may be provided on the film part 120 as shown in e.g. FIG. 7A. In this case, the magnetization direction of the magnetization fixed layer is aligned with the annealing direction in the magnetic field for the purpose of pinning. Thus, the magnetization direction is directed in the same direction. Accordingly, the strain sensing elements 200 are preferably placed in the range where an anisotropic strain with a nearly uniform magnitude occurs.

In this respect, the strain sensing element 200 according to the first embodiment can achieve a high gauge factor (strain sensing sensitivity) even in a relatively small size. Thus, even in the case where the dimension of the film part 120 is small, a high gauge factor can be obtained by placing the strain sensing elements 200 in the range where an anisotropic strain with a nearly uniform magnitude occurs. Furthermore, a plurality of strain sensing elements 200 may be placed on the film part 120 to obtain an electrical resistance change (e.g., polarity) in response to a similar pressure. In this case, the strain sensing elements 200 are preferably placed in the vicinity of the region near the outer edge where a similar anisotropic strain Aε_{X-Y} is obtained as shown in FIG. 10. The strain sensing element 200 according to the first embodiment can achieve a high gauge factor (strain sensing sensitivity) even in a relatively small size. Thus, the strain sensing element 200 can be placed in a large number in the region near the outer edge where a similar anisotropic strain Aε_{X-Y} is obtained.

The strain sensing element 200 composed of the first magnetic layer 201, the intermediate layer 203, and the second magnetic layer 202 can be provided in a plurality and connected in series. The number of strain sensing elements 200 connected in series in a plurality is denoted by N. The obtained electrical signal is N times that in the case where the number of strain sensing elements 200 is one. On the other hand, thermal noise and Schottky noise are N^{1/2} times. That is, the SN ratio (signal-noise ratio, SNR) is N^{1/2} times. The SN ratio can be improved by increasing the number N of strain sensing elements 200 connected in series without upsizing the vibration part 121 of the film part 120. The strain sensing element 200 composed of the first magnetic layer 201, the intermediate layer 203, and the second magnetic layer 202 may be placed in a plurality on the film part 120 and connected. The strain sensing elements 200 may be placed in the vicinity of the region near the outer edge where a similar anisotropic strain Δε_{X-Y} is obtained. This can equalize the signal of a plurality of strain sensing elements 200 in response to pressure. Thus, a pressure sensor with high SN ratio can be realized by the aforementioned effect.

Here, the strain sensing element 200 according to this embodiment is placed in a plurality along the outer edge of the first region R1 in the first to fourth planar regions as described with reference to FIGS. 7A to 7F. Thus, a uniform strain can be detected by the plurality of strain sensing elements 200 placed in the first to fourth planar regions.

In this specification, placing a detection element “in close proximity” refers to the case as follows.

FIGS. 7A to 7F are schematic views illustrating examples of the placement of the strain sensing element 200 on the film part 120. FIGS. 7A to 7F illustrate the element placement region in the case where a plurality of strain sensing elements 200 are placed in close proximity.

As shown in FIG. 7A, the aforementioned smallest circumscribing rectangle can be formed when the first region R1 is projected on a surface (e.g., X-Y plane) parallel to the film part 120. The smallest circumscribing rectangle circumscribes the shape of the vibration part 121. The shape of the first region R1 is e.g. the shape obtained when the outer edge of the vibration part 121 shown by the dotted line in FIG. 7A is projected on the surface parallel to the film part 120. In this example, the planar shape of the first region R1 is circular. Thus, the smallest circumscribing rectangle is square.

As shown in FIG. 7A, the smallest circumscribing rectangle includes a first side, a second side, a third side, and a fourth side. The second side is spaced from the first side. The third side is connected to one end of the first side and one end of the second side. The fourth side is connected to the other end of the first side and the other end of the second side, and spaced from the third side. The smallest circumscribing rectangle has a barycenter. For instance, the barycenter coincides with the barycenter of the vibration part 121.

As described above, the smallest circumscribing rectangle includes a first planar region, a second planar region, a third planar region, and a fourth planar region. The first planar region is a region enclosed with the line segment connecting the barycenter and one end of the first side, the line segment connecting the barycenter and the other end of the first side, and the first side. The second planar region is a region enclosed with the line segment connecting the barycenter and one end of the second side, the line segment connecting the barycenter and the other end of the second side, and the second side. The third planar region is a region enclosed with the line segment connecting the barycenter and one end of the third side, the line segment connecting the barycenter and the other end of the third side, and the third side. The fourth planar region is a region enclosed with the line segment connecting the barycenter and one end of the fourth side, the line segment connecting the barycenter and the other end of the fourth side, and the fourth side.

As shown in FIG. 7A, a plurality of strain sensing elements 200 are provided on the portion of the first region R1 overlapping the first planar region (the hatched portion in the figure). For instance, at least two of the plurality of strain sensing elements 200 provided on the region of the first region R1 overlapping the first planar region are mutually different in position in the direction parallel to the first side of the smallest circumscribing rectangle. This placement enables placing numerous strain sensing elements 200 in the outer edge region where a similar anisotropic strain Δε_{X-Y} is obtained.

As shown in FIG. 7B, the smallest circumscribing rectangle can be defined also in the case where the planar shape of the vibration part 121 is flat circular. As shown in FIG. 7C, the smallest circumscribing rectangle can be defined also in the case where the planar shape of the vibration part 121 is square. In this case, the planar shape of the smallest circumscribing rectangle is square like the film part. In FIG. 7D, the planar shape of the vibration part 121 is square, and the vibration part 121 is provided with a curved (or linear) corner part. The smallest circumscribing rectangle can be defined also in this case. As shown in FIG. 7E, the smallest circumscribing rectangle can be defined also in the case where the planar shape of the vibration part 121 is rectangular. In this case, the planar shape of the smallest circumscribing rectangle is rectangular like the supported part 122. In FIG. 7F, the planar shape of the vibration part 121 is rectangular, and the vibration part 121 is provided with a curved (or linear) corner part. The smallest circumscribing rectangle can be defined also in this case. Then, the first to fourth planar regions can be defined.

The strain sensing elements 200 are placed in close proximity in the aforementioned region. This enables placing numerous strain sensing elements 200 in the region near the outer edge where a similar anisotropic strain Δε_{X-Y} is obtained.

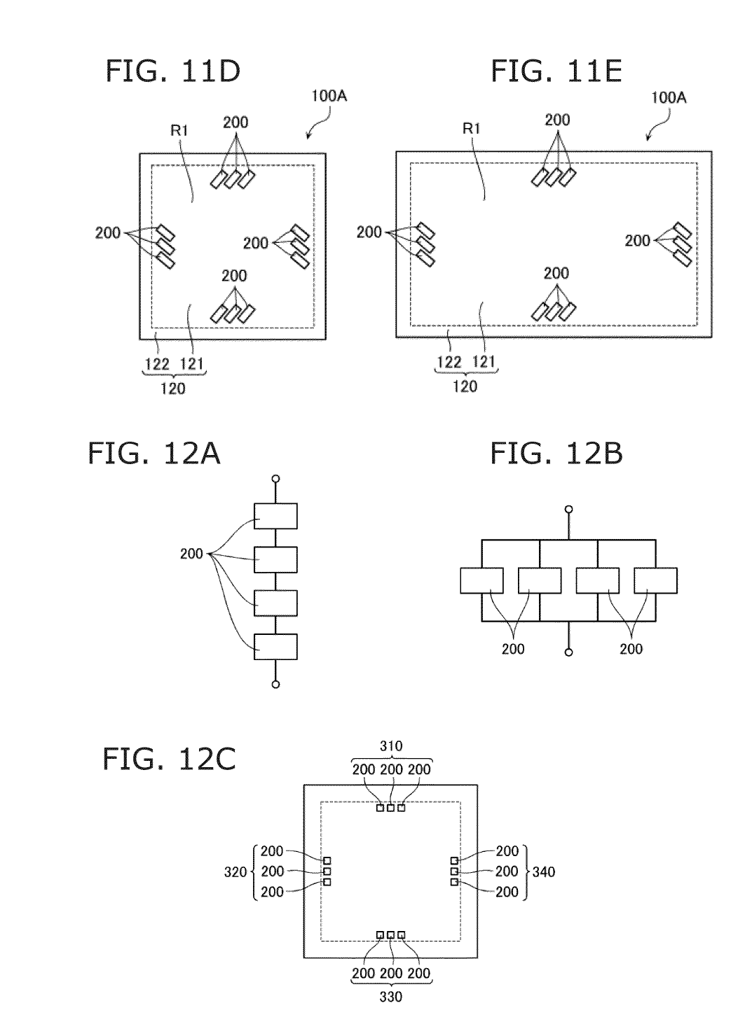

Next, alternative configuration examples of the pressure sensor 100 are described with reference to FIGS. 11A to 11E.

FIGS. 11A to 11E are schematic plan views illustrating alternative pressure sensors according to the first embodiment.

The pressure sensors 100 shown in FIGS. 11A to 11E are configured nearly similarly to the pressure sensors 100 shown in FIGS. 7A to 7F. However, the pressure sensors 100 shown in FIGS. 11A to 11E are different in that the first magnetic layer 201 included in the strain sensing element 200 is formed in a generally rectangular shape rather than a generally square shape.

FIG. 11A shows a mode in which the vibration part 121 of the film part 120 is generally circular. FIG. 11B shows a mode in which the vibration part 121 of the film part 120 is generally oval. FIG. 11D shows a mode in which the vibration part 121 of the film part 120 is generally square. FIG. 11E shows a mode in which the vibration part 121 of the film part 120 is generally rectangular. FIG. 11C is a partially enlarged view of FIG. 11B.

As shown in FIG. 11C, a plurality of strain sensing elements 200 are placed on the film part 120 along the outer edge of the first region R1. Here, the line connecting the barycenter G of the strain sensing element 200 and the outer edge of the first region R1 in the shortest distance is denoted by line L. The angle between the direction of this line L and the longitudinal direction of the first magnetic layer 201 included in the strain sensing element 200 is set to larger than 0° and smaller than 90°.

As described above, the first magnetic layer 201 included in the strain sensing element 200 may be formed in a shape having a shape magnetic anisotropy such as a rectangle or oval. In this case, the initial magnetization direction of the magnetization free layer 210 can be set in the longitudinal direction. The direction of the line L shown in FIG. 11C indicates the direction of strain occurring in the strain sensing element 200. The angle between the direction of this line L and the longitudinal direction of the first magnetic layer 201 included in the strain sensing element 200 is set to larger than 0° and smaller than 90°. This can adjust the initial magnetization direction of the magnetization free layer 210 and the direction of strain occurring in the strain sensing element 200. Thus, a pressure sensor responsive to positive and negative pressure can be manufactured. More preferably, this angle is 30 degrees or more and 60 degrees or less.

The difference between the maximum and the minimum of the aforementioned angle may be set to e.g. five degrees or less. In this case, a similar pressure-electrical resistance characteristic can be obtained by a plurality of strain sensing elements 200.

In the examples shown in FIGS. 11A to 11E, the pressure sensor 100 includes a plurality of strain sensing elements 200. However, the pressure sensor 100 may include only one strain sensing element 200.

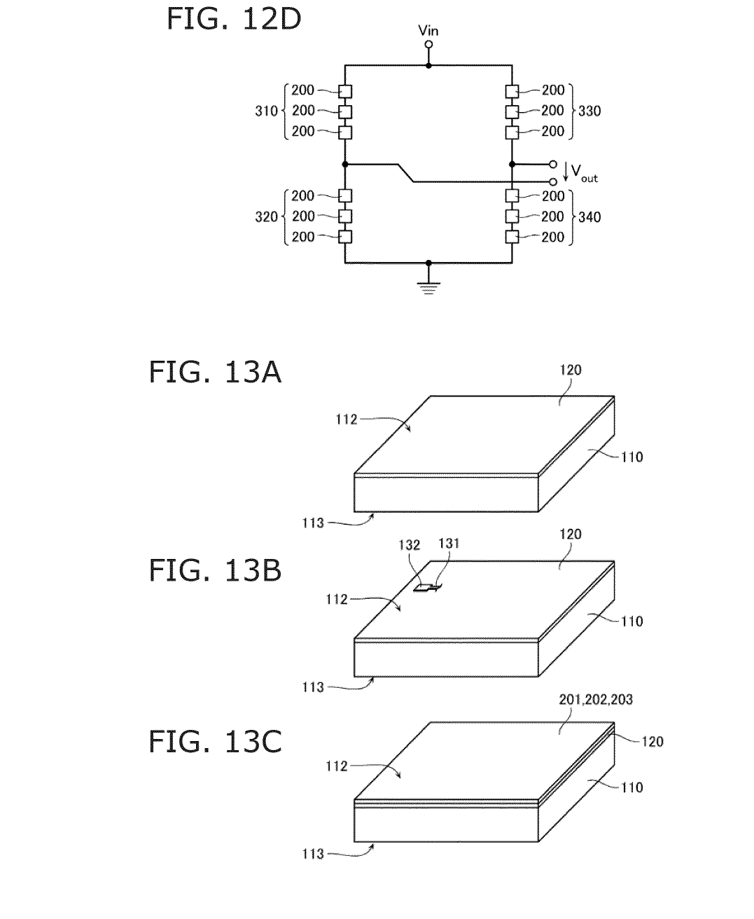

Next, the wiring pattern of the strain sensing elements 200 is described with reference to FIGS. 12A to 12D.

FIGS. 12A to 12D are schematic views illustrating the wiring pattern of the strain sensing elements according to the first embodiment. FIGS. 12A, 12B, and 12D are schematic circuit diagrams. FIG. 12C is a schematic plan view.

A plurality of strain sensing elements 200 may be provided in the pressure sensor 100. In this case, for instance, all the strain sensing elements 200 may be connected in series as shown in FIG. 12A. Here, the bias voltage of the strain sensing element 200 is e.g. 50 millivolts (mV) or more and 150 mV or less. In the case where N strain sensing elements 200 are connected in series, the bias voltage is 50 mV×N or more and 150 mV×N or less. For instance, in the case where the number N of strain sensing elements connected in series is 25, the bias voltage is 1 V or more and 3.75 V or less.

A bias voltage with a value of 1 V or more facilitates the design of an electrical circuit for processing an electrical signal obtained from the strain sensing element 200, and is practically desirable. On the other hand, a bias voltage (terminal-to-terminal voltage) exceeding 10 V is undesirable in an electrical circuit for processing an electrical signal obtained from the strain sensing element 200. In the embodiment, the number N of strain sensing elements 200 connected in series and the bias voltage are set so as to provide an appropriate voltage range.

For instance, the voltage of a plurality of strain sensing elements 200 electrically connected in series is preferably 1 V or more and 10 V or less. For instance, the voltage applied between the terminals (between the terminal at one end and the terminal at the other end) of a plurality of strain sensing elements 200 electrically connected in series is 1 V or more and 10 V or less.

To generate this voltage in the case where the bias voltage applied to one strain sensing element 200 is 50 mV, the number N of strain sensing elements 200 connected in series is preferably 20 or more and 200 or less. In the case where the bias voltage applied to one strain sensing element 200 is 150 mV, the number N of strain sensing elements 200 connected in series is preferably 7 or more and 66 or less.

Alternatively, all the plurality of strain sensing elements 200 may be connected in parallel as shown in e.g. FIG. 12B.

Alternatively, as shown in e.g. FIG. 12C, a plurality of strain sensing elements 200 may be placed in each of the first to fourth planar regions described with reference to FIGS. 7A to 7F. These groups of strain sensing elements 200 are referred to as first to fourth strain sensing element groups 310, 320, 330, and 340, respectively. Then, as shown in FIG. 12D, a Wheatstone bridge circuit may be configured by the first to fourth strain sensing element groups 310, 320, 330, and 340. Here, the first strain sensing element group 310 and the third strain sensing element group 330 shown in FIG. 12D can provide a strain-electrical resistance characteristic of the same polarity. The second strain sensing element group 320 and the fourth strain sensing element group 340 can provide a strain-electrical resistance characteristic of the opposite polarity to that of the first strain sensing element group 310 and the third strain sensing element group 330. The number of strain sensing elements 200 included in the first to fourth strain sensing element groups 310, 320, 330, and 340 may be one. Thus, for instance, temperature compensation of the detection characteristic can be performed.

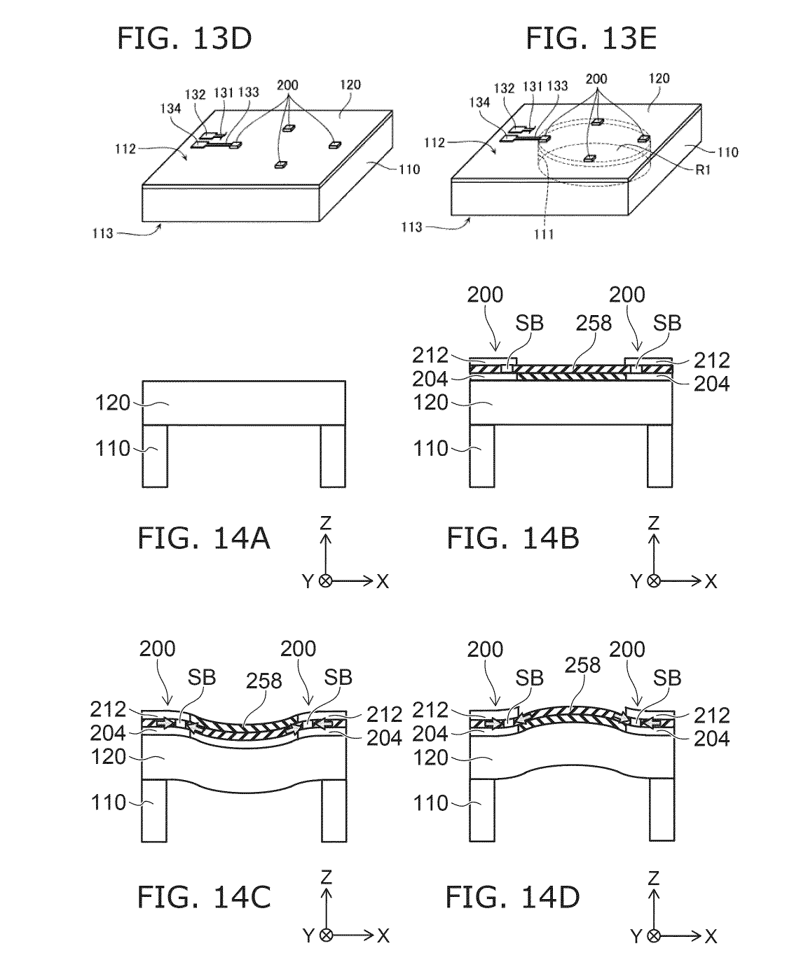

Next, a method for manufacturing the pressure sensor 100 according to this embodiment is described with reference to FIGS. 13A to 13E.

FIGS. 13A to 13E are schematic perspective views illustrating a method for manufacturing a pressure sensor according to the embodiment.

In the method for manufacturing the pressure sensor 100 according to this embodiment, as shown in FIG. 13A, a film part 120 is formed on one surface 112 of the substrate 110. In the case where the substrate 110 is e.g. a Si substrate, the film part 120 may be formed as a thin film of SiOₓ/Si by sputtering.

The substrate 110 may be e.g. an SOI (silicon on insulator) substrate. In this case, a stacked film of SiO₂/Si on the Si substrate may be used as the film part 120. In this case, formation of the film part 120 is the lamination of a Si substrate with a stacked film of SiO₂/Si.

Next, as shown in FIG. 13B, a wiring 131 and a pad 132 are formed on one surface 112 of the substrate 110. More specifically, a conductive film constituting a wiring 131 and a pad 132 is formed. The conductive film is removed while leaving a part. This step may use photolithography and etching, or may use lift-off.

The periphery of the wiring 131 and the pad 132 may be buried with an insulating film, not shown. This may be performed by e.g. lift-off. In the lift-off, for instance, the pattern of the wiring 131 and the pad 132 is etched. Then, an insulating film, not shown, is formed on the entire surface before removing the resist. Subsequently, the resist is removed.

Next, as shown in FIG. 13C, a first magnetic layer 201, a second magnetic layer 202, and an intermediate layer 203 located between the first magnetic layer 201 and the second magnetic layer 202 are formed on one surface 112 of the substrate 110.

Next, as shown in FIG. 13D, the first magnetic layer 201, the second magnetic layer 202, and the intermediate layer 203 are removed while leaving a part to form a strain sensing element 200. This step may use photolithography and etching, or may use lift-off.

The periphery of the strain sensing element 200 may be buried with an insulating film, not shown. This may be performed by e.g. lift-off. In the lift-off, for instance, the pattern of the strain sensing element 200 is etched. Then, an insulating film, not shown, is formed on the entire surface before removing the resist. Subsequently, the resist is removed.

Next, as shown in FIG. 13D, a wiring 133 and a pad 134 are formed on one surface 112 of the substrate 110. More specifically, a conductive film constituting a wiring 133 and a pad 134 is formed. The conductive film is removed while leaving a part. This step may use photolithography and etching, or may use lift-off.

The periphery of the wiring 133 and the pad 134 may be buried with an insulating film, not shown. This may be performed by e.g. lift-off. In the lift-off, for instance, the pattern of the wiring 133 and the pad 134 is etched. Then, an insulating film, not shown, is formed on the entire surface before removing the resist. Subsequently, the resist is removed.

Next, as shown in FIG. 13E, part of the substrate 110 is removed from the other surface 113 of the substrate 110 to form a hollow part 111 in the substrate 110. The region removed in this step is a portion corresponding to the first region R1 of the substrate 110. In this embodiment, the portion located in the first region R1 of the substrate 110 is entirely removed. However, part of the substrate 110 can be left. For instance, the film part 120 may be formed integrally with the substrate 110. In this case, the substrate 110 may be partly removed and thinned. This thinned portion may be used as the film part 120.

In this embodiment, the step shown in FIG. 13E uses etching. For instance, the film part 120 may be a stacked film of SiO₂/Si. In this case, this step may be performed by deep digging from the other surface 113 of the substrate 110. Furthermore, this step can use a double-sided aligner exposure apparatus. Thus, the other surface 113 can be patterned with the hole pattern of the resist in alignment with the position of the strain sensing element 200.

The etching can use e.g. the Bosch process based on RIE. The Bosch process repeats e.g. an etching step using SF₆ gas and a deposition step using C₄F₈ gas. Thus, etching is selectively performed in the depth direction (Z-axis direction) of the substrate 110 while suppressing etching of the sidewall of the substrate 110. The endpoint of etching is e.g. a SiOₓ layer. That is, etching is terminated by using a SiOₓ layer different in etching selection ratio from Si. The SiOₓ layer functioning as an etching stopper layer may be used as part of the substrate 110. The SiOₓ layer may be removed by treatment with e.g. anhydrous hydrogen fluoride and alcohol after etching. The etching of the substrate 110 may be based on anisotropic etching by the wet process or etching using a sacrificial layer besides the Bosch process.

The relationship between the residual stress of the electrode and the sensitivity of the pressure sensor is described below.

FIGS. 14A to 14D are schematic sectional views illustrating the operation of the pressure sensor. FIGS. 14A to 14D show the influence of the electrode on the pressure sensor in the state of no pressure difference between the two sides of the film part 120.

FIG. 14A illustrates the case of no electrode or stacked body on the film part 120.

FIG. 14B illustrates the case where an electrode and a stacked body SB are placed on the film part 120, and the residual stress of the first electrode (lower electrode 204) and the second electrode (upper electrode 212) is sufficiently small.

FIG. 14C illustrates the case where an electrode and a stacked body are placed on the film part 120, and the residual stress of the first electrode and the second electrode is a large compressive stress.

FIG. 14D illustrates the case where an electrode and a stacked body are placed on the film part 120, and the residual stress of the first electrode and the second electrode is a large tensile stress.

An insulating layer 258 for insulation between the electrodes and between the elements is provided on the film part 120. The insulating layer 258 may have a stacked structure.

Here, the examples of FIGS. 14A to 14D show the case where the magnitude of the residual stress of the film part 120 is zero, or the case where the residual stress of the film part 120 is a tensile stress. In the case where the residual stress of the film part 120 is compressive, an initial warpage may occur even in the state of no pressure difference between the two sides of the film part 120.

As shown in FIG. 14A, in the case of only the film part 120, the film part 120 has a flat shape without vertical warpage in the state of no pressure difference between the two sides of the film part 120. This film part 120 is vertically warped under external application of pressure and functions as a pressure sensor.

In FIG. 14B, the residual stress of the electrode of the detection element 200 provided on the film part 120 is sufficiently small. In this case, the influence of the electrode on the shape of the film part 120 is sufficiently small. The film part 120 can maintain a flat shape without vertical warpage in the state of no pressure difference between the two sides of the film part 120.

Thus, by decreasing the initial bending, the shape change of the film part 120 can be made linear and larger in response to both positive and negative external pressure. This can provide a high-sensitivity pressure sensor.

On the other hand, as shown in FIG. 14C, the volume of the electrode itself tries to expand in the case where the electrode on the film part 120 has a large compressive stress. Thus, the film part 120 on the side provided with the electrode is subjected to an expanding force from the electrode. Accordingly, the film part 120 convexly bends opposite to the side provided with the electrode. This results in a state in which a tensile strain is applied to the strain sensing element 200 in the direction perpendicular to the outer edge of the film part 120. In such a state, the film part 120 has been significantly deformed in the state of no pressure difference between the two sides of the film part 120 (what is called the state of zero application pressure). In such a deformed region (large bending region), the bending change of the film part 120 in response to pressure is decreased by the influence of internal stress of the film part 120. This is undesirable because of sensitivity decrease of the pressure sensor in response to pressure change in the state in which the application pressure is nearly zero.

Likewise, as shown in FIG. 14D, the volume of the electrode itself tries to shrink in the case where the electrode on the film part 120 has a large tensile stress. Thus, the film part 120 on the side provided with the electrode is subjected to a shrinking force from the electrode. Accordingly, the film part 120 convexly bends to the side provided with the electrode. This results in a state in which a compressive strain is applied to the strain sensing element 200 in the direction perpendicular to the outer edge of the film part 120. In such a state, the film part 120 has been significantly deformed in the state of no pressure difference between the two sides of the film part 120 (what is called the state of zero application pressure). In such a deformed region (large bending region), the bending change of the film part 120 in response to pressure is decreased by the influence of internal stress of the film part 120. This is undesirable because of sensitivity decrease of the pressure sensor in response to pressure change in the state in which the application pressure is nearly zero.

The residual stress of the electrodes (first electrode and second electrode) provided on the film part 120 is preferably set to a sufficiently low value. This can provide a pressure sensor having high sensitivity to pressure.

The influence of the electrode on the bending change of the film part 120 in response to external pressure, and the strain change on the film part 120, was verified by simulation.

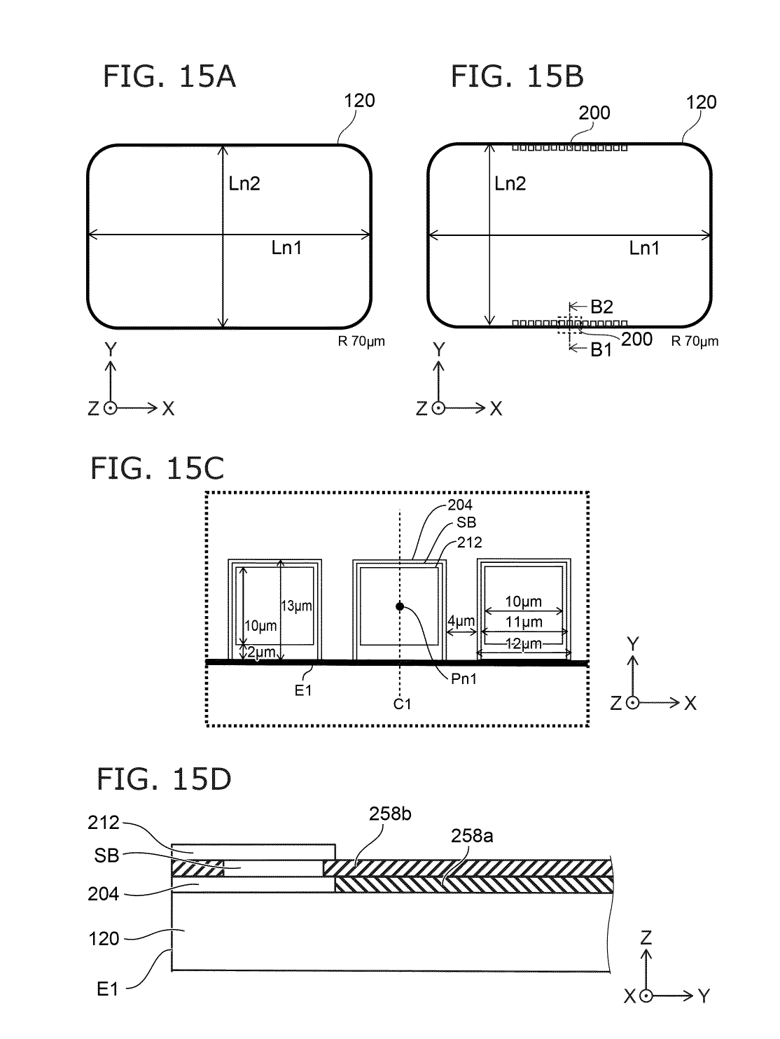

FIGS. 15A to 15D are schematic views illustrating a pressure sensor used for simulation. This simulation is performed by finite element analysis. More specifically, the film part 120 and the electrode are partitioned into a plurality. Hooke's law is applied to each partitioned element.

FIGS. 15A and 15B are schematic plan views for describing the planar shape of pressure sensors used for simulation.

FIG. 15A shows a model of only the film part 120 with no electrode. FIG. 15B is a planar shape diagram in the case where the strain sensing elements 200 (lower electrode 204, upper electrode 212, stacked body SB, and insulating layer 258) are placed on the film part 120. As shown in FIGS. 15A and 15B, in the simulation, the shape of the vibration part 121 of the film part 120 is a rectangle with rounded corners. The long side Ln1 of the vibration part 121 is 587 μm, and the short side Ln2 of the vibration part 121 is 376 μm. Furthermore, the outer edge E1 of the vibration part 121 is a completely constrained fixed end.

In the simulation, it is assumed that the material of the film part 120 is aluminum oxide. Thus, the Young's modulus of the film part 120 is 120 GPa, and the Poisson's ratio is 0.24.

In the example shown in FIG. 15B, a plurality of strain sensing elements 200 are placed in the end part on the long side of a generally rectangular film part 120. FIG. 15C is a partially enlarged view of part (the portion enclosed with the dotted line of FIG. 15B) of the region provided with the strain sensing elements 200. The planar shape of the lower electrode 204 (first electrode), the stacked body SB, and the upper electrode 212 (second electrode) of the strain sensing element 200 in FIG. 15B is as shown in FIG. 15C.

In this simulation, a pressure is applied to the film part 120. Then, this simulation calculates the displacement at the center of the film part 120 and the strain ε at the position of the strain sensing element 200 on the film part 120. The planar position for calculating the strain is position Pn1 shown in FIG. 15C. The position Pn1 is located at the center (C1) in the long-axis direction (longitudinal direction) of the film part 120. The position Pn1 is located at 7 μm inside the end part of the film part 120. Also in the case of no electrode in FIG. 15A, the planar position for calculating the strain is located at 7 μm inside the end part of the film part at the center in the long-axis direction.

FIG. 15D shows a cross section of the end part provided with the strain sensing element 200 of the pressure sensor. FIG. 15D corresponds to the cross section taken along line B1-B2 of FIG. 15B. As shown in FIG. 15D, the periphery of the lower electrode 204 and the stacked body SB is buried with an insulating layer 258. Here, it is assumed that the material of the insulating layer 258 is aluminum oxide. The Young's modulus of the film part 120 is 120 GPa, and the Poisson's ratio is 0.24. It is assumed that the material of the lower electrode 204 and the upper electrode 212 is Cu alloy, Ta alloy, or a stacked body thereof. The Young's modulus of the lower electrode 204 is 140 GPa, and the Poisson's ratio is 0.34. Likewise, the Young's modulus of the upper electrode 212 is 140 GPa, and the Poisson's ratio is 0.34. The Young's modulus of the stacked body SB is 140 GPa, and the Poisson's ratio is 0.34.

In the example of only the film part 120 in FIG. 15A, the thickness of the film part 120 is 700 nm. In the example of the pressure sensor shown in FIGS. 15B and 15D, the strain sensing elements 200 are provided on the film part 120. In this example, the thickness of the film part 120 is 700 nm. The thickness of the lower electrode 204 is 100 nm. The thickness of the stacked body SB is 100 nm. The thickness of the upper electrode 212 is 100 nm. Here, the thickness of the insulating layer 258a around the lower electrode 204 is made equal to the thickness of the lower electrode 204. The thickness of the insulating layer 258b around the stacked body SB is made equal to the thickness of the stacked body SB.

In the example of only the film part 120 in FIG. 15A, calculation of strain is performed at the topmost surface of the film part 120.

In the example of FIGS. 15B, 15C, and 15D, calculation of strain is performed at the interface between the stacked body SB and the upper electrode 212.

Here, the calculation of strain calculates the strain εₓ in the long-axis direction (X-direction) and the strain ε_{y} in the short-axis direction (Y-direction). Then, the difference ε_{y}−εₓ is calculated. In the strain sensing element 200 of this embodiment, the change of ε_{y}−εₓ (anisotropic strain) applied to the stacked body SB in response to pressure is proportional to the sensitivity of the pressure sensor. Thus, a pressure sensor with higher sensitivity can be provided as the change of ε_{y}−εₓ in response to pressure is larger.

For the pressure sensors shown in FIG. 15A and FIGS. 15B to 15D, the influence of the residual stress of the electrode on the pressure sensor characteristic was studied by simulation.

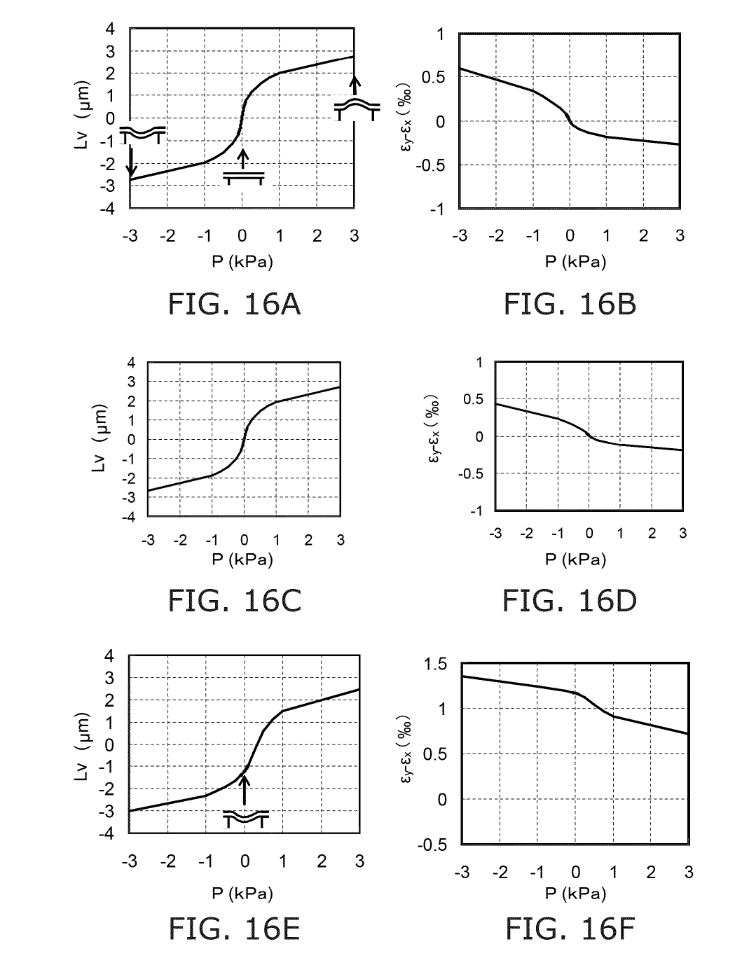

FIGS. 16A to 16F are graphs illustrating the simulation result of the characteristic of the pressure sensors.

FIG. 16A shows a calculation result for the change of displacement Lv at the film part center in response to application pressure P in the pressure sensor illustrated in FIG. 15A. FIG. 16A shows a calculation result for the change of strain at the film part surface in response to application pressure P in the pressure sensor illustrated in FIG. 15A.

The application pressure P herein is applied from the surface on the opposite side of the surface where the strain is calculated. The positive pressure is defined as the application pressure P being positive. The negative pressure is defined as the application pressure P being negative. The calculation is performed assuming that the residual stress of the film part 120 is 0 megapascals (MPa).

As shown in FIG. 16A, in the film part 120 with no electrode, the center displacement at positive pressure and the center displacement at negative pressure are symmetric. It is found that the center displacement changes linearly near zero application pressure P. As shown in FIG. 16B, in the case of no electrode, the change of anisotropic strain ε_{y}−εₓ at the film part surface in response to pressure is linear near zero application pressure P. Furthermore, it is found that the amount of change of anisotropic strain ε_{y}−εₓ in response to pressure is maximized near zero application pressure P. The sensitivity changes linearly and is maximized near zero application pressure P. Such a film part 120 is preferable in a device such as a microphone in which the film part 120 is alternately subjected to positive pressure and negative pressure.

FIGS. 16C and 16D show the characteristic of the pressure sensor provided with the strain sensing elements. The planar shape of the pressure sensor is described above with reference to FIGS. 15B to 15D. FIG. 16C shows a calculation result for the change of displacement Lv at the film part center in response to application pressure P. FIG. 16D shows a calculation result for the change of strain at the stacked body surface in response to application pressure P.

The calculation is performed assuming that the residual stress of the film part 120 is +1 MPa. The residual stress of the lower electrode 204 and the residual stress of the upper electrode 212 are each set to a sufficiently small value (−5 MPa).

As shown in FIG. 16C, in the case where the residual stress of the electrode is sufficiently small, the center displacement at positive pressure and the center displacement at negative pressure are symmetric. It is found that the center displacement changes linearly near zero application pressure P. As shown in FIG. 16D, in the case where the residual stress of the electrode is sufficiently small, the change of anisotropic strain ε_{y}−εₓ at the stacked body surface in response to pressure is linear near zero application pressure P. Furthermore, it is found that the amount of change of anisotropic strain ε_{y}−εₓ in response to pressure is maximized near zero application pressure P. The sensitivity changes linearly and is maximized near zero application pressure P. Such a film part 120 is preferable in a device such as a microphone in which the film part 120 is alternately subjected to positive pressure and negative pressure.

FIGS. 16E and 16F show the characteristic of the pressure sensor provided with the strain sensing elements. The planar shape of the pressure sensor is described with reference to FIGS. 15B to 15D. FIG. 16E shows a calculation result for the change of displacement Lv at the film part center in response to application pressure P. FIG. 16F shows a calculation result for the change of strain at the stacked body surface in response to application pressure P.

The calculation is performed assuming that the residual stress of the film part 120 is +1 MPa. The residual stress of the lower electrode 204 and the residual stress of the upper electrode 212 are each set to a large value (−600 MPa).

As shown in FIG. 16E, in the case where the residual stress of the electrode is large, the center displacement at positive pressure and the center displacement at negative pressure are asymmetric. As shown in FIG. 16F, in the case where the residual stress of the electrode is large, the amount of change of anisotropic strain C_{y}−εₓ at the stacked body surface in response to pressure is not maximized near zero application pressure P. The application pressure maximizing the amount of change of anisotropic strain ε_{y}−εₓ at the stacked body surface in response to pressure is shifted to the positive pressure side and is approximately 0.4 kPa. Such a pressure sensor with sensitivity not maximized near zero application pressure P is undesirable particularly in a device such as a microphone in which the film part is alternately subjected to positive pressure and negative pressure.

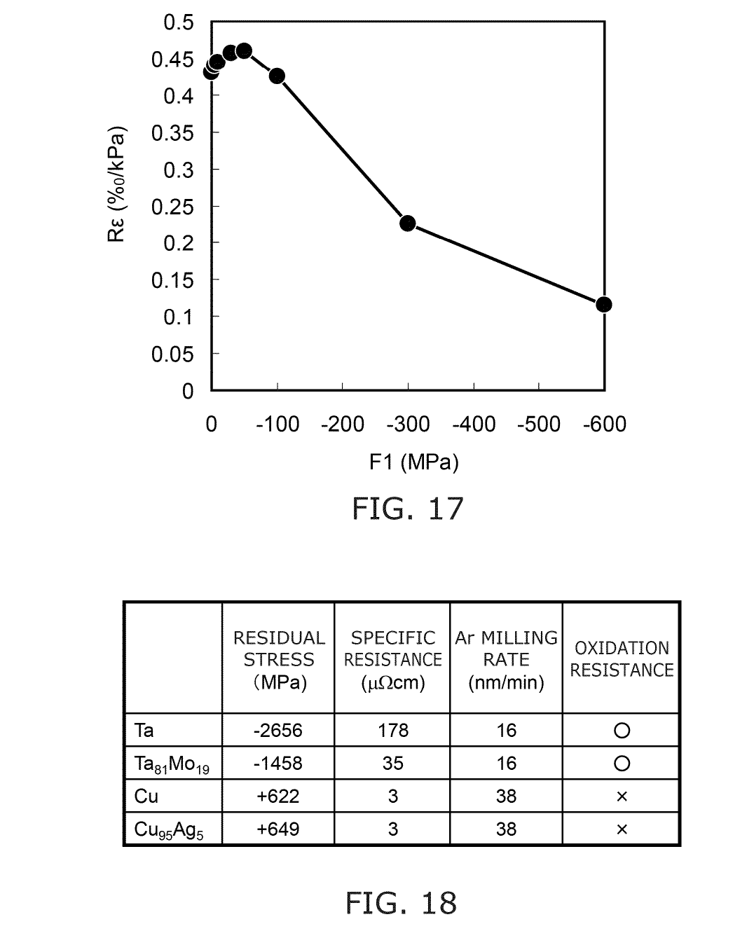

FIG. 17 is a graph illustrating the simulation result of the characteristic of the pressure sensor.

FIG. 17 shows the characteristic of the pressure sensor provided with the strain sensing elements. The planar shape of the pressure sensor is described with reference to FIGS. 15B to 15D. FIG. 17 shows a calculation result for the amount of change of anisotropic strain at the stacked body surface near zero application pressure P. Here, the residual stress of the lower electrode 204 and the residual stress of the upper electrode 212 are simultaneously changed from 0 MPa to −600 MPa. The residual stress of the film part 120 is +1 MPa. The vertical axis of FIG. 17 represents the amount of change RE of anisotropic strain in response to pressure. The horizontal axis of FIG. 17 represents the average residual stress F1 of the electrode.

The amount of change RE of anisotropic strain in response to pressure is maximized when the absolute value of the average residual stress F1 (the average of the residual stress of the first electrode and the residual stress of the second electrode) is 100 MPa or less. As shown in FIG. 17, it is found that the amount of change RE of anisotropic strain in response to pressure has a high value in the case of 100 MPa or less.

In the embodiment, the absolute value of the residual stress of the first electrode is 100 MPa or less. The absolute value of the residual stress of the second electrode is 100 MPa or less. Thus, the residual stress of the first electrode and the second electrode is set to a small value in the pressure sensor of this embodiment. This can provide a pressure sensor exhibiting high sensitivity near zero pressure. In such a pressure sensor, the strain change between the state of zero application pressure and the state subjected to a desired pressure can be made large and linear. Thus, such a pressure sensor is preferable not only in a microphone subjected to both positive and negative pressure, but also in a pressure sensor for measuring only positive pressure or only negative pressure.

With the increase in the thickness of the first electrode and the thickness of the second electrode, the influence of the film part 120 on the initial deformation is more significant. Thus, the thickness of the first electrode and the thickness of the second electrode are preferably thin. Each thickness is preferably 200 nm or less, and more preferably 100 nm or less.

In this embodiment, a Ta—Mo alloy layer may be provided in the lower electrode 204 (first electrode) of the strain sensing element 200 placed on the film part 120. This can provide a high-sensitivity pressure sensor. In this embodiment, a Ta—Mo alloy layer may be provided in the upper electrode 212 (second electrode) of the strain sensing element 200 placed on the film part 120. This can provide a high-sensitivity pressure sensor.

As described above, the residual stress of each of the lower electrode 204 and the upper electrode 212 has a low value in the pressure sensor of this embodiment. This can provide a pressure sensor having a sensitivity maximized near zero application pressure.

On the other hand, the lower electrode 204 and the upper electrode 212 are restricted in the available material from the viewpoint of other than the residual stress. First, the electrode material is preferably resistant to oxidation at the time of exposure to atmosphere after the formation of the electrode and before the overlying layer is provided. Furthermore, the electrode material is preferably resistant to oxidation in e.g. the oxygen ashing step used for resist removal in the element formation process.

The stacked body SB formed on the lower electrode 204 is a stacked body of metal films or oxide films including a plurality of materials. The processing of the stacked body SB is typically based on physical milling. Thus, a material having a slow physical milling rate and functioning as a stopper layer is preferably placed at the topmost surface of the lower electrode 204 provided below the stacked body SB.

FIG. 18 shows a table illustrating the characteristics of materials of the electrode confirmed by experiments performed by the inventors. FIG. 18 shows residual stress, specific resistance, Ar milling rate, and the presence or absence of oxidation resistance.

These results are obtained after a film of various materials is formed and then subjected to heat treatment at 360° C. for 6 H. As shown in FIG. 18, in the Ta layer, a passivation coating is formed at the surface. Thus, the Ta layer also has high oxidation resistance, and sufficiently slow physical milling rate. From these viewpoints, the Ta layer is preferably used at the topmost surface (first electrode cap layer) of the lower electrode 204 and the topmost surface (second electrode cap layer) of the upper electrode 212.

Here, Ta has high specific resistance as shown in FIG. 18. Thus, from the viewpoint of sufficiently decreasing the wiring resistance, it is undesirable to form the lower electrode 204 and the upper electrode 212 from a monolayer of Ta. From this viewpoint, the electrode is preferably formed by stacking the Ta layer with a material having sufficiently low specific resistance such as Cu layer and Cu₉₅Ag₅ layer. For instance, a three-layer structure such as Ta/Cu₉₅Ag₅/Ta is preferable. Here, the Ta layer as an underlayer in the electrode is preferably 3-10 nm. The Ta layer as a cap layer in the electrode is preferably 25 nm or more from the viewpoint of sufficiently developing the oxidation prevention function and fulfilling the physical milling stopper function. The Ta layer as a cap layer in the electrode is preferably 25 nm or more and 100 nm or less.

Here, according to the result for Ta in FIG. 18 from the viewpoint of residual stress, Ta has a very large compressive residual stress of −2656 MPa. On the other hand, Cu and Cu₉₅Ag₅ have a tensile residual stress of approximately +600 MPa. Thus, in the aforementioned electrode having a stacked structure of Ta and CuAg, the compressive stress and the tensile stress weaken (e.g., cancel) each other. However, the absolute value of the compressive stress of Ta is much larger than the absolute value of the tensile stress of Cu and CuAg. This is preferable from the viewpoint of providing the aforementioned high-sensitivity pressure sensor. It is difficult to provide an electrode in which the absolute value of the residual stress is 100 MPa or less.

On the other hand, as a result of diligent investigations by the inventors, as shown in FIG. 18, in the Ta—Mo alloy including Ta and Mo, the residual stress is reduced to approximately 55% of Ta. Furthermore, the Ta—Mo alloy is comparable to Ta in oxidation resistance and low physical milling rate necessary for the topmost material of the electrode. Such a Ta—Mo alloy including Ta and Mo may be used for the first electrode or the second electrode. This can reduce the residual stress of the electrode and provide a high-sensitivity pressure sensor.

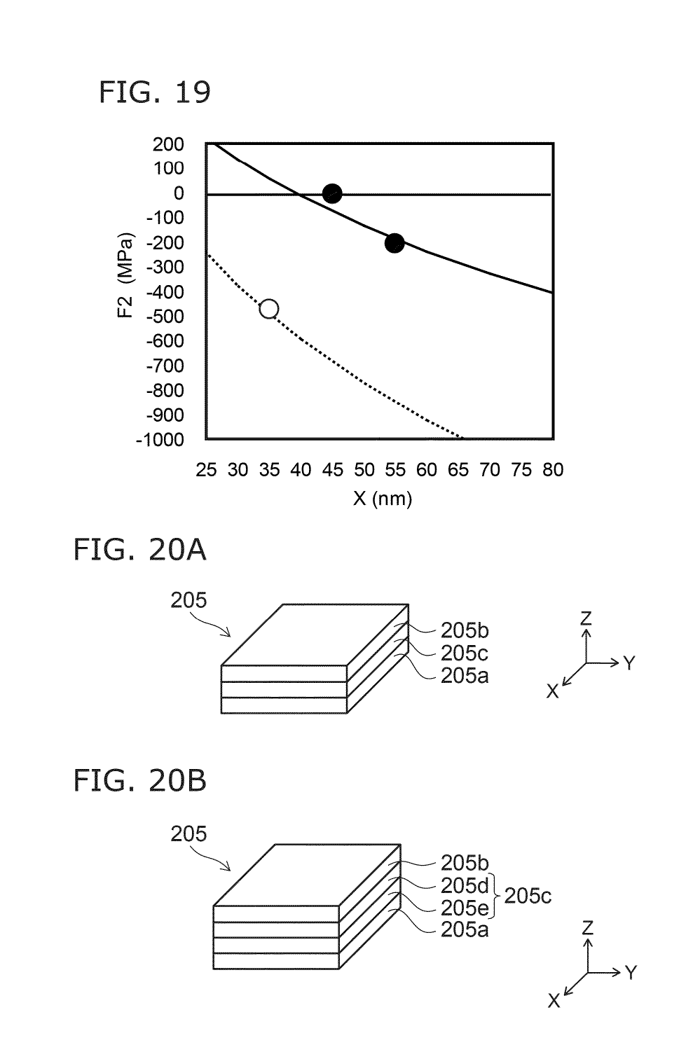

FIG. 19 is a graph illustrating the characteristic of the electrode of the strain sensing element.

FIG. 19 shows the dependence of the residual stress F2 (MPa) in the electrode of the strain sensing element on the thickness Tc (nm) of the cap layer of the electrode. In this experiment, the material of the cap layer is Ta—Mo and Ta.

In Specific example 1,

Ta₈₁Mo₁₉(5 nm)/Cu₉₅Ag₅(60 nm)/Ta₈₁Mo₁₉(Tc nm)

was fabricated, and the residual stress was examined.

In Comparative example 1,

Ta(5 nm)/Cu₉₅Ag₅(60 nm)/Ta(Tc nm)

was fabricated, and the residual stress was examined.

These results are also obtained after a film of various materials is formed and then subjected to heat treatment at 360° C. for 6 hours. In FIG. 19, the filled circle and the solid line represent the data of Specific example 1. The open circle and the dashed line represent the data of Comparative example 1. The solid line and the dashed line are the result of fitting in view of the ratio of the thickness of films based on the result for the residual stress of various monolayers of Ta, CuAg, and TaMo in FIG. 18.

In the case of using Ta of Comparative example 1, the thickness of the electrode (the total thickness of the films) may be designed to be approximately 100 nm. Then, it is found from FIG. 19 that a residual stress of 100 MPa or less in absolute value cannot be achieved if the thickness of the topmost Ta cap layer is maintained at 25 nm or more. On the other hand, in the case of using Ta—Mo of Specific example 1, the thickness of the electrode may be designed to be approximately 100 nm. Then, it is found that a residual stress of 100 MPa or less can be achieved by optimizing the TaMo film thickness while maintaining the film thickness of the topmost TaMo cap layer at 25 nm or more.

Here, regarding the Mo composition of the Ta—Mo alloy available in this embodiment, the Ta—Mo alloy can be Ta₁₀₀₋ₓMoₓ (13 at. %≦x≦70 at. %). The mechanism by which the Ta—Mo alloy can achieve lower residual stress than Ta has not been completely clarified. However, as a result of confirmation by the inventors, the crystal structure of the Ta—Mo alloy is a body-centered cubic structure (α-Ta structure). This structure is different from the tetragonal structure (β-Ta structure). A Ta thin film formed by sputtering is likely to assume the tetragonal structure. Such change of crystal structure by Mo addition is considered to be a cause of the reduction of residual stress. Here, from the viewpoint of the crystal structure being the body-centered cubic structure (α-Ta structure), the Mo composition of the Ta—Mo alloy is preferably 13 at. % or more. On the other hand, if the Mo composition is too high, the physical milling rate tends to be accelerated. Thus, the Mo composition of the Ta—Mo alloy is preferably 70 at. % or less from the viewpoint of maintaining low physical milling rate.

### Second Embodiment

As described in the first embodiment, a high-sensitivity pressure sensor can be provided by using a Ta—Mo alloy for the lower electrode 204. In this case, a layer having the function of interrupting crystal growth is preferably included in the underlayer 205 of the stacked body SB.

FIGS. 20A and 20B are schematic perspective views illustrating part of a strain sensing element according to a second embodiment.

As shown in FIGS. 20A and 20B, in the strain sensing element according to this embodiment, the underlayer 205 includes a crystal growth interruption layer 205c. The rest of the configuration of the strain sensing element according to this embodiment is similar to that of the strain sensing element according to the first embodiment, and the description thereof is omitted.

Preferable configurations of the underlayer 205 are shown in FIGS. 20A and 20B. As shown in FIG. 20A, the underlayer 205 can include e.g. the aforementioned buffer layer 205a, a crystal growth interruption layer 205c formed thereon, and the aforementioned seed layer 205b formed thereon.

Here, the crystal growth interruption layer 205c can be an amorphous layer (a layer including an amorphous material). The amorphous material can be e.g. a metal layer including a light element such as B and N. The amorphous material can be e.g. Cu₈₀B₂₀. The amorphous material used for the crystal growth interruption layer 205c is preferably a nonmagnetic material. If a magnetic material is used, the leakage magnetic field from the magnetic material included in the underlayer 205 may affect the operation of the magnetization free layer of the stacked body SB. This may hamper the rotation of magnetization. Thus, it is preferable to use a nonmagnetic material. The underlayer 205 shown in FIG. 20A can be e.g. Ta 1 nm (buffer layer 205a)/Cu₈₀B₂₀ 3 nm (crystal growth interruption layer 205c)/Ru 2 nm (seed layer 205b).

Besides, as shown in FIG. 20B, the structure of the crystal growth interruption layer 205c may be e.g. a stacked structure of a Cu layer 205e and a Ta layer 205d. Alternatively, the structure of the crystal growth interruption layer 205c may be a stacked structure of a Cu-including layer 205e and a Ta-including layer 205d. The Ta-including layer 205d is formed on the Cu-including layer 205e. In the case of using such a structure, the Ta layer 205d on the Cu layer 205e is likely to be amorphous, and can be caused to function as a crystal growth interruption layer 205c. The underlayer 205 shown in FIG. 20B can be e.g. Ta 1 nm (buffer layer 205a)/Cu 3 nm/Ta 2 nm (crystal growth interruption layer 205c)/Ru 2 nm (seed layer 205b).

As a result of investigation by the inventors, it is found that in the case of using a Ta—Mo alloy for the lower electrode 204, a high strain sensitivity is obtained when the underlayer 205 of the stacked body SB includes a layer having the function of interrupting crystal growth.

In the case of using a Ta—Mo alloy for the lower electrode 204, the following stacked bodies SB (stacked body SBA and stacked body SBB) were each formed and subjected to characterization. The stacked body SBA includes an underlayer 205A including a crystal growth interruption layer 205c. The stacked body SBB includes an underlayer 205B. The details of the element structure of each of the stacked body SBA and the stacked body SBB are as follows.

The configuration of the electrode connected to the stacked body SBA and the configuration of the electrode connected to the stacked body SBB are in common as follows.

Lower electrode 204: Ta₁₉Mo₈₁ (5 nm)/Cu₉₅Ag₅ (60 nm)/Ta₁₉Mo₈₁ (35 nm)

Upper electrode 212: Ta (5 nm)/Cu (200 nm)/Ta (35 nm)/Au (200 nm)

Here, in this specific example, the element is intended to verify the influence of the crystal growth from the lower electrode 204 to the stacked body on the strain sensitivity. Thus, the upper electrode 212 is based on a configuration with a thick film thickness for enabling easy characterization.

The configuration of the stacked body SBA is as follows.

Foundation layer 205A: Ta (1 nm)/Cu (3 nm)/Ta (2 nm)/Ru (2 nm)

Pinning layer 206: Ir₂₂Mn₇₈ (7 nm)

Second magnetization fixed layer 207: Fe₅₀Co₅₀ (2.5 nm)

Magnetic coupling layer 208: Ru (0.9 nm)

First magnetization fixed layer 209: Co₄₀Fe₄₀B₂₀ (3 nm)

Intermediate layer 203: Mg—O (1.5 nm)

Strain sensing layer (magnetization free layer 210): Co₄₀Fe₄₀B₂₀ (4 nm)

Diffusion prevention layer: Mg—O (1.5 nm)

Cap layer 211: Cu (1 nm)/Ta (2 nm)/Ru (15 nm)

The configuration of the stacked body SBB is as follows.

Foundation layer 205B: Ta (1 nm)/Ru (2 nm)

Pinning layer 206: Ir₂₂Mn₇₈ (7 nm)

Second magnetization fixed layer 207: Fe₅₀Co₅₀ (2.5 nm)

Magnetic coupling layer 208: Ru (0.9 nm)

First magnetization fixed layer 209: Co₄₀Fe₄₀B₂₀ (3 nm)

Intermediate layer 203: Mg—O (1.5 nm)

Strain sensing layer (magnetization free layer 210): Co₄₀Fe₄₀B₂₀ (4 nm)

Diffusion prevention layer: Mg—O (1.5 nm)

Cap layer 211: Cu (1 nm)/Ta (2 nm)/Ru (15 nm)

The configuration of the stacked body SBA and the configuration of the stacked body SBB are identical to each other except the underlayer.

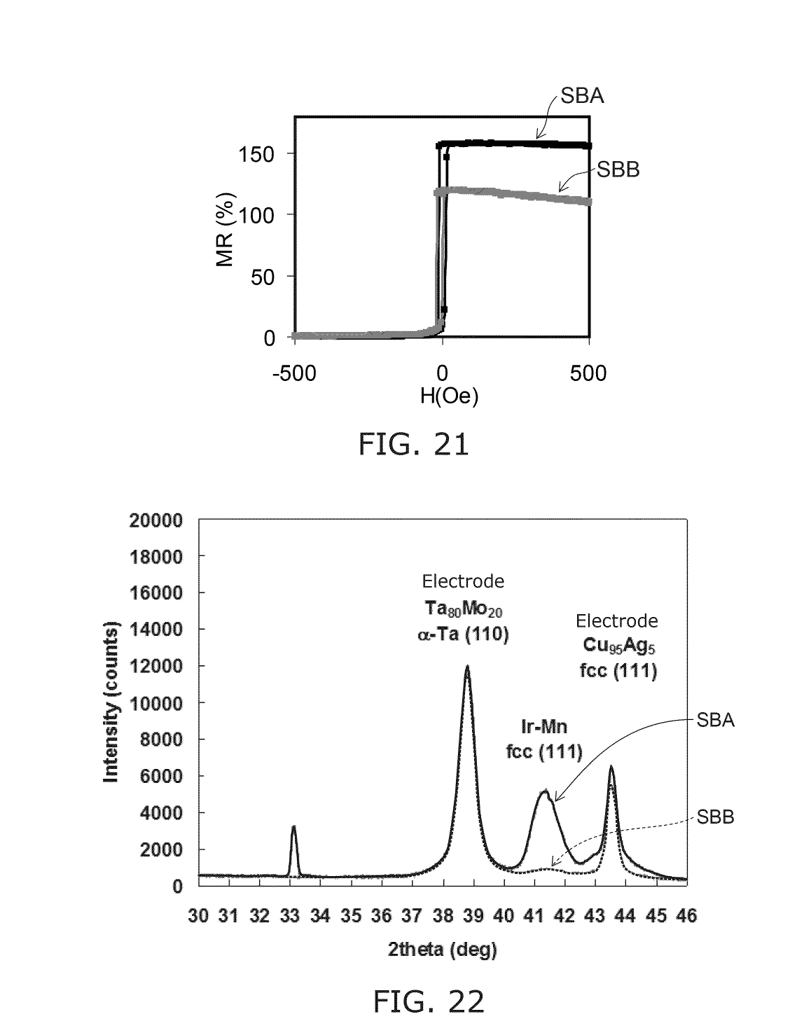

FIG. 21 is a graph illustrating the characteristic of the strain sensing element.

FIG. 21 shows a result for the MR ratio (MR (%)) of the stacked body SBA and the stacked body SBB. It is found that the MR ratio of the stacked body SBB is reduced to approximately 80% of that of the stacked body SBA. On the other hand, the coercivity and the magnetostriction of the strain sensing layer of the stacked body SBA and the stacked body SBB were examined. Then, it was found that in both the stacked body SBA and the stacked body SBB, the coercivity is 3 Oe, and the magnetostriction is 20 ppm. The strain sensitivity (GF) of the stacked body SBA and the stacked body SBB was characterized. Then, GF of the stacked body SBA was 4100, whereas GF of the stacked body SBB was 3200.

The coercivity of the stacked body SBA is comparable with the coercivity of the stacked body SBB. The magnetostriction of the stacked body SBA is comparable with the magnetostriction of the stacked body SBB. In contrast, the MR ratio of the stacked body SBB is approximately 80% of the MR ratio of the stacked body SBA. Under this influence, the value of GF of the stacked body SBB is also approximately 80% of GF of the stacked body SBA.

The major loop of the magnetization curve of the stacked body SBA and the stacked body SBB was characterized to examine the cause of the reduction of the MR ratio of the stacked body SBB compared with the MR ratio of the stacked body SBA. As a result, it was found that the fixing of magnetization (pinning) of the first magnetization fixed layer and the second magnetization fixed layer is weaker in the stacked body SBB than in the stacked body SBA. Thus, the magnetization direction of the first magnetization fixed layer is not completely parallel to the magnetization direction of the strain sensing layer near zero magnetic field. It was found that this results in reducing the MR ratio.

The crystal structure of the stacked body SBA and the stacked body SBB was examined by X-ray diffraction to examine the cause of insufficient pinning of the stacked body SBB.

FIG. 22 is a graph illustrating the X-ray diffraction result of the stacked body used for the strain sensing element. In the stacked body SBA in which the underlayer 205A includes a crystal growth interruption layer 205c, the crystal orientation of IrMn of the pinning layer 206 is a good preferred orientation of fcc(111). In contrast, in the stacked body SBB, the diffraction peak of fcc(111) of IrMn of the pinning layer 206 is weak, revealing poor crystal orientation. This results from a peculiar crystal growth on the Ta—Mo alloy of the body-centered cubic structure. This embodiment uses a crystal growth interruption layer 205c. Thus, the crystal orientation of the stacked body SB can be newly grown from the seed layer of the stacked body SB. This can improve the aforementioned pinning. Furthermore, according to the X-ray diffraction result of FIG. 22, the diffraction peak resulting from the Ta—Mo alloy included in the lower electrode 204 is only α-Ta (110). This indicates a body-centered cubic structure.

As described above, the crystal growth interruption layer 205c of this embodiment is used for the purpose of improving the pinning on the Ta—Mo alloy. Besides, an alternative method is to use e.g. an amorphous magnetic layer for the magnetization free layer 210. In this case, the top-type structure is used. In this structure, the magnetization fixed layer 209 is formed above the magnetization free layer 210. Thus, the magnetization free layer serves to interrupt crystal growth, and can improve the orientation of the magnetization fixed layer. The top-type structure will be described later (e.g., FIG. 65).

### Third Embodiment

In a third embodiment, the magnetization free layer 210 includes an amorphous magnetic layer. Examples of the configuration and the material are described in the case where the magnetization free layer 210 includes an amorphous magnetic layer.

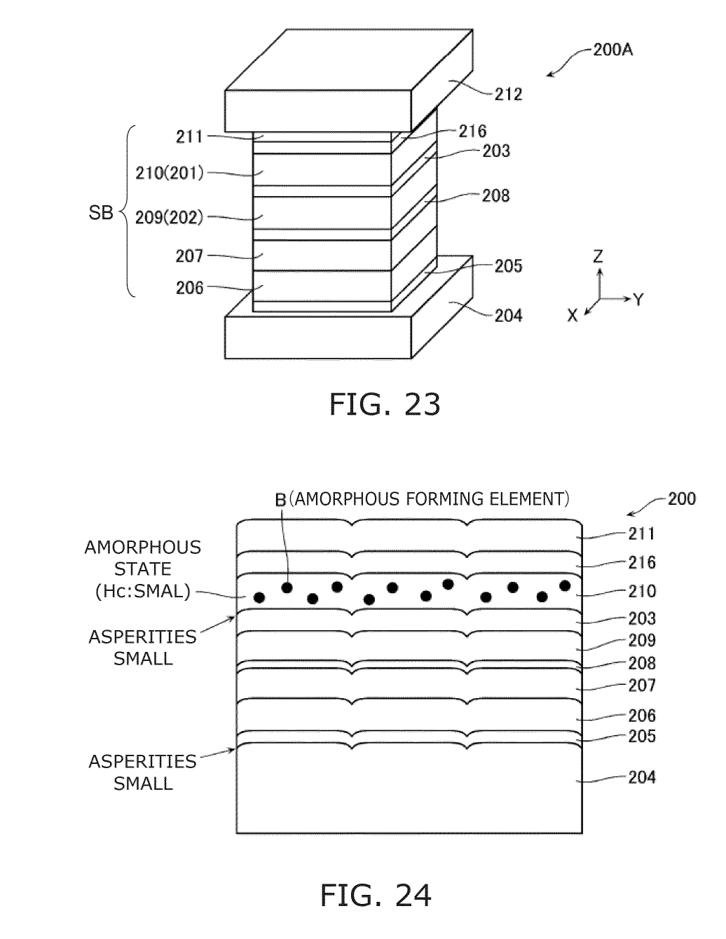

FIG. 23 is a schematic perspective view illustrating a strain sensing element according to the third embodiment. The magnetization free layer 210 of the strain sensing element 200A according to this embodiment is made of a ferromagnetic material including an amorphous portion. Furthermore, in the strain sensing element 200A according to this embodiment, the stacked body SB includes a diffusion prevention layer 216 provided between the magnetization free layer 210 and the cap layer 211. The rest of the strain sensing element according to this embodiment is similar to the strain sensing element according to the first and second embodiments.

The magnetization free layer 210 can be made of e.g. an alloy including at least one element selected from Fe, Co, and Ni, and an amorphous forming element (e.g., boron (B)). The magnetization free layer 210 can be made of e.g. Co—Fe—B alloy or Fe—B alloy. The magnetization free layer 210 can be made of e.g. (CoₓFe₁₀₀₋ₓ)_{100-y}B_{y} alloy (x being 0 at. % or more and 100 at. % or less, and y being more than 0 at. % and 40 at. % or less). The magnetization free layer 210 can be e.g. a Co₄₀Fe₄₀B₂₀ layer having a thickness of 4 nm.

In the case where the magnetization free layer 210 is made of an alloy including at least one element selected from the group consisting of Fe, Co, and Ni, and boron (B), the alloy may be added with at least one of Ga, Al, Si, and W as an element for promoting high magnetostriction constant λ. The magnetization free layer 210 may be made of e.g. Fe—Ga—B alloy, Fe—Co—Ga—B alloy, or Fe—Co—Si—B alloy.

At least part of the magnetization free layer 210 may be made of Fe_{1-y}B_{y} (0<y≦0.3) or (FeₐX₁₋ₐ)_{1-y}B_{y} (X being Co or Ni, 0.8≦a<1, 0<y≦0.3). This facilitates compatibility between large magnetostriction constant λ and low coercivity. Thus, this is particularly preferable. The magnetization free layer 210 can be e.g. a Fe₈₀B₂₀ layer having a thickness of 4 nm.

As described above, the magnetization free layer 210 includes an amorphous portion. Part of the magnetization free layer 210 may be crystallized. The magnetization free layer 210 may include an amorphous portion while including a crystallized portion.

The magnetostriction constant h and the coercivity Hc in the magnetization free layer 210 are additive characteristics depending on the volume ratio of the ferromagnetic material included in the magnetization free layer 210. Even in the case where the magnetization free layer 210 includes a crystallized portion, a small coercivity Hc can be obtained by the magnetic characteristic of the amorphous portion. For instance, the intermediate layer 203 may be made of insulator to utilize the tunneling magnetoresistance effect. In this case, the portion including the interface between the magnetization free layer 210 and the intermediate layer 203 is preferably crystallized. This achieves e.g. high MR ratio.

The boron concentration (e.g., the composition ratio of boron) in the magnetization free layer 210 is preferably 5 at. % (atomic percent) or more. This facilitates obtaining an amorphous structure. The boron concentration in the magnetization free layer 210 is preferably 35 at. % or less. If the boron concentration is too high, for instance, the magnetostriction constant decreases. The boron concentration in the magnetization free layer is preferably e.g. 5 at. % or more and 35 at. % or less, and more preferably 10 at. % or more and 30 at. % or less.

For instance, the magnetization free layer 210 includes a first portion in contact with or close to the intermediate layer 203, and a second portion in contact with or close to the first portion. The first portion includes e.g. a portion of the magnetization free layer 210 in contact with the intermediate layer 203. This first portion is made of a layer of Co—Fe—B alloy. The second portion is made of e.g. Fe—Ga—B alloy. That is, the magnetization free layer 210 is made of e.g. Co—Fe—B/Fe—Ga—B alloy. The thickness of this Co₄₀Fe₄₀B₂₀ layer is e.g. 2 nm. The thickness of this Fe—Ga—B layer is e.g. 6 nm. Alternatively, the magnetization free layer 210 can be made of Co—Fe—B/Fe—B alloy. The thickness of this Co₄₀Fe₄₀B₂₀ layer is e.g. 0.5 nm. The thickness of this Fe—B layer is e.g. 4 nm. As described above, the magnetization free layer 210 may be made of e.g. Co—Fe—B/Fe—B alloy. In this case, the thickness of this Co₄₀Fe₄₀B₂₀ layer is e.g. 0.5 nm. The thickness of this Fe—B layer is e.g. 4 nm. Thus, high MR ratio can be obtained by using Co—Fe—B alloy for the first portion on the intermediate layer 203 side.

The first portion of the magnetization free layer 210 including the interface with the intermediate layer 203 may be made of crystallized Fe₅₀Co₅₀ (thickness 0.5 nm). The first portion of the magnetization free layer 210 including the interface with the intermediate layer 203 may be made of a two-layer structure such as crystallized Fe₅₀Co₅₀ (thickness 0.5 nm)/Co₄₀Fe₄₀B₂₀ (thickness 2 nm).

The magnetization free layer 210 may be a stacked film of Fe₅₀Co₅₀ (thickness 0.5 nm)/Co₄₀Fe₄₀B₂₀ (thickness 4 nm). The second magnetic layer 202 may be a stacked film of Fe₅₀Co₅₀ (thickness 0.5 nm)/Co₄₀Fe₄₀B₂₀ (thickness 2 nm)/Co₃₅Fe₃₅B₃₀ (thickness 4 nm). In this stacked film, the boron concentration increases with the distance from the intermediate layer 203.

The magnetization free layer 210 may be made of a magnetic material including an amorphous forming element (e.g., boron). In this case, the diffusion prevention layer 216 suppresses diffusion of the amorphous forming element and keeps the amorphous structure of the magnetization free layer 210. The diffusion prevention layer 216 includes e.g. oxide or nitride. Specifically, the oxide material or nitride material used for the diffusion prevention layer 216 can be an oxide material or nitride material including an element such as Mg, Al, Si, Ti, V, Cr, Mn, Fe, Co, Ni, Cu, Zn, Zr, Nb, Mo, Ru, Rh, Pd, Ag, Hf, Ta, W, Sn, Cd, and Ga. Here, the diffusion prevention layer 216 is a layer not contributing to the magnetoresistance effect. Thus, its area resistance is preferably low. For instance, the area resistance of the diffusion prevention layer 216 is preferably set lower than the area resistance of the intermediate layer 203 contributing to the magnetoresistance effect. From the viewpoint of decreasing the area resistance of the diffusion prevention layer, an oxide or nitride of Mg, Ti, V, Zn, Sn, Cd, or Ga having low barrier height is preferable. For the function of suppressing diffusion of boron, an oxide with stronger chemical coupling is preferable. For instance, the oxide can be MgO of 1.5 nm. An oxynitride can be regarded as either oxide or nitride.

In the case where the diffusion prevention layer 216 is made of an oxide material or nitride material, the thickness of the diffusion prevention layer 216 is preferably 0.5 nm or more from the viewpoint of sufficiently developing the function of preventing diffusion of boron. The thickness of the diffusion prevention layer 216 is preferably 5 nm or less from the viewpoint of decreasing the area resistance. That is, the film thickness of the diffusion prevention layer 216 is preferably 0.5 nm or more and 5 nm or less, and more preferably 1 nm or more and 3 nm or less.

The diffusion prevention layer 216 can be made of at least one selected from the group consisting of magnesium (Mg), silicon (Si), and aluminum (Al). The diffusion prevention layer 216 can be made of a material including these light elements. These light elements produce a compound by coupling with boron. At least one of e.g. a Mg—B compound, Al—B compound, and Si—B compound is formed in the portion including the interface between the diffusion prevention layer 216 and the magnetization free layer 210. These compounds suppress diffusion of boron.

Another metal layer or the like may be inserted between the diffusion prevention layer 216 and the magnetization free layer 210. However, if the distance between the diffusion prevention layer 216 and the magnetization free layer 210 is too large, boron diffuses therebetween. This decreases the boron concentration in the magnetization free layer 210. Thus, the distance between the diffusion prevention layer and the magnetization free layer 210 is preferably 10 nm or less, and more preferably 3 nm or less.

In this embodiment, a magnetic layer, not shown, may be further provided between the diffusion prevention layer 216 and the magnetization free layer 210. This magnetic layer, not shown, has a variable magnetization direction. This magnetic layer, not shown, can be based on the materials similar to the materials applicable to the magnetization free layer 210. This magnetic layer, not shown, may be magnetically coupled to the magnetization free layer 210 and may function integrally with the magnetization free layer 210.

The diffusion prevention layer 216 may be provided in the magnetization free layer 210. This can suppress diffusion of boron in the portion of the magnetization free layer 210 located between the diffusion prevention layer 216 and the intermediate layer 203 (e.g., diffusion of boron between the first portion and the second portion described above). Thus, a small coercivity Hc is obtained. That is, the overall coercivity Hc of the magnetization free layer 210 can be maintained at low level. A plurality of diffusion prevention layers 216 may be provided in the case of providing the diffusion prevention layer 216 in the magnetization free layer 210.

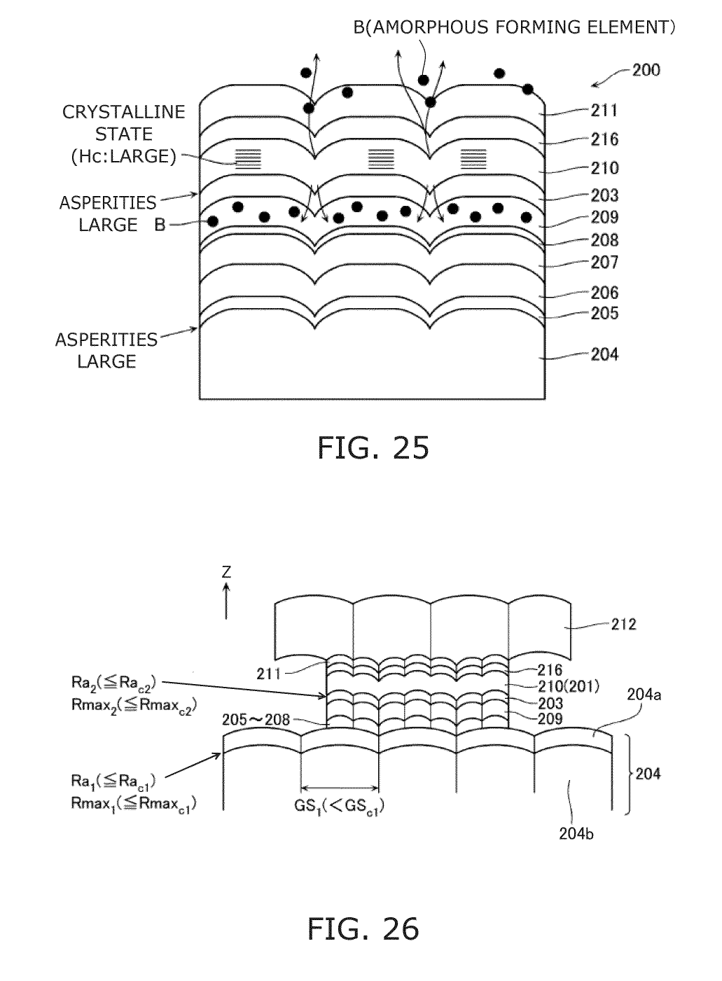

Next, the relationship between the asperities of the lower electrode 204 and the coercivity Hc of the magnetization free layer 210 is described with reference to FIGS. 24 and 25.

FIGS. 24 and 25 are schematic sectional views illustrating part of the strain sensing element according to the third embodiment. FIG. 24 illustrates the case where asperities of the upper surface of the lower electrode 204 are small. FIG. 25 illustrates the case where asperities of the upper surface of the lower electrode 204 are large.

In the example shown in FIG. 24, the magnetization free layer 210 includes an amorphous forming element (boron (B) in FIG. 24). Thus, the magnetization free layer 210 is in the amorphous state. Here, as a result of diligent investigations by the inventors, it was found that the coercivity Hc of the magnetization free layer 210 is smaller in the case where the magnetization free layer 210 is in the amorphous state than in the case where the magnetization free layer 210 is in the crystalline state. Thus, an amorphous forming element is included in the magnetization free layer 210 to turn the magnetization free layer 210 to the amorphous state. This can reduce the coercivity Hc of the magnetization free layer 210 and increase the gauge factor.

On the other hand, as shown in FIG. 25, even if an amorphous forming element is included in the magnetization free layer 210, there were cases where this amorphous forming element diffuses into the adjacent layer at the time of annealing treatment. This advanced the crystallization of the magnetization free layer 210 and increased the coercivity Hc of the magnetization free layer 210. As a result of diligent investigations by the inventors, it was found that the diffusion of the amorphous forming element and the associated crystallization of the magnetization free layer 210 tend to occur in the case where asperities of the upper surface of the lower electrode 204 are large. It is considered that this is caused by the reasons as follows.

In FIG. 24, asperities of the upper surface of the lower electrode 204 are small. In this case, asperities of the layers from the underlayer 205 to the first magnetization fixed layer 209 formed on the upper surface of the lower electrode 204, asperities of the intermediate layer 203, asperities of the magnetization free layer 210, and asperities of the diffusion prevention layer 216 are small. Thus, the thickness of the intermediate layer 203 and the diffusion prevention layer 216 for preventing diffusion of the amorphous forming element is also relatively uniform. It is considered that this can favorably suppress diffusion of the amorphous forming element at the time of annealing.

On the other hand, in FIG. 25, asperities of the upper surface of the lower electrode 204 are large. In this case, asperities of the layers from the underlayer 205 to the first magnetization fixed layer 209 formed on the upper surface of the lower electrode 204, asperities of the intermediate layer 203, asperities of the magnetization free layer 210, and asperities of the diffusion prevention layer 216 are large. Thus, the intermediate layer 203 and the diffusion prevention layer 216 include a thin portion. Accordingly, it is considered that the amorphous forming element diffuses through this thin portion at the time of annealing.

As a result of investigation by the inventors, it was found that such diffusion of the amorphous forming element and the associated progress of crystallization of the magnetization free layer 210 are less likely to occur in the case where the crystal grain size of the material of the lower electrode 204 is small. Such diffusion and crystallization are more likely to occur in the case where the crystal grain size of the material of the lower electrode 204 is large.

Next, a mode of the strain sensing element 200 according to this embodiment is described with reference to FIG. 26.

FIG. 26 is a schematic sectional view illustrating the strain sensing element according to the third embodiment.

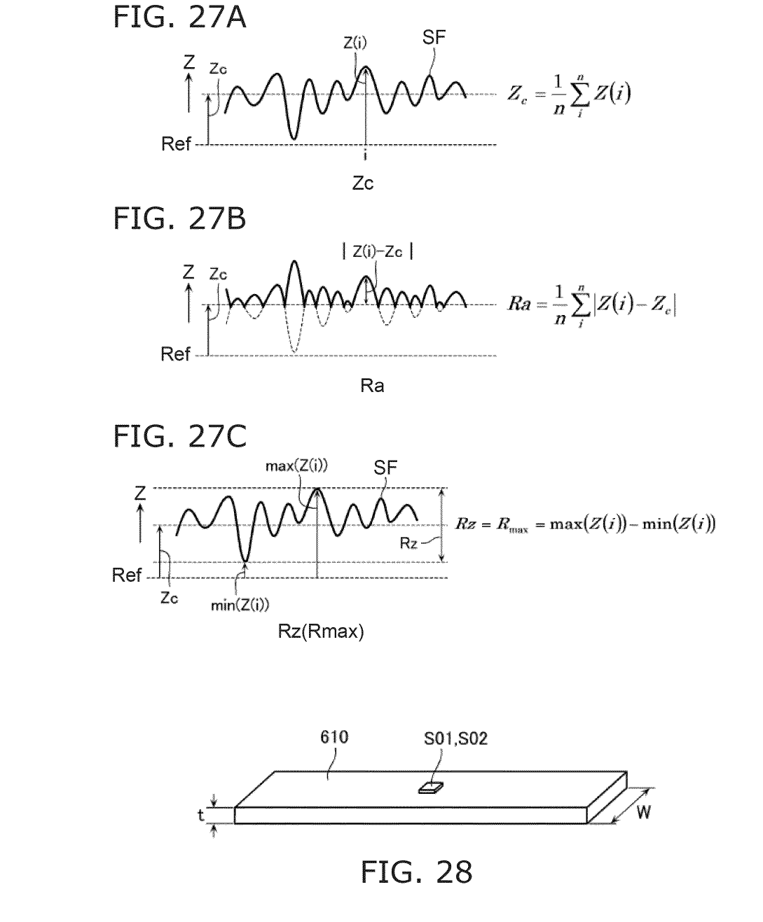

As shown in FIG. 26, in the strain sensing element 200 according to this embodiment, the average roughness Ra₂ of the interface between the intermediate layer 203 and the first magnetic layer 201 is less than or equal to a prescribed value Ra_{c2}. This value Ra_{c2} is e.g. 0.3 nm. The Ra value is a numerical value indicating the magnitude of asperities of a prescribed surface, and is also referred to as average roughness. A method for calculating the Ra value will be described later with reference to FIGS. 27A and 27B. The average roughness Ra₂ is calculated by e.g. the Ra value described with reference to FIGS. 27A and 27B.

As shown in FIG. 26, in the strain sensing element 200 according to this embodiment, the maximum roughness Rmax₂ of the interface between the intermediate layer 203 and the first magnetic layer 201 is less than or equal to a prescribed value Rmax_{c2}. This value Rmax_{c2} is e.g. 2.5 nm. The Rmax value is a numerical value indicating the magnitude of asperities of a prescribed surface, and is also referred to as maximum roughness. A method for calculating the Rmax value will be described later with reference to FIG. 27C. The maximum roughness Rmax₂ is calculated by e.g. the Rmax value described with reference to FIG. 27C.

As shown in FIG. 26, in the strain sensing element 200 according to this embodiment, the lower electrode 204 includes a metal layer of low resistivity (lower electrode intermediate metal layer 204b) including at least one element selected from the group consisting of aluminum (Al), copper (Cu), silver (Ag), gold (Au), nickel (Ni), iron (Fe), and cobalt (Co). The Ra value Ra₁ of the upper surface of this metal layer is less than or equal to a prescribed value Ra_{c1}. The prescribed value Ra_{c1} is e.g. 2 nm.

As shown in FIG. 26, the Rmax value Rmax₁ of the upper surface of the lower electrode intermediate metal layer 204b is less than or equal to a prescribed value Rmax_{c1}. The prescribed value Rmax_{c1} is e.g. 10 nm.

As shown in FIG. 26, the crystal grain size GS₁ of the lower electrode intermediate metal layer 204b is less than or equal to a prescribed value GS_{c1}. This value GS_{c1} is e.g. 50 nm.

As described above, the lower electrode 204 may include Cu—Ag alloy as a metal layer of low resistivity. This can decrease the crystal grain size GS₁ of the metal layer of low resistivity (lower electrode intermediate metal layer 204b) included in the lower electrode 204. The Cu—Ag alloy can be e.g. Cu₁₀₀₋ₓAgₓ (1 at. %≦x≦20 at. %).

Such a configuration can reduce asperities of the interface between the intermediate layer 203 and the first magnetic layer 201 and asperities of the interface between the diffusion prevention layer 216 and the first magnetic layer 201 resulting from the asperities of the upper surface of the lower electrode 204. Furthermore, this can suppress occurrence of a thin portion in the intermediate layer 203 and the diffusion prevention layer 216. Thus, diffusion of the amorphous forming element and the associated crystallization of the first magnetic layer 201 can be suppressed. Accordingly, the first magnetic layer 201 can be maintained in the amorphous state having low coercivity. High MR is achieved by annealing, and the gauge factor of the pressure sensor is increased. This can provide a high-sensitivity strain sensing element 200 and a pressure sensor installed therewith.

Next, a method for calculating asperities is described with reference to FIGS. 27A to 27C. FIGS. 27A to 27C are schematic diagrams for describing a method for calculating asperities in this specification.

First, a method for calculating the average Z_{c} of positions in the height direction (in this example, Z-direction) in a prescribed surface SF is described with reference to FIG. 27A. The curve in FIG. 27A schematically represents the Z-direction position of the prescribed surface SF as viewed from the side surface of the strain sensing element 200. The symbol “i” in the figure represents a prescribed position in a direction (a prescribed direction parallel to the XY-plane) orthogonal to the Z-direction. The symbol “Z(i)” represents the Z-direction position (distance from reference Ref) of the prescribed surface SF at position i. Furthermore, Z_{c} in the figure is the average of Z(i) over all i's. Z_{c} is expressed by the following equation (1) as shown in FIG. 27A.

$$\begin{matrix}[ Math 1 ] & \\ {Z}_{c} = \frac{1}{n} {\sum }_{i}^{n} Z ( i ) & ( 1 )\end{matrix}$$

For instance, an actual strain sensing element 200 may be cut, and the cross section may be observed by e.g. TEM. In this case, Z_{c} can be obtained by fitting to e.g. the interface between the intermediate layer 203 or the diffusion prevention layer 216 and the first magnetic layer 201 or the second magnetic layer 202 in the obtained image. In the case where Z_{c} is obtained by e.g. the aforementioned means, this line may be used as “reference Ref” in FIG. 27A. The direction perpendicular to this line may be used as the height direction.

Next, a method for calculating asperities (Ra value, average roughness) is described with reference to FIG. 27B. In FIG. 27B, the Z-direction position Z(i) of the surface SF and the average Z_{c} of Z(i) are shown by dotted lines. The absolute value of the difference between Z(i) and Z_{c} is shown by the solid line. The Ra value is the average of the absolute value of the difference between Z(i) and Z_{c} over all the positions i. Z(i) is expressed by the following equation (2) as shown in FIG. 27B.

$$\begin{matrix}[ Math 2 ] & \\ Ra = \frac{1}{n} {\sum }_{i}^{n} \vert Z ( i ) - {Z}_{c} \vert & ( 2 )\end{matrix}$$

Next, a method for calculating alternative asperities (maximum height difference Rz (=Rmax)) is described with reference to FIG. 27C. The curve in FIG. 27C schematically represents the Z-direction position of the surface SF as viewed from the side surface of the strain sensing element 200. As shown in FIG. 27C, the maximum height difference Rz (=Rmax) is the difference between the maximum of Z(i), max(Z(i)), and the minimum of Z(i), min(Z(i)). Rz is expressed by the following equation (3) as shown in FIG. 27C.

[Math 3]

Rz=Rₘₐₓ=max(Z(i)) . . . min(Z(i)) (3)

### (Investigation of the Relationship Between the Crystal Structure and the Magnetic Characteristic of the Magnetization Free Layer)

Next, the result of an experiment performed by the inventors is described. First, the relationship between the crystal structure and the magnetic characteristic of the magnetization free layer 210 is described with reference to FIGS. 28 to 42.

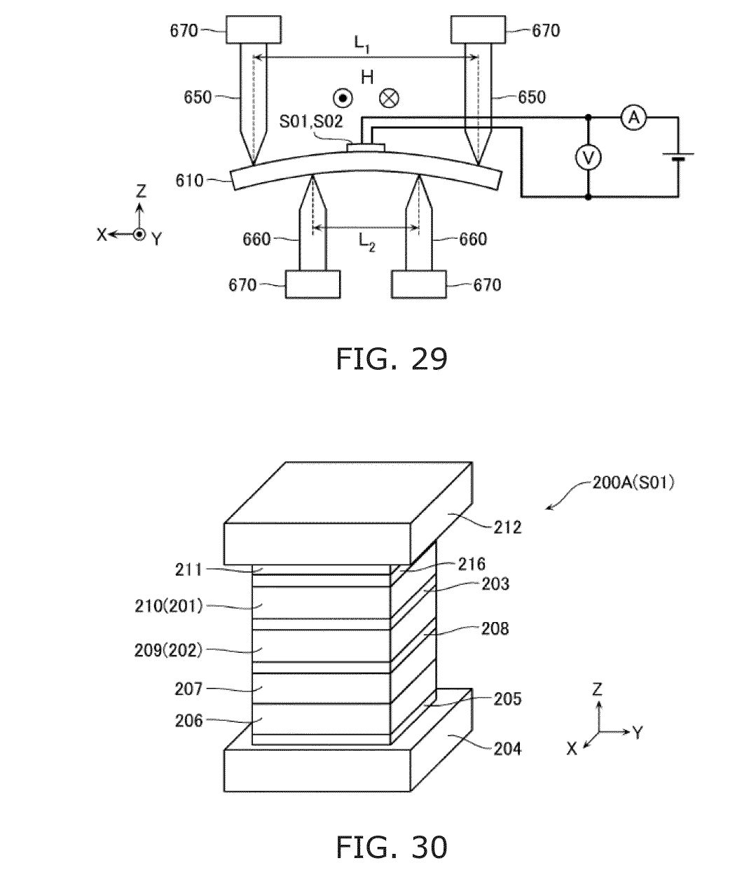

First, the method of this experiment is described with reference to FIGS. 28 and 29. FIGS. 28 and 29 are schematic views illustrating the method of the experiment. In this experiment, a first sample S01 and a second sample S02 have a configuration similar to that of the strain sensing element 200. A strain was applied to the first sample S01 or the second sample S02 by a substrate bending method for bending a substrate 610. In this state, an external magnetic field H was applied to the first sample S01 or the second sample S02. The resistance of the sample was measured.

In this experiment, first, as shown in FIG. 28, the first sample S01 or the second sample S02 was fabricated on the substrate 610. Next, the substrate 610 was cut into a strip. The first sample S01 and the second sample S02 were formed like a dot on the substrate 610. The size in the XY-plane of the first sample S01 and the second sample S02 is 20 μm×20 μm.

Next, as shown in FIG. 29, the substrate 610 with the first sample S01 or the second sample S02 fabricated thereon is bent in a direction (e.g., X-direction) orthogonal to the magnetization direction (e.g., −Y-direction) of the second magnetic layer 202. Thus, a strain was applied to the first sample S01 or the second sample S02. The bending of the substrate 610 was performed by the four-point bending method (substrate bending method) with knife-edges 650 and 660. The knife-edges 650 and 660 include a load cell 670. The load of the knife-edges 650 and 660 was measured by this load cell 670 to calculate the strain ε applied to the first sample S01 or the second sample S02. The calculation of the strain ε was based on the following equation (4) related to a two-side supported beam.

$$\begin{matrix}[ Math 4 ] & \\ ɛ = \frac{- 3 ( {L}_{1} - {L}_{2} ) G}{2 W {t}^{2} {e}_{s}} & ( 4 )\end{matrix}$$

In the above equation (4), the symbol “eₛ” represents the Young's modulus of the substrate 610. The symbol “L₁” represents the edge-to-edge length of the outer knife-edge 650. The symbol “L₂” represents the edge-to-edge length of the inner knife-edge 660. The symbol “W” represents the width of the substrate 610. The symbol “t” represents the thickness of the substrate 610. The symbol “G” represents the load applied to the knife-edges 650 and 660. The load applied to the knife-edges 650 and 660 can be continuously changed by a motor, not shown. In the experiment in this specification, a Si substrate (substrate thickness 0.6 mm) was used. Substrate bending was performed in the (110)-direction of the Si substrate. The Young's modulus eₛ of the substrate 610 is 169 GPa.

In the example described in FIG. 29, the substrate 610 is bent convexly. However, in this experiment, the substrate 610 was bent also concavely. When the substrate 610 is bent convexly as shown in e.g. FIG. 29, a strain in the tensile direction (positive direction) occurs in the first sample S01 or the second sample S02. On the other hand, when the substrate 610 is bent concavely, a strain in the compressive direction (negative direction) occurs in the first sample S01 or the second sample S02.

Furthermore, as shown in FIG. 29, an external magnetic field H was applied in a direction orthogonal to the direction of bending the substrate 610 (the direction of the strain applied to the first sample S01 or the second sample S02). In this state, the perpendicular current-passing characteristic of the first sample S01 or the second sample S02 was characterized. Regarding the direction of the external magnetic field H, the direction (e.g. Y-direction) opposite to the magnetization direction of the second magnetic layer 202 is referred to as positive direction. The direction (e.g. −Y-direction) identical to the magnetization direction of the second magnetic layer 202 is referred to as negative direction.

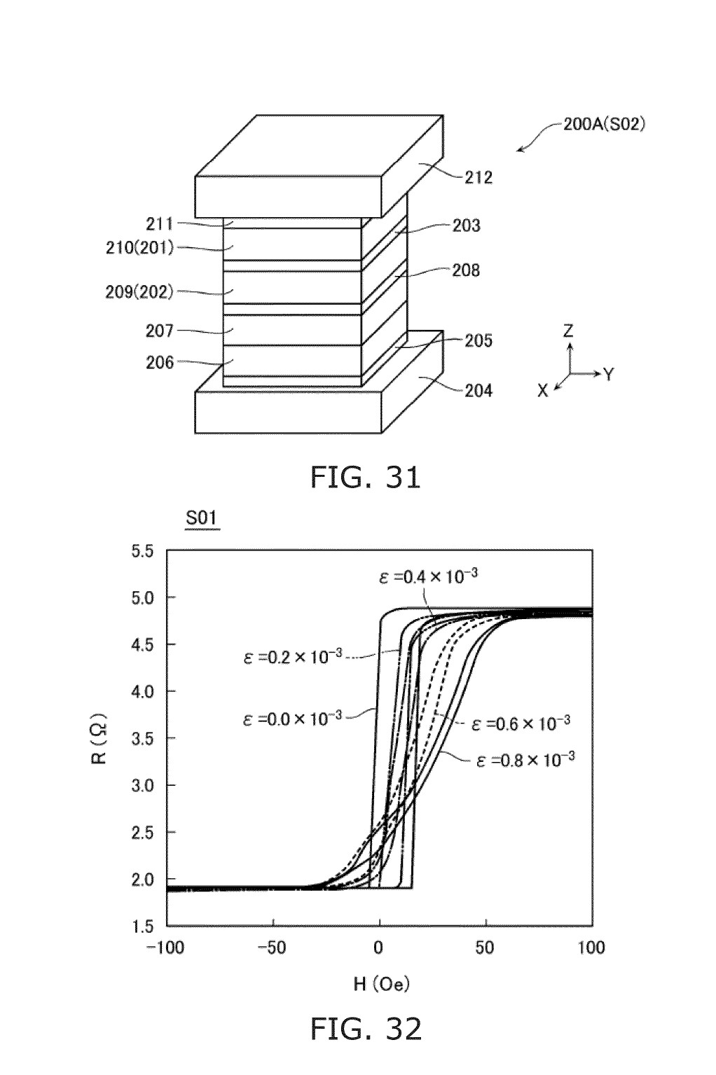

Next, the samples used for this experiment are described with reference to FIGS. 30 and 31.

FIGS. 30 and 31 are schematic perspective views illustrating the samples used for the experiment.

FIG. 30 shows the configuration of the first sample S01. The first sample S01 is configured similarly to the strain sensing element 200A shown in FIG. 23. The first sample S01 includes a diffusion prevention layer 216.

In the first sample S01, the lower electrode 204 is a Ta (5 nm)/Cu₉₅Ag₅ (240 nm)/Ta (50 nm) layer. The underlayer 205 is made of Ta (1 nm)/Ru (2 nm). The pinning layer 206 is an Ir₂₂Mn₇₈ layer having a thickness of 7 nm. The second magnetization fixed layer 207 is a Co₇₅Fe₂₅ layer having a thickness of 2.5 nm. The magnetic coupling layer 208 is a Ru layer having a thickness of 0.9 nm. The first magnetization fixed layer 209 is a Co₄₀Fe₄₉B₂₀ layer having a thickness of 3 nm. The intermediate layer 203 is an MgO layer having a thickness of 1.6 nm. The magnetization free layer 210 is made of Co₄₀Fe₄₀B₂₀ with a thickness of 4 nm. The diffusion prevention layer 216 is an MgO layer having a thickness of 1.5 nm. The cap layer 211 is made of Cu (1 nm)/Ta (2 nm)/Ru (15 nm). The upper electrode 212 is made of Ta (5 nm)/Cu (200 nm)/Ta (35 nm)/Au (200 nm). Here, in this specific example, the element is intended to verify the influence of the coercivity of the magnetization free layer 210 on the strain sensitivity. Thus, the upper electrode 212 is based on a configuration with a thick film thickness for enabling easy characterization. In this specific example, the underlayer and the cap layer of the lower electrode 204 are a Ta layer. However, a similar result is obtained when the Ta layer is replaced by a Ta—Mo alloy layer.

The Mg—O layer used in the intermediate layer 203 and the diffusion prevention layer 216 is formed as follows. A Mg layer having a thickness of 1.6 nm is formed. Then, the Mg layer is subjected to surface oxidation by IAO (ion beam-assisted oxidation) treatment. The oxidation condition for fabricating the Mg—O layer for the diffusion prevention layer 216 is weaker than e.g. the oxidation condition for fabricating the Mg—O layer for the intermediate layer 203. The area resistance of the Mg—O layer for the diffusion prevention layer 216 is lower than the area resistance of the Mg—O layer for the intermediate layer 203. If the area resistance of the Mg—O layer for the diffusion prevention layer 216 is higher than the area resistance of the Mg—O layer for the intermediate layer 203, the diffusion prevention layer 216 increases the parasitic resistance, reduces the MR ratio, and decreases the gauge factor. If the area resistance of the Mg—O layer for the diffusion prevention layer 216 is lower than the area resistance of the Mg—O layer for the intermediate layer 203, the parasitic resistance can be decreased. This achieves high MR ratio and high gauge factor.

FIG. 31 shows the configuration of the second sample S02. The second sample S02 is configured similarly to the strain sensing element 200A shown in FIGS. 4A to 4C. The second sample S02 includes no diffusion prevention layer 216. The other layers of the second sample S02 are configured similarly to those of the first sample S01.

FIGS. 32 to 37 are graphs illustrating the characteristic of the samples of the experiment. First, the result of this experiment is described with reference to FIGS. 32 to 35.

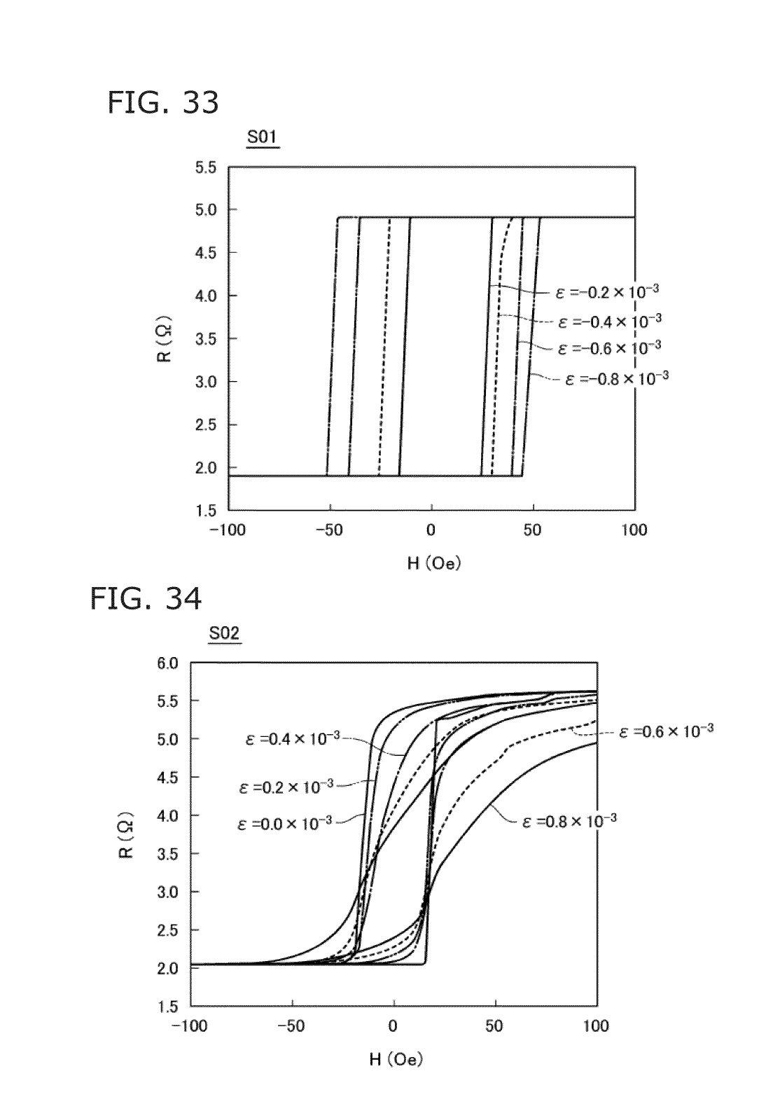

FIGS. 32 and 33 show the result in the case where the first sample S01 is provided on the substrate 610. FIG. 32 shows the result in the case where a strain in the positive direction (tensile direction) is applied to the first sample S01 by convexly bending the substrate 610. FIG. 33 shows the result in the case where a strain in the negative direction (compressive direction) is applied to the first sample S01 by concavely bending the substrate 610.

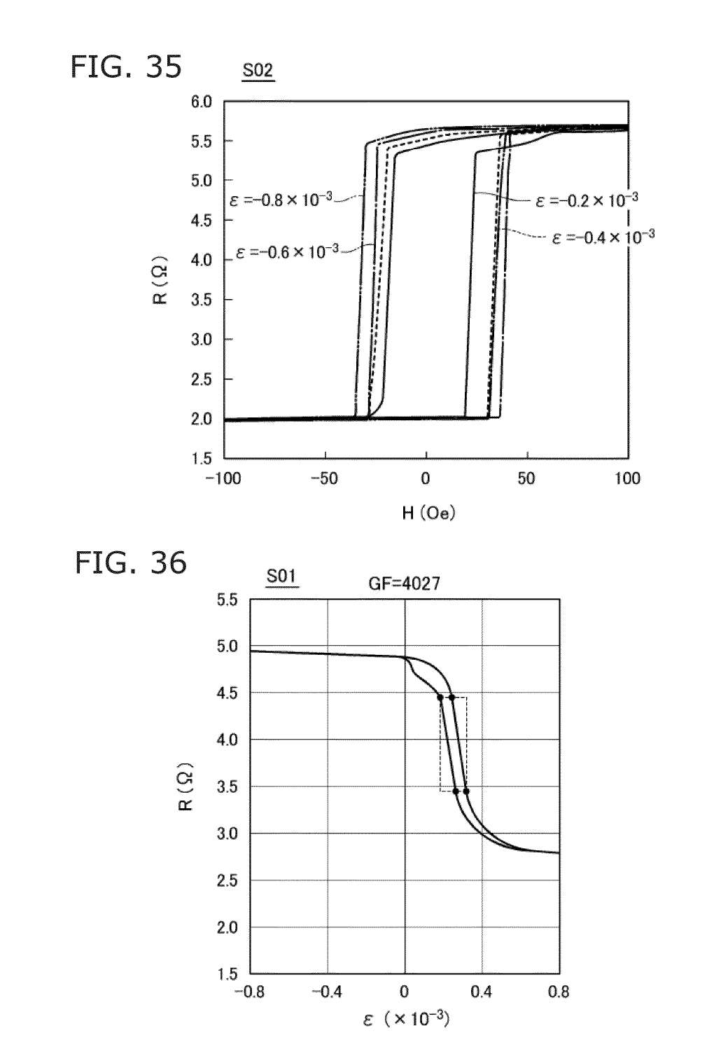

On the other hand, FIGS. 34 and 35 show the result in the case where the second sample S02 is provided on the substrate 610. FIG. 34 shows the result in the case where a strain in the positive direction (tensile direction) is applied to the second sample S02 by convexly bending the substrate 610. FIG. 35 shows the result in the case where a strain in the negative direction (compressive direction) is applied to the second sample S02 by concavely bending the substrate 610.

The horizontal axis of FIGS. 32 to 35 represents the magnitude of the external magnetic field H (oersted, Oe). The vertical axis of FIGS. 32 to 35 represents the electrical resistance R (ohm, Ω) between the lower electrode 204 and the upper electrode 212. Furthermore, in FIGS. 32 to 35, the relationship between the external magnetic field H and the electrical resistance R is shown with respect to the strain ε applied to the first sample S01 or the second sample S02. The value of the magnetostriction λ and the coercivity Hc of the first sample S01 and the second sample S02 was examined by M-H (magnetization-magnetic field) measurement in the state of continuous film without device processing. The change of the anisotropic magnetic field Hk in the magnetization hard axis direction of the magnetization free layer was examined by applying a strain to the substrate. Thus, the magnetostriction 2 was calculated. In the results shown in FIGS. 31 to 34, the M-H measurement was performed by a loop tracer using a magnetic field sweep of 50 Hz.

FIGS. 32 and 34 show the magnetic field dependence of the electrical resistance when the strain ε is 0.8×10⁻³, 0.6×10⁻³, 0.4×10⁻³, 0.2×10⁻³, and 0.0×10⁻³. FIGS. 33 and 35 show the magnetic field dependence of the electrical resistance when the strain ε is −0.2×10⁻³, −0.4×10⁻³, −0.6×10⁻³, and −0.8×10⁻³. As shown in FIGS. 32 and 34, in the first sample S01 and the second sample S02, the R—H loop shape is changed with the value of the strain ε. This indicates that the in-plane magnetic anisotropy of the first magnetic layer 201 (magnetization free layer) is changed by the inverse magnetostriction effect.

The characteristic of the first sample S01 was calculated from the graphs shown in FIGS. 32 and 33 and the result of the M-H measurement, not shown. Then, the MR ratio was 149%, and the coercivity was 3.2 Oe. On the other hand, the characteristic of the second sample S02 was calculated. Then, the MR ratio was 188%, and the coercivity was 27 Oe. Thus, it was confirmed that the coercivity Hc is significantly lower in the first sample S01 including the diffusion prevention layer 216 made of Mg—O than in the second sample S02 including no diffusion prevention layer 216.

Next, the relationship between the strain ε and the electrical resistance R in the first sample S01 and the second sample S02 was investigated under the environment as shown in FIGS. 28 and 29. In this investigation, the magnitude of the external magnetic field H was fixed. The strain ε in the first sample S01 and the second sample S02 was continuously changed from −0.8×10⁻³ to 0.8×10⁻³. Then, the strain ε was continuously changed from 0.8×10⁻³ to −0.8×10⁻³.

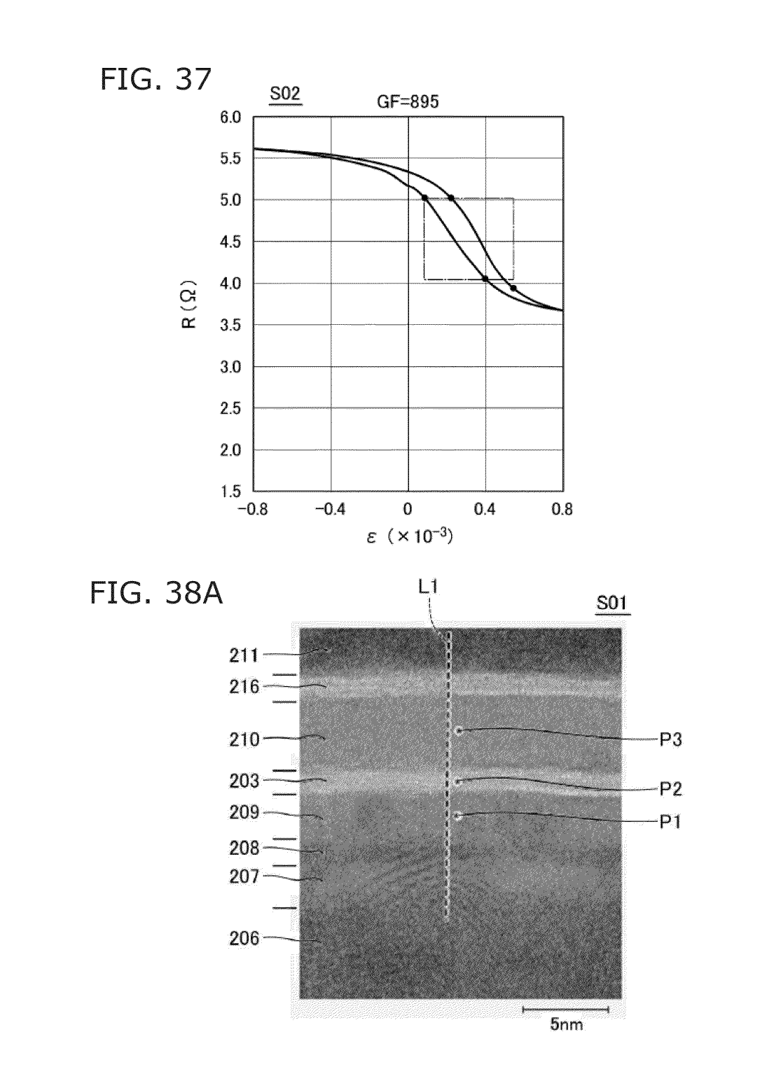

Next, other results of this experiment are described with reference to FIGS. 36 and 37. FIGS. 36 and 37 show the relationship between the strain applied to the first sample S01 and the second sample S02 and the electrical resistance R, respectively. The horizontal axis represents the strain ε. The vertical axis represents the electrical resistance R between the lower electrode 204 and the upper electrode 212. The characteristic of the first sample S01 was calculated from these results. Then, the magnetostriction constant λ was 20 ppm, and the gauge factor (GF=(dR/R)/dε) was 4027. Likewise, the characteristic of the second sample S02 was calculated. Then, the magnetostriction constant λ was 30 ppm, and the gauge factor (GF=(dR/R)/dε) was 895.

Thus, it was confirmed that even in the case where the first magnetic layer 201 is made of the same material (magnetization free layer of a Co₄₀Fe₄₀B₂₀ layer having a thickness of 4 nm), the first sample S01 including the diffusion prevention layer 216 made of Mg—O has a larger gauge factor than the second sample S02 including no diffusion prevention layer 216. It is considered that such difference in gauge factor due to the presence or absence of the diffusion prevention layer 216 results from the difference in coercivity Hc of the first magnetic layer (Co₄₀Fe₄₀B₂₀).

That is, as described with reference to FIGS. 3D and 3E, the first magnetic layer 201 may have a larger magnetostriction constant and a smaller coercivity. In this case, the inverse magnetostriction effect is developed more significantly in the first magnetic layer 201, and the gauge factor increases. Here, in the first sample S01, the value of the MR ratio and the magnetostriction constant λ is lower, but the coercivity Hc is approximately 1/10, compared with the second sample S02. Thus, in the first sample S01, the contribution of the reduction of the coercivity Hc to the gauge factor increase is developed more significantly than the contribution of the reduction of the MR ratio and the magnetostriction constant 2 to the gauge factor decrease. It is considered that this increases the gauge factor.

Next, the first sample S01 and the second sample S02 were observed using a transmission electron microscope (TEM).

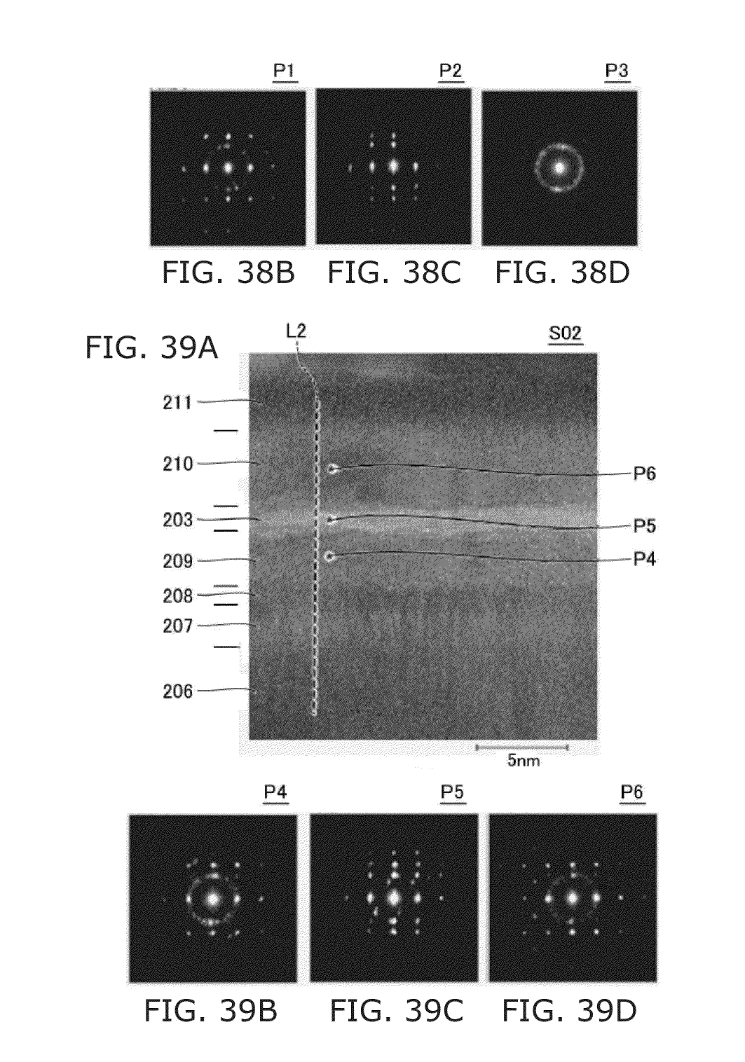

FIGS. 38A to 38D and FIGS. 39A to 39D are transmission electron micrographs of the samples.

First, the crystal structure of the first sample S01 and the second sample S02 is described with reference to FIGS. 38A to 38D and FIGS. 39A to 39D. FIGS. 38A and 39A are cross-sectional transmission electron micrographs (cross-sectional TEM) of the first sample S01 and the second sample S02. FIGS. 38A and 39A show the stacked structure from the pinning layer 206 to the cap layer 211.

FIGS. 38B to 38D are crystal lattice diffraction images obtained by electron beam nanodiffraction at point P1 (a point in the first magnetization fixed layer 209 of the first sample S01), point P2 (a point in the intermediate layer 203 of the first sample S01), and point P3 (a point in the magnetization free layer 210 of the first sample S01) in FIG. 38A, respectively. As shown in the figures, a regular atomic arrangement is observed in FIGS. 38B and 38C. This indicates that the portions at point P1 and point P2 are in the crystalline state. In contrast, in FIG. 38D, no regular atomic arrangement is observed, but a ring-shaped diffraction image is observed. This indicates that the portion at point P3 is in the amorphous state.

FIGS. 39B to 39D are crystal lattice diffraction images obtained by electron beam nanodiffraction at point P4 (a point in the first magnetization fixed layer 209 of the second sample S02), point P5 (a point in the intermediate layer 203 of the second sample S02), and point P6 (a point in the magnetization free layer 210 of the second sample S02) in FIG. 39A. As shown in the figures, a regular atomic arrangement is observed in FIGS. 39B to 39D. This indicates that the portions at point P4, point P5, and point P6 are in the crystalline state.

Thus, it was found that the magnetization free layer 210 of the first sample 501 including the diffusion prevention layer 216 and exhibiting a high gauge factor includes an amorphous structure. It was found that the magnetization free layer 210 of the second sample S02 including no diffusion prevention layer 216 and exhibiting a low gauge factor includes a crystalline structure.

Next, the composition of the first sample S01 and the second sample S02 is described.

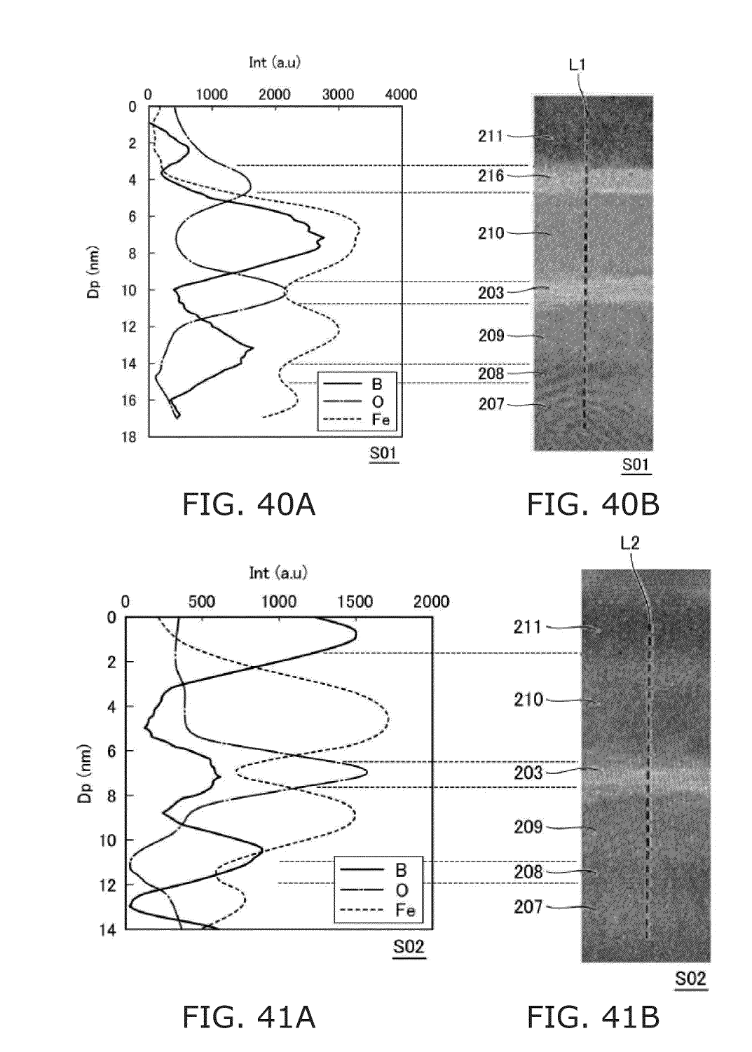

FIGS. 40A, 40B, 41A, and 41B are schematic views illustrating the composition of the samples.

FIGS. 40A and 41A show the characterization results of the elemental depth profile of the first sample S01 and the second sample S02 according to electron energy-loss spectroscopy (EELS). FIGS. 40B and 41B are portions clipped from FIGS. 40A and 41A, respectively, showing the characterized portions L1 and L2 of the aforementioned depth profile.

In FIGS. 40A and 41A, the vertical axis represents depth Dp, and the horizontal axis represents the intensity Int (arbitrary unit) of element detection. The depth Dp corresponds to e.g. the distance in the Z-axis direction. In FIGS. 40A and 41A, boron (B) is shown by the solid line, oxygen (O) is shown by the dot-dashed line, and iron (Fe) is shown by the dotted line.

As shown in FIG. 41A, in the second sample S02, the intensity Int of boron in the cap layer 211 is higher than the intensity Int of boron in the magnetization free layer 210 (Co—Fe—B layer). In the magnetization free layer 210, the intensity Int of boron in the portion on the cap layer 211 side is higher than the intensity Int of boron in the central portion of the magnetization free layer 210. Thus, it is considered that in the second sample S02 including no diffusion prevention layer 216, boron diffuses from the magnetization free layer 210 to the cap layer 211 and decreases the concentration of boron in the magnetization free layer 210.

On the other hand, as shown in FIG. 40A, in the first sample S01, a peak of boron occurs in the central portion of the magnetization free layer 210 (Co—Fe—B layer). The cap layer 211 has a low boron content. That is, the boron concentration of the magnetization free layer 210 (Co—Fe—B layer) is maintained in the initial state of film formation without substantial diffusion to other layers. The reason for this is considered as follows. The first sample S01 includes the diffusion prevention layer 216. This diffusion prevention layer 216 serves as a diffusion barrier for suppressing diffusion of boron from the magnetization free layer 210.

Here, as described with reference to FIGS. 38A to 38D and FIGS. 39A to 39D, in the first sample S01 including the diffusion prevention layer 216, the magnetization free layer 210 includes a portion in the amorphous state. The reason for this is considered as follows. In the first sample S01, the diffusion prevention layer 216 prevents diffusion of boron, which is an amorphous forming element. On the other hand, in the second sample S02 including no diffusion prevention layer 216, crystallization of the magnetization free layer 210 is advanced. The reason for this is considered as follows. The second sample S02 includes no diffusion prevention layer 216. This allows relatively easy diffusion of boron, which is an amorphous forming element.

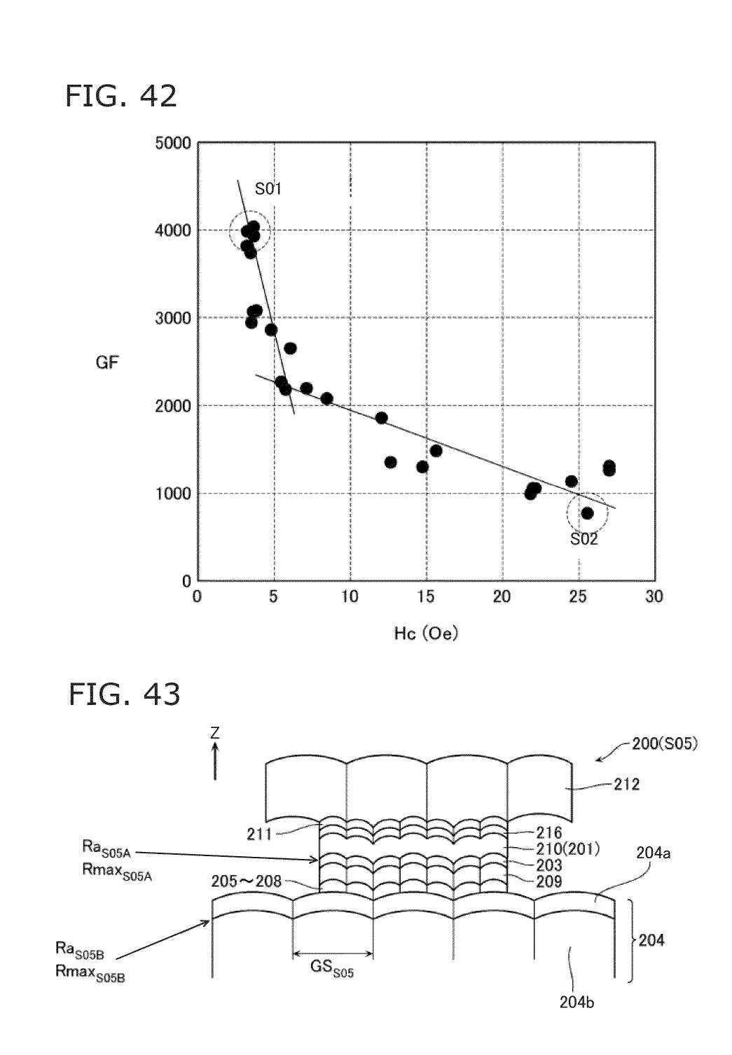

Next, the configuration of the magnetization free layer 210 and the diffusion prevention layer 216 was changed as shown in FIG. 42. Thus, a plurality of samples different in coercivity Hc were fabricated. The relationship between the coercivity Hc and the gauge factor GF in these samples was examined.

FIG. 42 is a graph illustrating the relationship between the coercivity Hc and the gauge factor. In FIG. 42, the horizontal axis represents the coercivity Hc, and the vertical axis represents the gauge factor GF. In this experiment, M-H measurement was performed by a loop tracer using a magnetic field sweep of 50 Hz to characterize the coercivity.

As shown in FIG. 42, it is found that a higher gauge factor GF is obtained for a lower coercivity Hc. It is found that the gauge factor GF steeply increases when the coercivity Hc is 5 Oe or less. Thus, the coercivity Hc of the magnetization free layer 210 is preferably 5 Oe or less for manufacturing a strain sensing element having a high gauge factor GF. Here, the coercivity of the magnetization free layer 210 changes with the magnetic field sweep rate of M-H measurement. For instance, the coercivity has a lower value for a slower magnetic field sweep rate. For instance, the coercivity may be determined by a vibrating sample magnetometer (VSM) for characterization at a magnetic field sweep rate of 40 Oe/min. In this case, the gauge factor GF steeply increases when the coercivity Hc is 4 Oe or less. In the case of M-H measurement at a magnetic field sweep rate in the range of 10-100 Oe/min, the coercivity is preferably 4 Oe or less for a particularly high gauge factor GF.

### (Investigation of the Relationship Between the Asperities of the Lower Electrode Upper Surface and the Magnetic Characteristic of the Magnetization Free Layer)

In the foregoing, the results of the experiment showing the relationship between the crystal structure and the magnetic characteristic of the magnetization free layer 210 have been described with reference to FIGS. 28 to 42. In the following, the results of the experiment showing the relationship between the asperities of the upper surface of the lower electrode 204 and the magnetic characteristic of the magnetization free layer 210 are described with reference to FIGS. 43 to 55.

FIGS. 43 to 45 are schematic sectional views illustrating the samples used for the experiment.

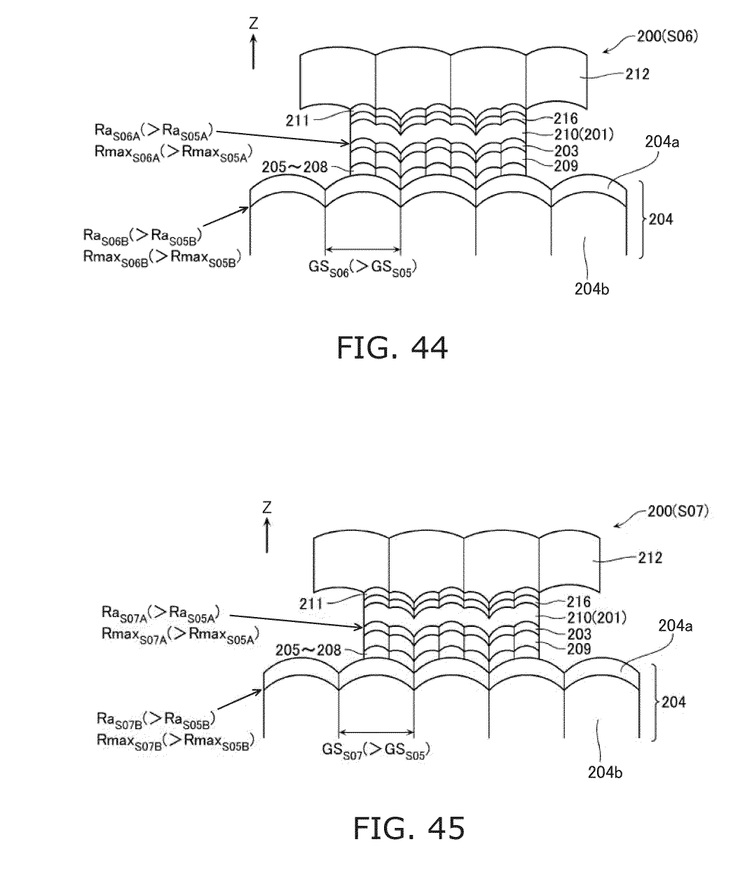

First, sample S05, sample S06, and sample S07 used for this experiment are described with reference to FIGS. 43 to 45. FIG. 43 is a schematic sectional view showing the configuration of the sample S05. FIG. 44 is a schematic sectional view showing the configuration of the sample S06. FIG. 45 is a schematic sectional view showing the configuration of the sample S07.

The sample S05, the sample S06, and the sample S07 are configured similarly to the first sample S01 shown in FIG. 30. However, the samples are different from each other in the material included in the lower electrode 204 and the fabrication process. Thus, the samples are different in the asperities of the upper surface. As a result, the asperities of the interface between the first magnetic layer 201 and the intermediate layer 203 of the stacked body formed on the lower electrode 204 are also different.

That is, the lower electrode 204 of the sample S05 is made of Ta (5 nm)/Cu₉₅Ag₅ (240 nm)/Ta (50 nm). The sample S05 was subjected to CMP treatment after forming the lower electrode 204. On the other hand, the lower electrode 204 of the sample S06 is made of Ta (5 nm)/Cu (240 nm)/Ta (50 nm). The sample S06 was subjected to CMP treatment after forming the lower electrode 204. The lower electrode 204 of the sample S07 is made of Ta (5 nm)/Cu (240 nm)/Ta (50 nm). The sample S07 was not subjected to CMP treatment, but subjected to surface smoothing treatment by Ar-ion irradiation, after forming the lower electrode 204. Here, in this specific example, the element is intended to verify the influence of the asperities of the lower electrode 204 on the strain sensitivity. Thus, the upper electrode 212 is based on a configuration with a thick film thickness for enabling easy characterization. In this specific example, the underlayer and the cap layer of the lower electrode 204 are a Ta layer. However, a similar result is obtained when the Ta layer is replaced by a Ta—Mo alloy layer.

After forming the stacked body, the sample S05, the sample S06, and the sample S07 were subjected to heat treatment in a magnetic field of 6500 Oe at 320° C. for 1 hour. Then, device processing was performed. The sample S05, the sample S06, and the sample S07 were subjected to magnetic/MR characterization (by CIPT) in the state of continuous film without device processing. For the continuous film sample, magnetic/MR characterization was performed also in the case of performing low-temperature annealing and high-temperature annealing immediately after forming the film in addition to the treatment at 320° C. for 1 hour. Here, magnetic characterization was performed using VSM at a magnetic field sweep rate of 40 Oe/min.

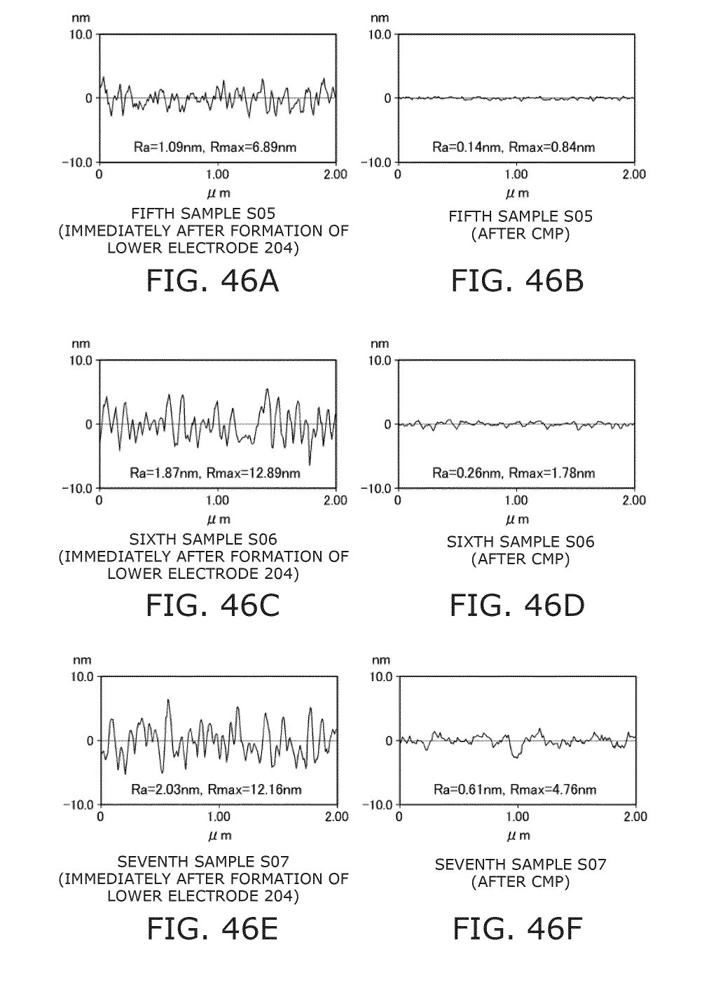

Next, as shown in FIGS. 46A to 46F, the surface asperities of the lower electrode 204 of the sample S05, the sample S06, and the sample S07 were characterized by an atomic force microscope (AFM). FIGS. 46A to 46F are graphs showing the height of the upper surface of the lower electrode 204 in the sample S05, the sample S06, and the sample S07 before and after smoothing treatment. In FIGS. 46A to 46F, the horizontal axis represents the position in the upper surface of the lower electrode 204. The vertical axis represents the height of the upper surface of the lower electrode 204.

FIGS. 46A to 46F are graphs illustrating the characteristics of the samples.

FIG. 46A is a graph showing the height of the lower electrode 204 of the sample S05 immediately after formation. Immediately after formation, the Ra value of the upper surface of the lower electrode 204 of the sample S05 was 1.09 nm, and the Rmax value was 6.89 nm. FIG. 46B is a graph showing the height of the lower electrode 204 of the sample S05 after smoothing treatment. After smoothing treatment, the Ra value of the upper surface of the lower electrode 204 of the sample S05 was 0.14 nm, and the Rmax value was 0.84 nm. Thus, it is found that the Ra value and the Rmax value of the lower electrode 204 of the sample S05 are favorably reduced by CMP treatment.

FIG. 46C is a graph showing the height of the lower electrode 204 of the sample S06 immediately after formation. Immediately after formation, the Ra value of the upper surface of the lower electrode 204 of the sample S06 was 1.87 nm, and the Rmax value was 12.89 nm. Thus, it is found that the Ra value and the Rmax value can be made lower in the case of using Cu—Ag alloy for the lower electrode 204 than in the case of using Cu for the lower electrode 204. FIG. 46D is a graph showing the height of the lower electrode 204 of the sample S06 after smoothing treatment. After smoothing treatment, the Ra value of the upper surface of the lower electrode 204 of the sample S06 was 0.26 nm, and the Rmax value was 1.78 nm. Thus, it is found that the Ra value and the Rmax value of the lower electrode 204 of the sample S06 are reduced by CMP treatment.

FIG. 46E is a graph showing the height of the lower electrode 204 of the sample S07 immediately after formation. Immediately after formation, the Ra value of the upper surface of the lower electrode 204 of the sample S07 was 2.03 nm, and the Rmax value was 12.16 nm. Thus, it is found that the Ra value can be made lower in the case of using Cu—Ag alloy for the lower electrode 204 than in the case of using Cu for the lower electrode 204. FIG. 46F is a graph showing the height of the lower electrode 204 of the sample S07 after smoothing treatment. After smoothing treatment, the Ra value of the upper surface of the lower electrode 204 of the sample S07 was 0.61 nm, and the Rmax value was 4.76 nm. Thus, it is found that the Ra value and the Rmax value of the lower electrode 204 of the sample S07 are reduced by surface smoothing treatment by Ar-ion irradiation.

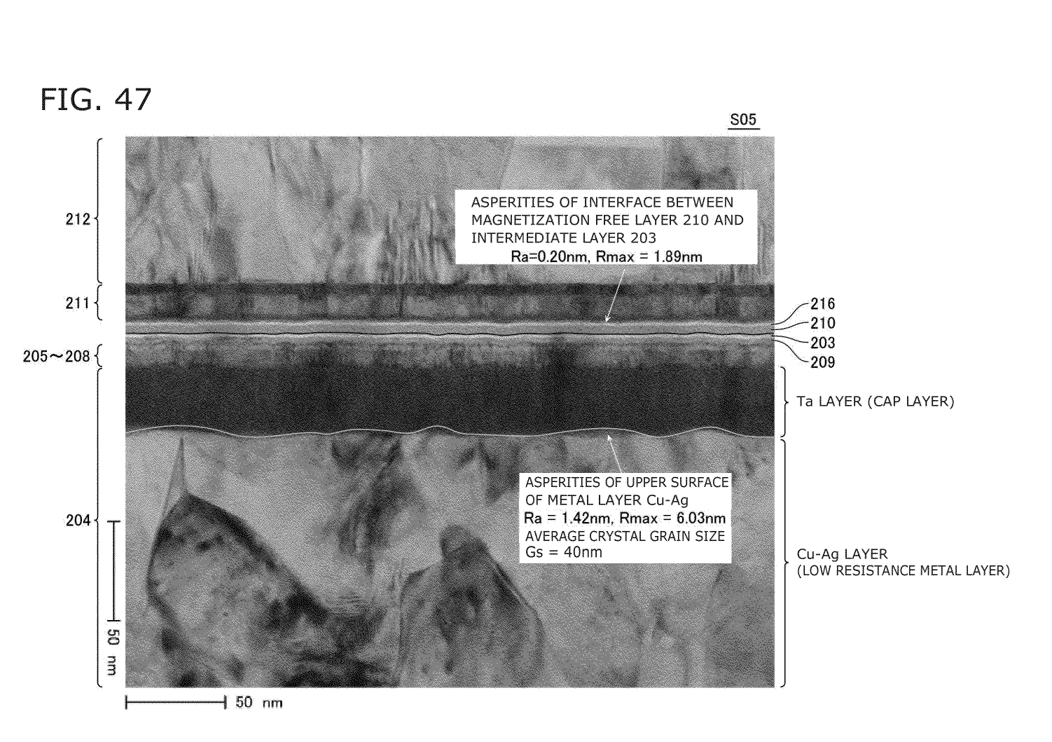

Next, transmission electron micrographs of the surface asperities of the lower electrode 204 and the stacked body of the sample S05, the sample S06, and the sample S07 were taken as shown in FIGS. 47, 48, and 49.

As shown in FIG. 47, in the asperities of the interface between the first magnetic layer 201 and the intermediate layer 203 of the sample S05, the Ra value was 0.20 nm, and the Rmax value was 1.89 nm. As shown in FIG. 47, in the asperities of the interface of the Cu—Ag layer formed as a low resistivity metal layer (lower electrode intermediate metal layer 204b) included in the lower electrode 204 of the sample S05, the Ra value was 1.42 nm, and the Rmax value was 6.03 nm. As shown in FIG. 47, the crystal grain size Gs of the Cu—Ag layer formed as a low resistivity metal layer included in the lower electrode 204 of the sample S05 was 40 nm.

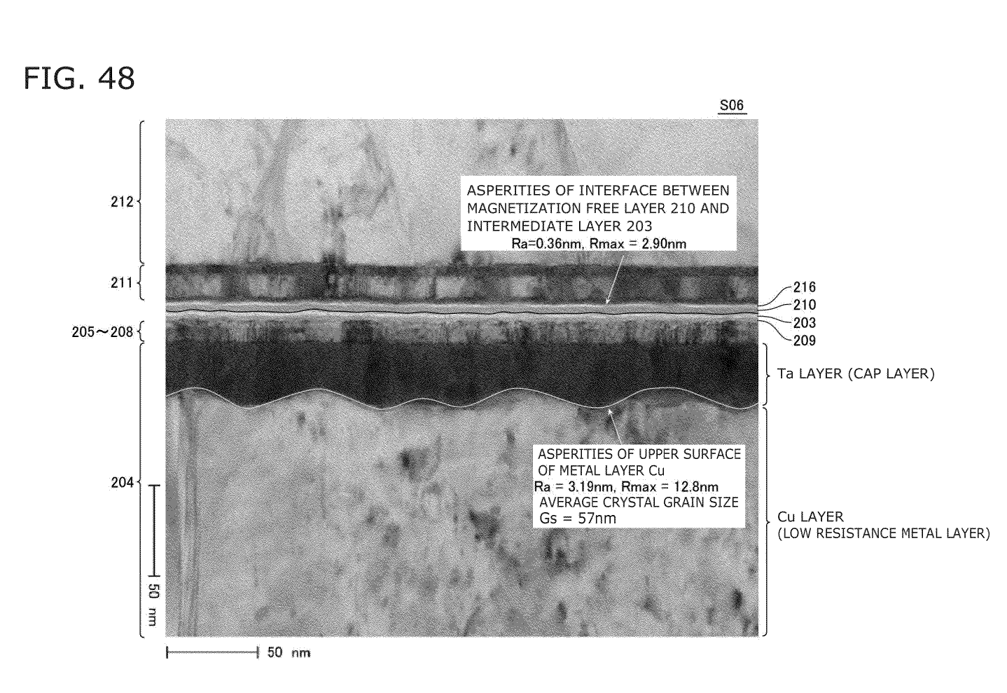

As shown in FIG. 48, in the asperities of the interface between the first magnetic layer 201 and the intermediate layer 203 of the sample S06, the Ra value was 0.36 nm, and the Rmax value was 2.90 nm. As shown in FIG. 48, in the asperities of the interface of the Cu layer formed as a low resistivity metal layer (lower electrode intermediate metal layer 204b) included in the lower electrode 204 of the sample S06, the Ra value was 3.19 nm, and the Rmax value was 12.8 nm. As shown in FIG. 48, the crystal grain size Gs of the Cu layer formed as a low resistivity metal layer included in the lower electrode 204 of the sample S06 was 57 nm.

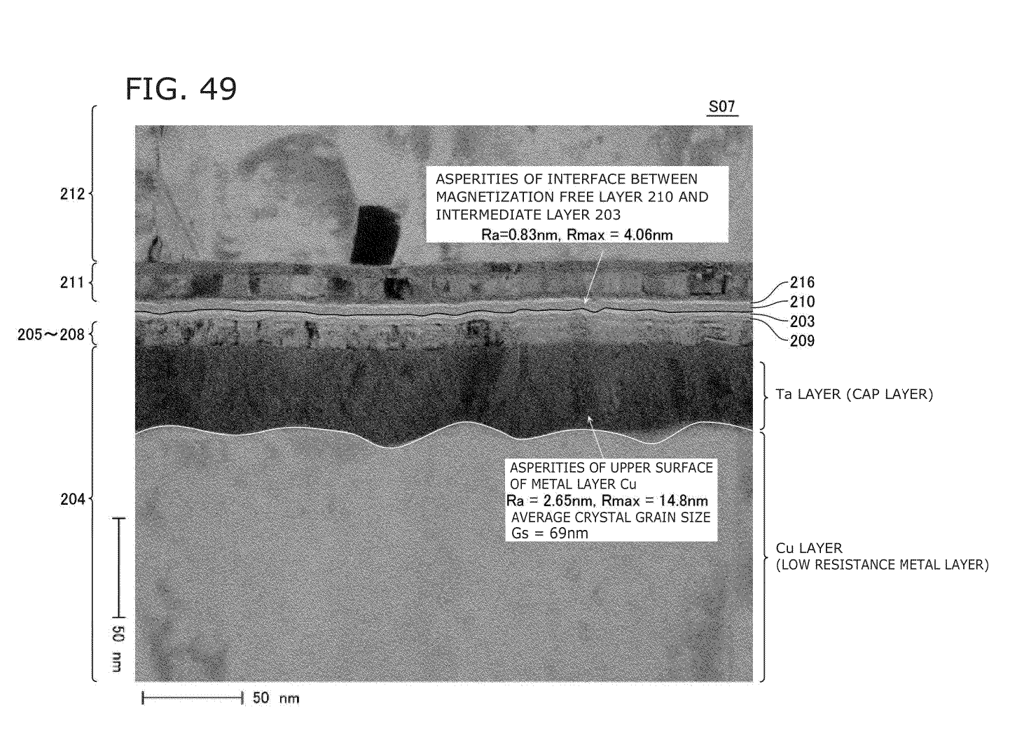

As shown in FIG. 49, in the asperities of the interface between the first magnetic layer 201 and the intermediate layer 203 of the sample S07, the Ra value was 0.83 nm, and the Rmax value was 4.06 nm. As shown in FIG. 49, in the asperities of the interface of the Cu layer formed as a low resistivity metal layer (lower electrode intermediate metal layer 204b) included in the lower electrode 204 of the sample S07, the Ra value was 2.65 nm, and the Rmax value was 14.8 nm. As shown in FIG. 49, the crystal grain size Gs of the Cu layer formed as a low resistivity metal layer included in the lower electrode 204 of the sample S07 was 69 nm.

Next, magnetic characterization was performed on the sample S05, the sample S06, and the sample S07 in the state of continuous film without device processing. Here, magnetic characterization was performed using VSM at a magnetic field sweep rate of 40 Oe/min. As a result, the coercivity of the sample S05 was 3.2 Oe. The coercivity of the sample S06 was 4.5 Oe. The coercivity of the sample S07 was 5.0 Oe. For each of the sample S05, the sample S06, and the sample S07, cross-sectional TEM analysis was performed on a plurality of samples to analyze the relationship between the asperities and the coercivity.

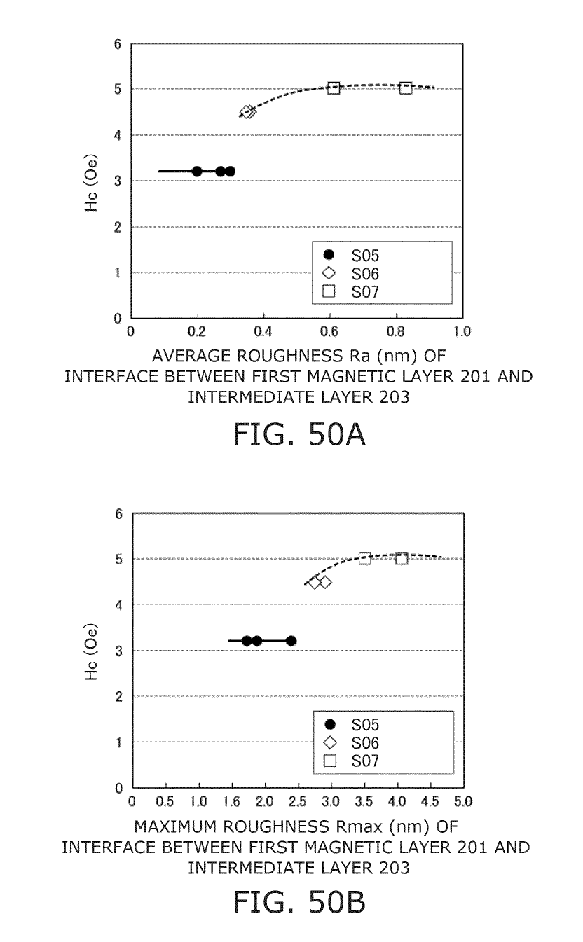

First, FIGS. 50A and 50B show a result for the relationship between the asperities of the interface between the first magnetic layer 201 and the intermediate layer 203, and the coercivity Hc of the first magnetic layer 201. FIG. 50A is a graph showing the relationship between the average roughness Ra and the coercivity Hc. FIG. 50B is a graph showing the relationship between the maximum roughness Rmax and the coercivity Hc. As shown in FIG. 50A, it was found that a low coercivity Hc of 4 Oe or less can be achieved when the average roughness Ra of the interface between the first magnetic layer 201 and the intermediate layer 203 is 0.3 nm or less. As shown in FIG. 50B, it was found that a low coercivity Hc of 4 Oe or less can be achieved when the maximum roughness Rmax of the interface between the first magnetic layer 201 and the intermediate layer 203 is 2.5 nm or less. A high gauge factor GF can be achieved by achieving a low coercivity Hc of 4 Oe or less as described later.

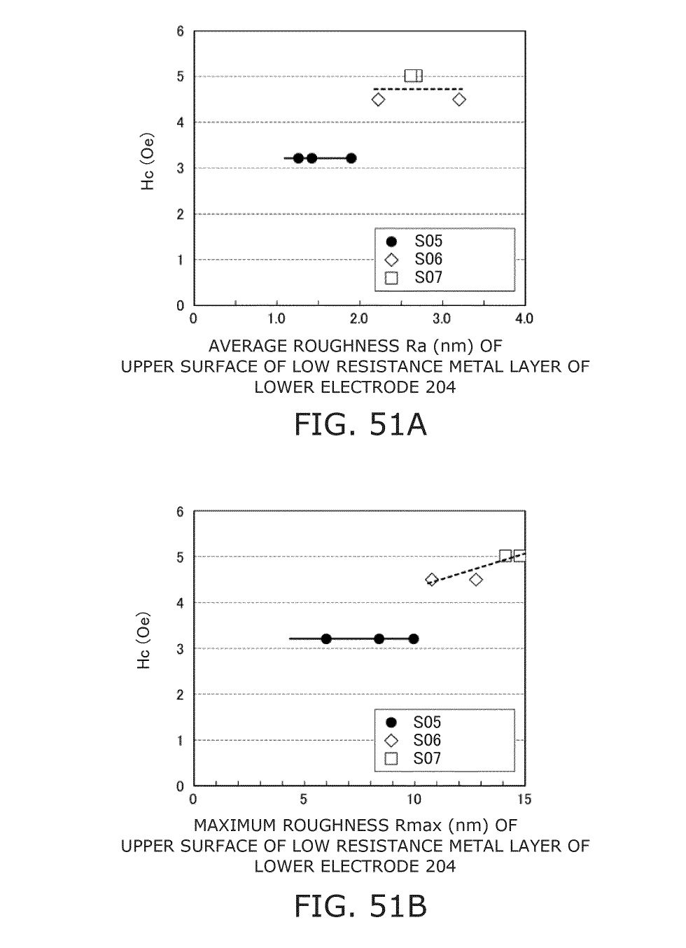

Next, FIGS. 51A and 51B show a result for the relationship between the asperities of the upper surface of the low resistivity metal layer (lower electrode intermediate metal layer 204b) included in the lower electrode 204 and the coercivity Hc of the first magnetic layer 201. FIG. 51A is a graph showing the relationship between the average roughness Ra and the coercivity Hc. FIG. 51B is a graph showing the relationship between the maximum roughness Rmax and the coercivity Hc. As shown in FIG. 51A, it was found that a low coercivity Hc of 4 Oe or less can be achieved when the average roughness Ra of the upper surface of the low resistivity metal layer is 2 nm or less. As shown in FIG. 51B, it was found that a low coercivity Hc of 4 Oe or less can be achieved when the maximum roughness Rmax of the upper surface of the low resistivity metal layer is 10 nm or less. A high gauge factor GF can be achieved by achieving a low coercivity Hc of 4 Oe or less as described later.

Next, FIG. 52 shows a result for the relationship between the crystal grain size of the low resistivity metal layer included in the lower electrode 204 and the coercivity Hc. As shown in FIG. 52, it was found that a low coercivity of 4 Oe or less can be achieved when the crystal grain size Gs of the low resistivity metal layer is 50 nm or less. A high gauge factor GF can be achieved by achieving a low coercivity Hc of 4 Oe or less as described later.

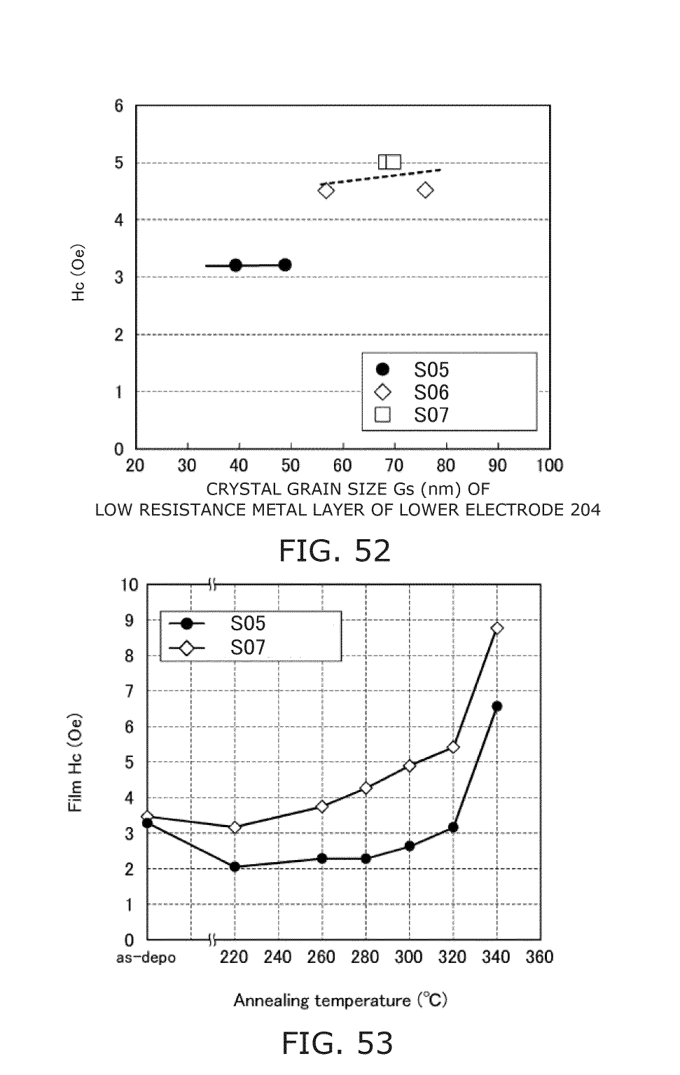

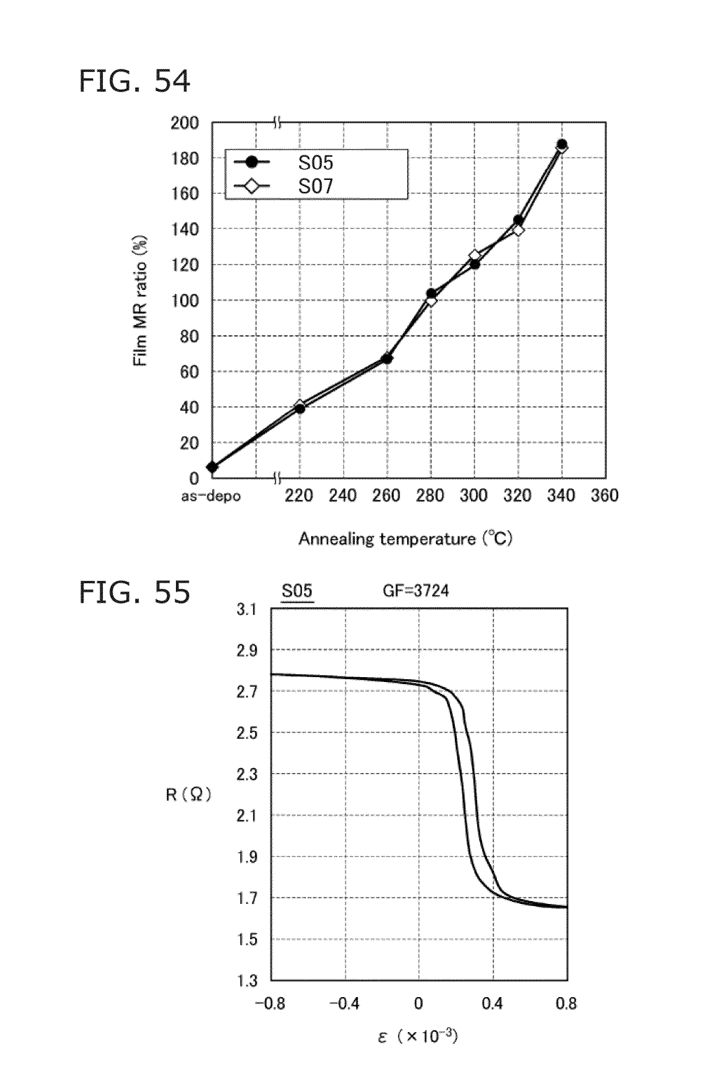

Next, the cause of the difference of coercivity confirmed by the difference of the configuration of the lower electrode was examined. Specifically, as shown in FIGS. 53 and 54, for the sample S05 and the sample S07, the heat treatment temperature dependence of the coercivity and the MR ratio was examined in the state of continuous film without device processing. In this experiment, a plurality of samples S05 and a plurality of samples S07 were fabricated and subjected to annealing treatment at different temperatures (220° C., 260° C., 280° C., 300° C., 320° C., 340° C.). Next, the coercivity Hc and the MR ratio of these samples were measured. Here, characterization of coercivity was performed using VSM at a magnetic field sweep rate of 40 Oe/min.

In FIG. 53, the horizontal axis represents the temperature of annealing treatment. The vertical axis represents the coercivity Hc of the magnetization free layer 210. As shown in FIG. 53, the sample S05 and the sample S07 in the state before heat treatment (as-depo) have a comparable coercivity Hc of 3.3 Oe. In the sample S05, the asperities of the surface of the magnetization free layer 210 are small, and the asperities of the surface of the lower electrode intermediate metal layer 204b are small. As shown in FIG. 53, in the sample S05, the coercivity Hc gradually increases in the range of 2-3 Oe while the temperature of annealing treatment increases from 220° C. to 320° C. In the sample S05, the coercivity Hc steeply increases to approximately 6.5 Oe when the temperature of annealing treatment reaches 340° C. On the other hand, in the sample S07, the asperities of the surface of the magnetization free layer 210 are large, and the asperities of the surface of the lower electrode intermediate metal layer 204b are large. As shown in FIG. 53, in the sample S07, the coercivity Hc gradually increases in the range of 3-5.5 Oe while the temperature of annealing treatment increases from 220° C. to 320° C. In the sample S07, the coercivity Hc exceeds 4 Oe when the temperature of annealing treatment is 280° C. or more.

In FIG. 54, the horizontal axis represents the temperature of annealing treatment. The vertical axis represents the magnitude of the MR ratio. As shown in FIG. 54, the MR ratio of the sample S05 and the sample S07 increases in a nearly equal proportion to the temperature of annealing treatment.

As shown in FIG. 53, in the state before heat treatment, the coercivity Hc of the magnetization free layer 210 is small.

It is considered that the magnetization free layer 210 is maintained in the amorphous state. However, as shown in FIG. 54, in the state before heat treatment, the MR ratio is as very small as 10% or less. Thus, a high gauge factor cannot be obtained.

As shown in FIG. 54, the MR ratio increases with the increase of the temperature of annealing treatment. It is considered that this results from the crystallization of the intermediate layer 203 made of MgO and the crystallization of the first magnetization fixed layer 209 made of Co—Fe—B.

As shown in FIG. 54, the MR ratio with respect to the annealing temperature of the sample S05 is comparable with the MR ratio with respect to the annealing temperature of the sample S07. It is found that the MR ratio is less susceptible to the difference in the asperities of the surface of the magnetization free layer 210 and the asperities of the surface of the lower electrode intermediate metal layer 204b.

On the other hand, as shown in FIG. 53, the coercivity Hc of the sample S05 and the coercivity Hc of the sample S07 are clearly different after heat treatment.

In the sample S07, the asperities of the surface of the magnetization free layer 210 and the lower electrode intermediate metal layer 204b are large. In the sample S05, the asperities of the surface of the magnetization free layer 210 and the lower electrode intermediate metal layer 204b are small. It is found that the increase of Hc due to annealing treatment is more significant in the sample S07 than in the sample S05.

As shown in FIG. 53, in the sample S05, the coercivity Hc is maintained at 3.2 Oe or less at a heat treatment temperature of up to 320° C. A small coercivity Hc is maintained at up to higher temperature in the sample S05 than in the sample S07. In other words, the magnetization free layer 210 is maintained in the amorphous structure at up to higher temperature in the sample S05 than in the sample S07.

As shown in FIG. 54, both the sample S05 and the sample S07 can achieve a high MR ratio of 100% or more at a heat treatment temperature of 280° C. or more. The sample S05 can maintain a small coercivity Hc of 4 Oe or less even at a heat treatment temperature of 280° C. or more at which this high MR ratio can be achieved. Thus, a high gauge factor can be obtained.

As described with reference to FIG. 24, due to the asperities of the surface, boron (amorphous forming element) included in the magnetization free layer 210 is more likely to remain in the magnetization free layer 210 without diffusing to the adjacent layer. This facilitates maintaining the amorphous structure of the magnetization free layer 210. It is considered that this causes the difference of characteristics resulting from the asperities of the surface of the magnetization free layer 210 and the lower electrode intermediate metal layer 204b as confirmed in the comparison between the sample S05 and the sample S07.

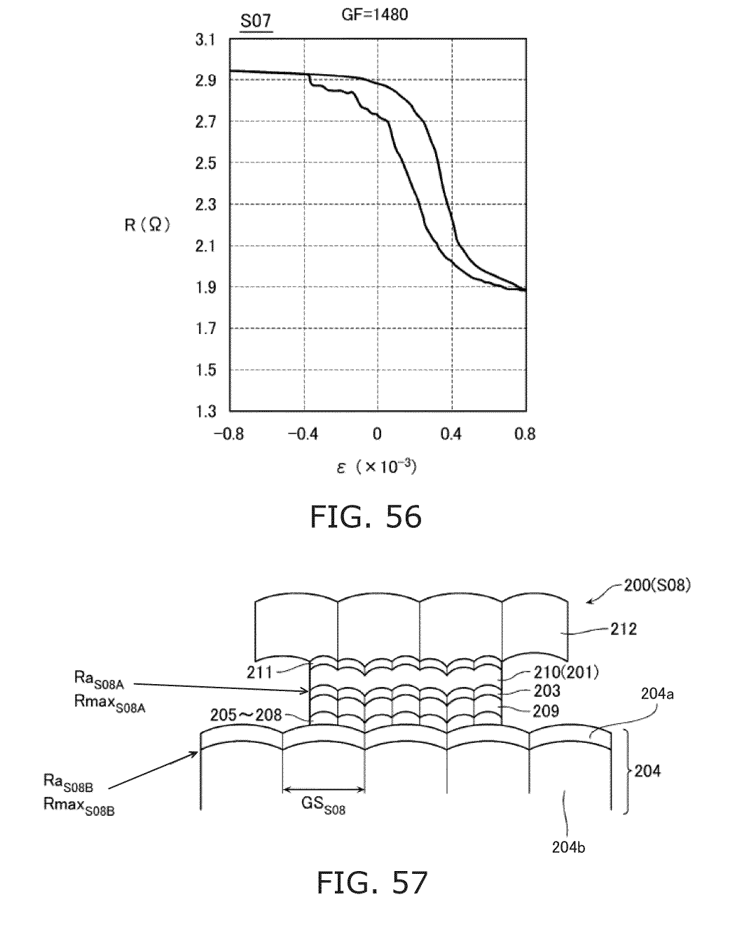

FIGS. 55 and 56 show the relationship between the strain ε applied to the sample S05 and the sample S07 and the electrical resistance R, respectively. The horizontal axis represents the strain ε. The vertical axis represents the electrical resistance R between the lower electrode 204 and the upper electrode 212.

Annealing treatment at 320° C. for 1 hour was performed on a sample similar to the sample of the cross-sectional TEM image shown in FIG. 47. FIG. 55 shows the measurement result of this sample.

Annealing treatment at 320° C. for 1 hour was performed on a sample similar to the sample of the cross-sectional TEM image shown in FIG. 49. FIG. 56 shows the measurement result of this sample.

The characteristic of the sample S05 was calculated from these results. Then, the gauge factor (GF=(dR/R)/dε) was 3724. Likewise, the characteristic of the sample S07 was calculated. Then, the gauge factor (GF=(dR/R)/dε) was 1480. It is considered that such difference in gauge factor results from the difference in the magnitude of the coercivity Hc as shown in FIGS. 50A and 50B.

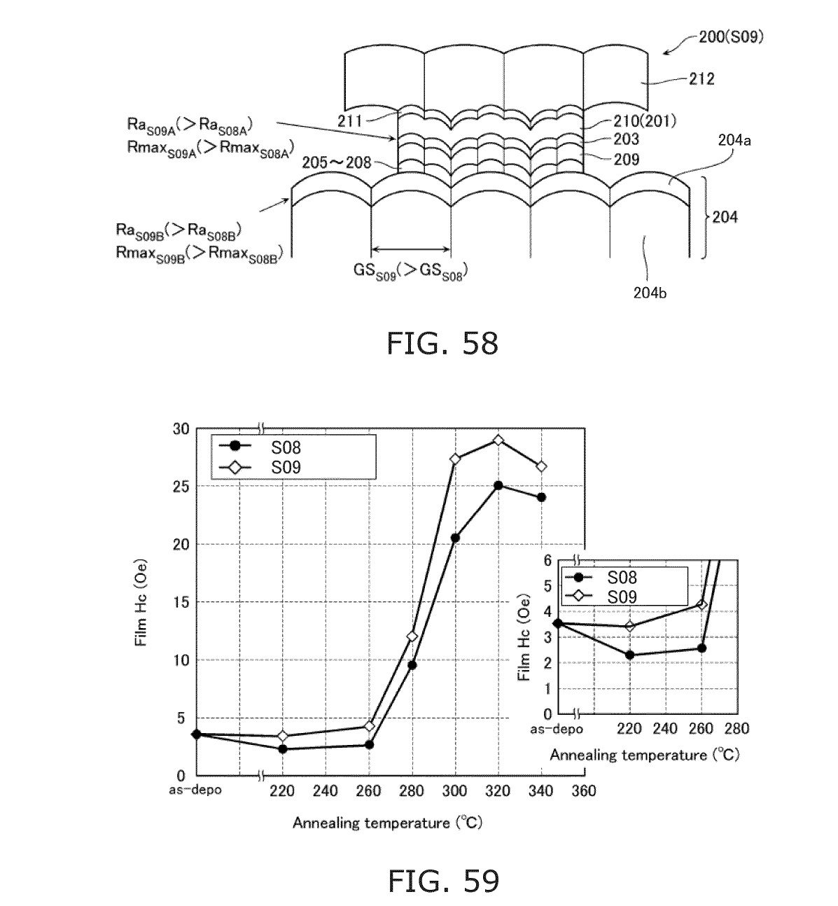

Next, sample S08 and sample 09 as shown in FIGS. 57 and 58 were fabricated and subjected to magnetic characterization. The sample S08 and the sample 09 are different from each other in the asperities of the magnetization free layer 210. The sample S08 and the sample 09 are different from each other in the asperities of the low resistivity metal layer (204b) included in the lower electrode 204.

FIG. 57 is a schematic sectional view illustrating the configuration of the sample S08. FIG. 58 is a schematic sectional view showing the configuration of the sample S09. The sample S08 is configured substantially similarly to the sample S05. However, the sample S08 includes no diffusion prevention layer 216. The sample S09 is configured substantially similarly to the sample S07. However, the sample S09 includes no diffusion prevention layer 216.

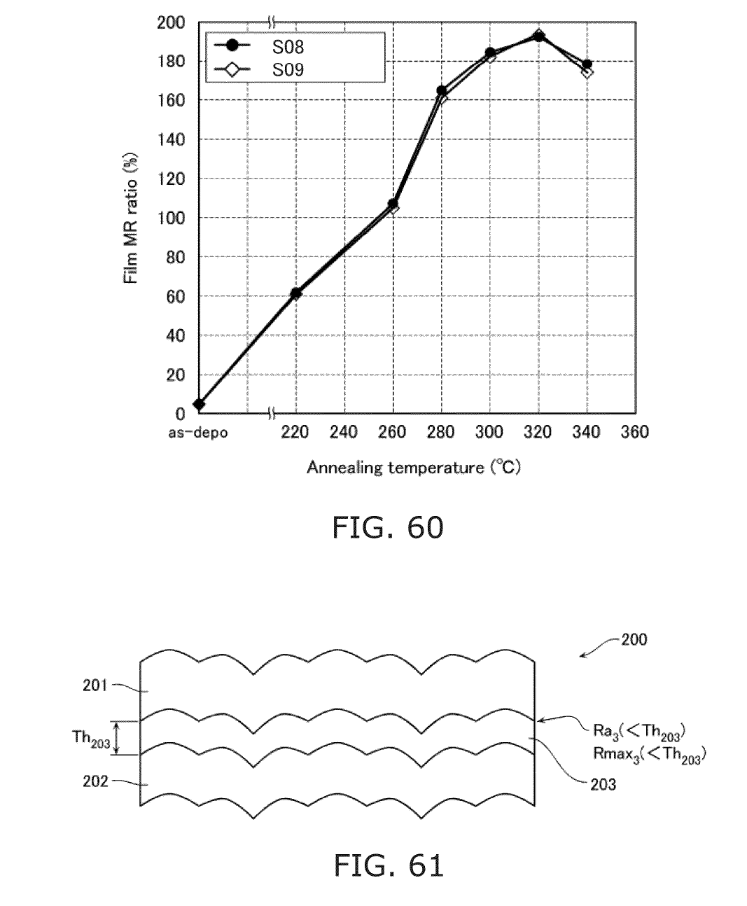

Next, as shown in FIGS. 59 and 60, magnetic characterization was performed on the sample S08 and the sample S09 in the state of continuous film without device processing. In this experiment, a plurality of samples S08 and a plurality of samples S09 were fabricated. The plurality of samples were subjected to annealing treatment at different temperatures (220° C., 260° C., 280° C., 300° C., 320° C., 340° C.). Next, the coercivity Hc and the MR ratio of these samples were measured. Here, characterization of coercivity Hc was performed using VSM at a magnetic field sweep rate of 40 Oe/min.

In FIG. 59, the horizontal axis represents the temperature of annealing treatment. The vertical axis represents the coercivity Hc of the magnetization free layer 210. As shown in FIG. 59, in the state before heat treatment (as-depo), the coercivity Hc of the sample S08 and the coercivity Hc of the sample S09 are nearly comparable, and are each 3.3 Oe. As shown in FIG. 59, in the sample S08 and the sample S09, the coercivity Hc gradually increases while the temperature of annealing treatment increases from 220° C. to 260° C. The coercivity Hc steeply increases when the temperature of annealing treatment reaches 280° C.

In FIG. 60, the horizontal axis represents the temperature of annealing treatment. The vertical axis represents the magnitude of the MR ratio. As shown in FIG. 60, the MR ratio of the sample S08 and the sample S09 increases in a nearly equal proportion to the temperature of annealing treatment.

As shown in FIG. 59, in the state before heat treatment, the coercivity Hc of the magnetization free layer 210 is small.

It is considered that the magnetization free layer 210 is maintained in the amorphous state. However, as shown in FIG. 60, in the state before heat treatment, the MR ratio is as very small as 10% or less. Thus, a high gauge factor cannot be obtained.

As shown in FIG. 60, it is found that the MR ratio increases with the increase of the temperature of annealing treatment. It is considered that this results from the crystallization of the intermediate layer 203 made of MgO and the first magnetization fixed layer 209 made of Co—Fe—B.

As shown in FIG. 60, the MR ratio with respect to the annealing temperature of the sample S08 is comparable with the MR ratio with respect to the annealing temperature of the sample S09. It is found that the MR ratio is less susceptible to the difference in the asperities of the surface of the magnetization free layer 210 and the asperities of the surface of the lower electrode intermediate metal layer 204b.

On the other hand, as shown in FIG. 59, the coercivity Hc of the sample S08 and the coercivity Hc of the sample S09 are clearly different after heat treatment. The coercivity Hc of the sample S09 is more likely to increase than that of the sample S08.

As shown in FIG. 59, in the sample S08, Hc is maintained at 3 Oe or less at a heat treatment temperature of up to 260° C. A small coercivity Hc can be maintained at up to higher temperature in the sample S08 than in the sample S09. In other words, the amorphous structure of the magnetization free layer 210 can be maintained at up to higher temperature in the sample S08 than in the sample S09.

As shown in FIG. 60, both the sample S08 and the sample S09 can achieve a high MR ratio of 100% or more by heat treatment at 260° C. or more. The sample S08 can maintain a small coercivity Hc of 4 Oe or less even at a heat treatment temperature of 260° C. or more at which this high MR ratio can be achieved. Thus, a high gauge factor can be obtained.

Thus, the difference of characteristics resulting from the surface asperities of the magnetization free layer 210 and the low resistivity metal layer included in the lower electrode 204 is confirmed in the comparison between the sample S08 and the sample S09. The reason for this difference is as follows. As described with reference to FIG. 24, boron (amorphous forming element) included in the magnetization free layer 210 is more likely to remain in the magnetization free layer 210 without diffusing to the adjacent layer. This facilitates maintaining the amorphous structure of the magnetization free layer 210.

As described with reference to FIG. 24, due to the asperities of the surface, boron (amorphous forming element) included in the magnetization free layer 210 is more likely to remain in the magnetization free layer 210 without diffusing to the adjacent layer. This facilitates maintaining the amorphous structure of the magnetization free layer 210. It is considered that this causes the difference of characteristics resulting from the asperities of the surface of the magnetization free layer 210 and the lower electrode intermediate metal layer as confirmed in the comparison between the sample S05 and the sample S07.

Thus, also in the case of providing no diffusion prevention layer 216, the MR ratio can be made compatible with a low coercivity Hc by reducing the surface asperities of the magnetization free layer 210 and the low resistivity metal layer included in the lower electrode 204. Thus, it was found that a high gauge factor can be achieved.

FIG. 61 is a schematic sectional view illustrating part of an alternative strain sensing element according to the third embodiment.

The strain sensing element 200 shown in FIG. 61 is configured substantially similarly to the strain sensing element 200 described with reference to FIG. 23. However, in the detection element 200 shown in FIG. 61, the average roughness Ra₃ or the maximum roughness Rmax₃ of the interface between the intermediate layer 203 and the first magnetic layer 201 can be made less than or equal to the thickness Th₂₀₃ of the intermediate layer 203. The average roughness Ra₃ is calculated by e.g. the Ra value described with reference to FIGS. 27A and 27B. The maximum roughness Rmax₃ is calculated by e.g. the Rmax value described with reference to FIG. 27C.

In the strain sensing element 200 shown in FIG. 61, the crystallization of the magnetization free layer 210 is suppressed by reducing the average roughness Ra₃ or the maximum roughness Rmax₃ of the interface between the intermediate layer 203 and the first magnetic layer 201.

As described with reference to FIGS. 24 and 25, it is considered that diffusion of the amorphous forming element results from occurrence of a thin portion in the intermediate layer 203 and the diffusion prevention layer 216. Thus, it is considered that the allowable size of asperities is larger e.g. when the intermediate layer 203 and the diffusion prevention layer are thick. Accordingly, it is considered favorable for diffusion prevention of the amorphous forming element to determine the asperities of the interface between the intermediate layer 203 and the first magnetic layer 201 in relation to the film thickness of the intermediate layer 203 and the diffusion prevention layer.

Although not shown in FIG. 61, in the strain sensing element 200 according to this embodiment, a diffusion prevention layer can be provided on e.g. the intermediate layer 203. In this case, the average roughness or the maximum roughness of the interface between the diffusion prevention layer and the first magnetic layer 201 may be made smaller than the film thickness of the diffusion prevention layer. This average roughness is calculated by e.g. the Ra value described with reference to FIGS. 27A and 27B. This maximum roughness is calculated by e.g. the Rmax value described with reference to FIG. 27C.

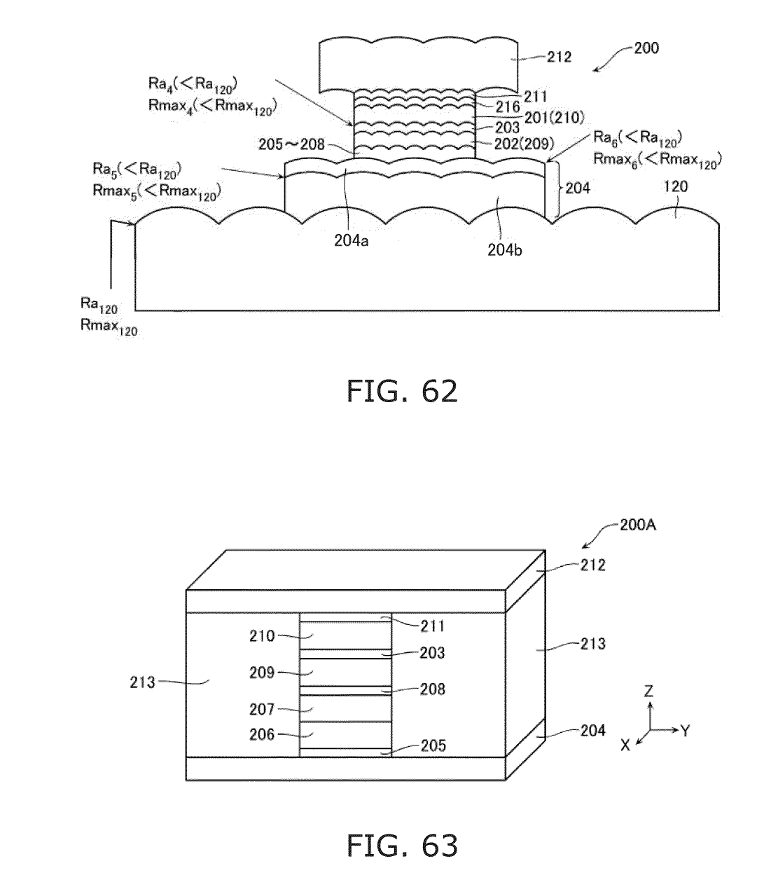

FIG. 62 is a schematic sectional view illustrating part of an alternative strain sensing element according to the third embodiment.

The strain sensing element 200 shown in FIG. 62 is configured substantially similarly to the strain sensing element described with reference to FIG. 23. However, the asperities of the interface between the intermediate layer 203 and the first magnetic layer 201 is smaller than the asperities of the upper surface of the film part 120. For instance, the average roughness Ra₄ of the interface between the intermediate layer 203 and the first magnetic layer 201 is smaller than the average roughness Ra₁₂₀ of the upper surface of the film part 120. For instance, the maximum roughness Rmax₄ of the interface between the intermediate layer 203 and the first magnetic layer 201 is smaller than the maximum roughness Rmax₁₂₀ of the upper surface of the film part 120.

In the strain sensing element 200 shown in FIG. 62, the asperities of the upper surface of the lower electrode intermediate metal layer 204b may be made smaller than the asperities of the upper surface of the film part 120. For instance, the average roughness Ra₅ of the upper surface of the lower electrode intermediate metal layer 204b is smaller than the average roughness Ra₁₂₀ of the upper surface of the film part 120. For instance, the maximum roughness Rmax₅ of the upper surface of the lower electrode intermediate metal layer 204b is smaller than the maximum roughness Rmax₁₂₀ of the upper surface of the film part 120.

In the strain sensing element 200 shown in FIG. 62, the asperities of the upper surface of the lower electrode 204 may be made smaller than the asperities of the upper surface of the film part 120. For instance, the average roughness Ra₆ of the upper surface of the lower electrode 204 is smaller than the average roughness Ra₁₂₀ of the upper surface of the film part 120. For instance, the maximum roughness Rmax₆ of the upper surface of the lower electrode 204 is smaller than the maximum roughness Rmax₁₂₀ of the upper surface of the film part 120.

These average roughnesses Ra₄, Ra₅, Ra₆, and Ra₁₂₀ are calculated by e.g. the Ra value described with reference to FIGS. 27A and 27B. The maximum roughnesses Rmax₄, Rmax₅, and Rmax₁₂₀ are calculated by e.g. the Rmax value described with reference to FIG. 27C.

In the strain sensing element 200 shown in FIG. 62, the asperities of the interface between the intermediate layer 203 and the first magnetic layer 201 and the asperities of the interface between the diffusion prevention layer 216 and the first magnetic layer 201 may be affected by the asperities of the upper surface of the film part 120. Thus, the asperities of the interface between the intermediate layer 203 and the first magnetic layer 201 and the asperities of the interface between the diffusion prevention layer 216 and the first magnetic layer 201 resulting from the asperities of the upper surface of the film part 120 are suppressed. This suppresses occurrence of a thin portion in e.g. the intermediate layer 203 and the diffusion prevention layer 216. Thus, diffusion of the amorphous forming element and the associated crystallization of the magnetization free layer 210 can be suppressed.

### (Alternative Configuration Examples of the Strain Sensing Element According to the Embodiment)

Next, alternative configuration examples of the strain sensing element 200 according to the embodiment are described. FIG. 63 is a schematic perspective view illustrating one configuration example of the strain sensing element 200A. As illustrated in FIG. 63, the strain sensing element 200A may include an insulating layer (insulating portion) 213 filled between the lower electrode 204 and the upper electrode 212.

The insulating layer 213 can be made of e.g. aluminum oxide (e.g., Al₂O₃) or silicon oxide (e.g., SiO₂). The insulating layer 213 can suppress the leakage current of the strain sensing element 200A.

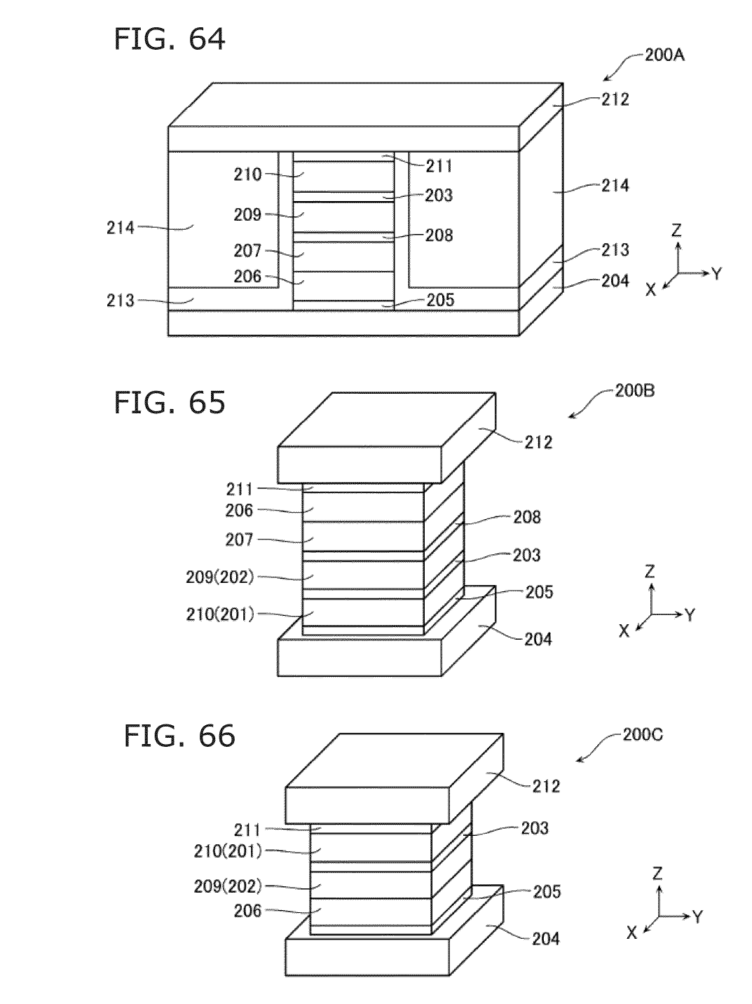

FIG. 64 is a schematic perspective view illustrating an alternative configuration example of the strain sensing element 200A. As illustrated in FIG. 64, the strain sensing element 200A may include two hard bias layers (hard bias portions) 214 and an insulating layer 213. The hard bias layers 214 are provided between the lower electrode 204 and the upper electrode 212 and spaced from each other. The insulating layer 213 is filled between the lower electrode 204 and the hard bias layer 214.

The hard bias layer 214 sets the magnetization direction of the magnetization free layer 210 (first magnetic layer 201) to a desired direction by the magnetization of the hard bias layer 214. The hard bias layer 214 can set the magnetization direction of the magnetization free layer 210 (first magnetic layer 201) to a desired direction when no external pressure is applied to the film part.

The hard bias layer 214 is made of e.g. a hard magnetic material having relatively high magnetic anisotropy and coercivity such as Co—Pt, Fe—Pt, Co—Pd, and Fe—Pd. The hard bias layer 214 may be made of an alloy in which an additive element is further added to Co—Pt, Fe—Pt, Co—Pd, and Fe—Pd. For instance, the hard bias layer 214 may be made of CoPt (the ratio of Co being 50 at. % or more and 85 at. % or less), (CoₓPt₁₀₀₋ₓ)_{100-y}Cr_{y} (x being 50 at. % or more and 85 at. % or less, and y being 0 at. % or more and 40 at. % or less), or FePt (the ratio of Pt being 40 at. % or more and 60 at. % or less). In the case of using such a material, the magnetization direction of the hard bias layer 214 can be set (fixed) to the direction of the applied external magnetic field by applying an external magnetic field larger than the coercivity of the hard bias layer 214. The thickness of the hard bias layer 214 (e.g., the length along the direction from the lower electrode 204 toward the upper electrode 212) is e.g. 5 nm or more and 50 nm or less.

The insulating layer 213 may be placed between the lower electrode 204 and the upper electrode 212. In this case, the material of the insulating layer 213 can be SiOₓ or AlOₓ. Furthermore, an underlayer, not shown, may be provided between the insulating layer 213 and the hard bias layer 214. In the case where the hard bias layer 214 is made of a hard magnetic material having relatively high magnetic anisotropy and coercivity such as Co—Pt, Fe—Pt, Co—Pd, and Fe—Pd, the material of the underlayer for the hard bias layer 214 can be e.g. Cr or Fe—Co. The aforementioned hard bias layer 214 is applicable to any of the strain sensing elements described later.

The hard bias layer 214 may have a structure stacked on a hard bias layer-pinning layer, not shown. In this case, the magnetization direction of the hard bias layer 214 can be set (fixed) by exchange coupling between the hard bias layer 214 and the hard bias layer-pinning layer. In this case, the hard bias layer 214 can be made of a ferromagnetic material including at least one of Fe, Co, and Ni, or an alloy including at least one of them. In this case, the hard bias layer 214 can be made of e.g. CoₓFe₁₀₀₋ₓ alloy (x being 0 at. % or more and 100 at. % or less), NiₓFe₁₀₀₋ₓ alloy (x being 0 at. % or more and 100 at. % or less), or a material in which a nonmagnetic element is added thereto. The hard bias layer 214 can be made of a material like the aforementioned first magnetization fixed layer 209. The hard bias layer-pinning layer can be made of a material like the aforementioned pinning layer 206 in the strain sensing element 200A. In the case of providing a hard bias layer-pinning layer, an underlayer like the material used for the underlayer 205 may be provided below the hard bias layer-pinning layer. The hard bias layer-pinning layer may be provided below or above the hard bias layer. The magnetization direction of the hard bias layer 214 in this case can be determined by heat treatment in magnetic field as in the pinning layer 206.

The hard bias layer 214 and the insulating layer 213 described above are applicable to any of the strain sensing elements 200 described in the embodiment. In the case of using the aforementioned stacked structure of the hard bias layer 214 and the hard bias layer-pinning layer, a large external magnetic field may be instantaneously applied to the hard bias layer 214. Even in this case, the magnetization direction of the hard bias layer 214 can be easily maintained.

FIG. 65 is a schematic perspective view illustrating an alternative configuration example (strain sensing element 200B) of the strain sensing element 200. The strain sensing element 200B is different from the strain sensing element 200A in having the top spin valve structure. More specifically, as shown in FIG. 65, the strain sensing element 200B is composed of a lower electrode 204, a stacked body provided on this lower electrode 204, and an upper electrode 212 provided on this stacked body. This stacked body includes an underlayer 205, a magnetization free layer 210 (first magnetic layer 201), an intermediate layer 203, a first magnetization fixed layer 209 (second magnetic layer 202), a magnetic coupling layer 208, a second magnetization fixed layer 207, a pinning layer 206, and a cap layer 211 stacked sequentially from the near side of the lower electrode 204. The first magnetization fixed layer 209 corresponds to the second magnetic layer 202. The magnetization free layer 210 corresponds to the first magnetic layer 201. A diffusion prevention layer, not shown, may be provided between the underlayer 205 and the magnetization free layer 210.

The underlayer 205 is made of e.g. Ta/Cu. The thickness (length in the Z-axis direction) of this Ta layer is e.g. 3 nm. The thickness of this Cu layer is e.g. 5 nm. The magnetization free layer 210 is made of e.g. Co₄₀Fe₄₀B₂₀ with a thickness of 4 nm. The intermediate layer 203 is e.g. an MgO layer having a thickness of 1.6 nm. The first magnetization fixed layer 209 is made of e.g. Co₄₀Fe₄₀B₂₀/Fe₅₀Co₅₀. The thickness of this Co₄₀Fe₄₀B₂₀ layer is e.g. 2 nm. The thickness of this Fe₅₀Co₅₀ layer is e.g. 1 nm. The magnetic coupling layer 208 is e.g. a Ru layer having a thickness of 0.9 nm. The second magnetization fixed layer 207 is e.g. a Co₇₅Fe₂₅ layer having a thickness of 2.5 nm. The pinning layer 206 is e.g. an IrMn layer having a thickness of 7 nm. The cap layer 211 is made of e.g. Ta/Ru. The thickness of this Ta layer is e.g. 1 nm. The thickness of this Ru layer is e.g. 5 nm.

In the aforementioned strain sensing element 200A of the bottom spin valve type, the first magnetization fixed layer 209 (second magnetic layer 202) is formed below (on the −Z-axis side of) the magnetization free layer 210 (first magnetic layer 201). In contrast, in the strain sensing element 200B of the top spin valve type, the first magnetization fixed layer 209 (second magnetic layer 202) is formed above (on the +Z-axis side of) the magnetization free layer 210 (first magnetic layer 201). Thus, the material of the layers included in the strain sensing element 200B can use the material of the layers included in the strain sensing element 200A inverted vertically. The aforementioned diffusion prevention layer can be provided between the underlayer 205 and the magnetization free layer 210 of the strain sensing element 200B.

FIG. 66 is a schematic perspective view illustrating an alternative configuration example (strain sensing element 200C) of the strain sensing element 200. The strain sensing element 200C is based on a single pinned structure using a single magnetization fixed layer. More specifically, as shown in FIG. 66, the strain sensing element 200C is composed of a lower electrode 204, a stacked body provided on this lower electrode 204, and an upper electrode 212 provided on this stacked body. This stacked body includes an underlayer 205, a pinning layer 206, a first magnetization fixed layer 209 (second magnetic layer 202), an intermediate layer 203, a magnetization free layer 210 (first magnetic layer 201), and a cap layer 211 stacked sequentially from the near side of the lower electrode 204. The first magnetization fixed layer 209 corresponds to the second magnetic layer 202. The magnetization free layer 210 corresponds to the first magnetic layer 201. A diffusion prevention layer, not shown, may be provided between the magnetization free layer 210 and the cap layer 211.

The underlayer 205 is made of e.g. Ta/Ru. The thickness (length in the Z-axis direction) of this Ta layer is e.g. 3 nm. The thickness of this Ru layer is e.g. 2 nm. The pinning layer 206 is e.g. an IrMn layer having a thickness of 7 nm. The first magnetization fixed layer 209 is e.g. a Co₄₀Fe₄₀B₂₀ layer having a thickness of 3 nm. The intermediate layer 203 is e.g. an MgO layer having a thickness of 1.6 nm. The magnetization free layer 210 is made of e.g. Co₄₀Fe₄₀B₂₀ with a thickness of 4 nm. The cap layer 211 is made of e.g. Ta/Ru. The thickness of this Ta layer is e.g. 1 nm. The thickness of this Ru layer is e.g. 5 nm.

The material of the layers of the strain sensing element 200C can be made similar to the material of the layers of the strain sensing element 200A.

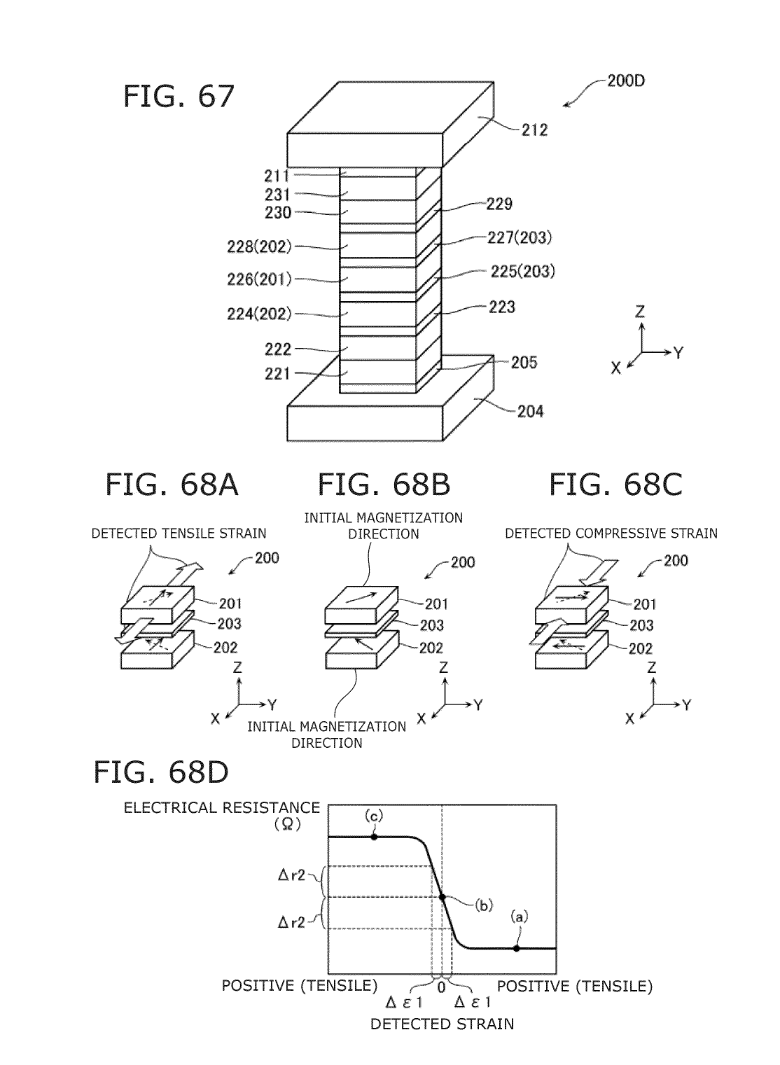

FIG. 67 is a schematic perspective view illustrating an alternative configuration example (strain sensing element 200D) of the strain sensing element 200. As shown in FIG. 67, the strain sensing element 200D is composed of a lower electrode 204, a stacked body provided on this lower electrode 204, and an upper electrode 212 provided on this stacked body. This stacked body includes an underlayer 205, a lower pinning layer 221, a lower second magnetization fixed layer 222, a lower magnetic coupling layer 223, a lower first magnetization fixed layer 224, a lower intermediate layer 225, a magnetization free layer 226, an upper intermediate layer 227, an upper first magnetization fixed layer 228, an upper magnetic coupling layer 229, an upper second magnetization fixed layer 230, an upper pinning layer 231, and a cap layer 211 stacked sequentially from the near side of the lower electrode 204. The lower first magnetization fixed layer 224 and the upper first magnetization fixed layer 228 correspond to the second magnetic layer 202. The magnetization free layer 226 corresponds to the first magnetic layer 201.

The underlayer 205 is made of e.g. Ta/Ru. The thickness (length in the Z-axis direction) of this Ta layer is e.g. 3 nanometers (nm). The thickness of this Ru layer is e.g. 2 nm. The lower pinning layer 221 is e.g. an IrMn layer having a thickness of 7 nm. The lower second magnetization fixed layer 222 is e.g. a Co₇₅Fe₂₅ layer having a thickness of 2.5 nm. The lower magnetic coupling layer 223 is e.g. a Ru layer having a thickness of 0.9 nm. The lower first magnetization fixed layer 224 is e.g. a Co₄₀Fe₄₀B₂₀ layer having a thickness of 3 nm. The lower intermediate layer 225 is e.g. an MgO layer having a thickness of 1.6 nm. The magnetization free layer 226 is made of e.g. Co₄₀Fe₄₀B₂₀ with a thickness of 4 nm. The upper intermediate layer 227 is e.g. an MgO layer having a thickness of 1.6 nm. The upper first magnetization fixed layer 228 is made of e.g. Co₄₀Fe₄₀B₂₀/Fe₅₀Co₅₀. The thickness of this Co₄₀Fe₄₀B₂₀ layer is e.g. 2 nm. The thickness of this Fe₅₀Co₅₀ layer is e.g. 1 nm. The upper magnetic coupling layer 229 is e.g. a Ru layer having a thickness of 0.9 nm. The upper second magnetization fixed layer 230 is e.g. a Co₇₅Fe₂₅ layer having a thickness of 2.5 nm. The upper pinning layer 231 is e.g. an IrMn layer having a thickness of 7 nm. The cap layer 211 is made of e.g. Ta/Ru. The thickness of this Ta layer is e.g. 1 nm. The thickness of this Ru layer is e.g. 5 nm.

The material of the layers of the strain sensing element 200D can be made similar to the material of the layers of the strain sensing element 200A.

Next, an alternative mode of the strain sensing element 200 according to the embodiment is described with reference to FIGS. 68A to 68D. The foregoing has described a mode in which the second magnetic layer 202 is a magnetization fixed layer. However, as described above, the second magnetic layer 202 may be a magnetization free layer. In the following description, the second magnetic layer 202 is a magnetization free layer. The strain sensing element 200 has what is called a two-layer free structure.

FIGS. 68A, 68B, and 68C are schematic perspective views showing the state of the strain sensing element 200 with a tensile strain, with no strain, and with a compressive strain, respectively. In the example shown in FIGS. 68A, 68B, and 68C, it is assumed that the second magnetic layer 202 is a magnetization free layer. It is also assumed that the direction of strain occurring in the strain sensing element 200 is the X-direction.

FIG. 68B shows the case where no strain occurs in the strain sensing element 200 according to the embodiment. In this case, the relative angle of the magnetization direction of the first magnetic layer 201 and the magnetization direction of the second magnetic layer 202 is larger than 0° and smaller than 180°. In the example shown in FIG. 68B, the initial magnetization direction of the first magnetic layer 201 is 90° relative to the initial magnetization direction of the second magnetic layer 202. These initial magnetization directions are each 45° (135°) relative to the direction in which the strain occurs.

As shown in FIG. 68A, when a tensile strain occurs in the X-direction in the strain sensing element 200, the inverse magnetostriction effect occurs in the first magnetic layer 201 and the second magnetic layer 202. This relatively changes the magnetization directions of these magnetic layers. The first magnetic layer 201 and the second magnetic layer 202 of the strain sensing element 200 are made of a ferromagnet having a positive magnetostriction constant. Thus, as shown in FIG. 68A, the magnetization directions of the first magnetic layer 201 and the second magnetic layer 202 are each made close to parallel with respect to the direction of the tensile strain. The magnetostriction constant of the first magnetic layer 201 may be negative. In the example shown in FIG. 68A, these magnetization directions change so as to decrease the angle difference therebetween.

On the other hand, as shown in FIG. 68C, when a compressive strain occurs in the X-direction in the strain sensing element 200, the inverse magnetostriction effect occurs in the first magnetic layer 201 and the second magnetic layer 202. Thus, the magnetization directions of the first magnetic layer 201 and the second magnetic layer 202 are each made close to perpendicular with respect to the direction of the compressive strain. In the example shown in FIG. 68C, these magnetization directions change so as to increase the angle difference therebetween.

FIG. 68D is a schematic graph showing the relationship between the electrical resistance of the strain sensing element 200 and the strain occurring in the strain sensing element 200. In FIG. 68D, the strain in the tensile direction is represented as a strain in the positive direction, and the strain in the compressive direction is represented as a strain in the negative direction.

As shown in FIG. 68D, the electrical resistance of the strain sensing element 200 according to the embodiment decreases when a positive strain (tensile strain) occurs, and increases when a negative strain (compressive strain) occurs. Thus, the strain sensing element 200 can be directly used for a device responsive to positive and negative pressure such as a microphone.

The strain of the strain sensing element 200 may be near zero. In this case, a relatively large resistance change Ar2 can be obtained in response to a small strain Δε1 applied in any of the positive direction (tensile direction) and the negative direction (compressive direction). That is, the strain sensing element 200 according to the embodiment has a large gauge factor for a very small strain. Thus, the strain sensing element 200 is suitable for the manufacturing of a high-sensitivity pressure sensor.

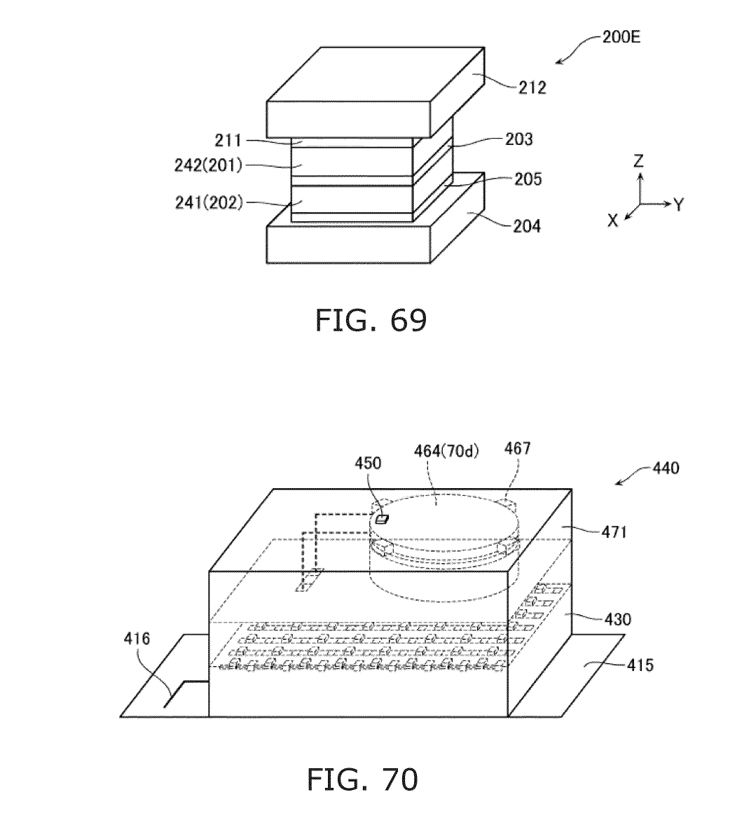

Next, a configuration example of the strain sensing element 200 using the second magnetic layer 202 as a magnetization free layer is described with reference to FIG. 69. FIG. 69 is a schematic perspective view illustrating one configuration example (strain sensing element 200E) of the strain sensing element 200. As shown in FIG. 69, the strain sensing element 200E is composed of a lower electrode 204, a stacked body provided on this lower electrode 204, and an upper electrode 212 provided on this stacked body. This stacked body includes an underlayer 205, a first magnetization free layer 241 (second magnetic layer 202), an intermediate layer 203, a second magnetization free layer 242 (first magnetic layer 201), and a cap layer 211 stacked sequentially from the near side of the lower electrode 204. The first magnetization free layer 241 corresponds to the second magnetic layer 202. The second magnetization free layer 242 corresponds to the first magnetic layer 201. A diffusion prevention layer, not shown, may be provided at least one of between the underlayer 205 and the first magnetization free layer 241 and between the second magnetization free layer 242 and the cap layer 211.

The underlayer 205 is made of e.g. Ta/Ru. The thickness (length in the Z-axis direction) of this Ta layer is e.g. 3 nm. The thickness of this Ru layer is e.g. 5 nm. The first magnetization free layer 241 is made of e.g. Co₄₀Fe₄₀B₂₀ with a thickness of 4 nm. The intermediate layer 203 is e.g. an MgO layer having a thickness of 1.6 nm. The second magnetization free layer 242 is made of e.g. Co₄₀Fe₄₀B₂₀ with a thickness of 4 nm. The cap layer 211 is made of e.g. Ta/Ru. The thickness of this Ta layer is e.g. 1 nm. The thickness of this Ru layer is e.g. 5 nm. A diffusion prevention layer may be provided at least one of between the underlayer 205 and the first magnetization free layer 241 and between the second magnetization free layer 242 and the cap layer 211. In this case, the diffusion prevention layer is e.g. an MgO layer having a thickness of 1.5 nm.

The material of the layers of the strain sensing element 200E can be made similar to the material of the layers of the strain sensing element 200A. The material of the first magnetization free layer 241 and the second magnetization free layer 242 may be made similar to e.g. that of the magnetization free layer 210 of the strain sensing element 200A.

### Fourth Embodiment

Next, a configuration example (pressure sensor 440) of a pressure sensor according to a fourth embodiment is described with reference to FIGS. 70 to 72.

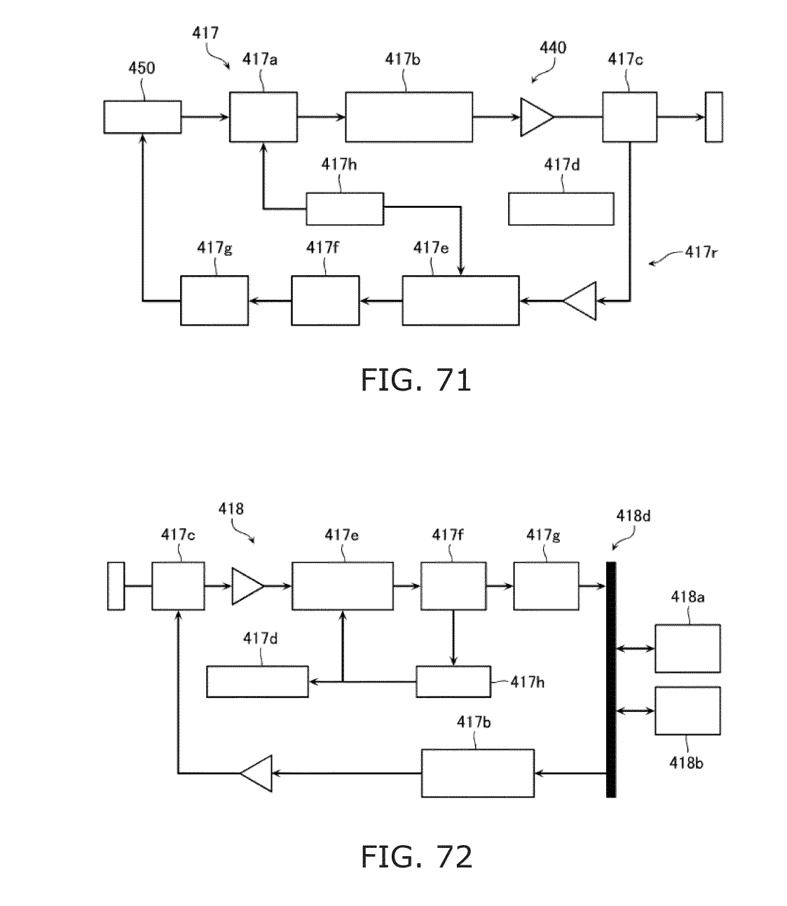

FIG. 70 is a schematic perspective view illustrating a pressure sensor according to the fourth embodiment. FIGS. 71 and 72 are block diagrams illustrating the pressure sensor according to the fourth embodiment.

As shown in FIGS. 70 and 71, the pressure sensor 440 includes a base section 471, a sensing section 450, a semiconductor circuit section 430, an antenna 415, an electrical wiring 416, a transmission circuit 417, and a reception circuit 417r. The sensing section 450 according to this embodiment is e.g. the strain sensing element 200 according to the first to third embodiments.

The antenna 415 is electrically connected to the semiconductor circuit section 430 through the electrical wiring 416.

The transmission circuit 417 wirelessly transmits data based on the electrical signal flowing in the sensing section 450. At least part of the transmission circuit 417 can be provided in the semiconductor circuit section 430.

The reception circuit 417r receives a control signal from electronic equipment 418d. At least part of the reception circuit 417r can be provided in the semiconductor circuit section 430. As the result of providing the reception circuit 417r, the operation of the pressure sensor 440 can be controlled by e.g. manipulating the electronic equipment 418d.

As shown in FIG. 71, the transmission circuit 417 includes e.g. an AD converter 417a and a Manchester encoding section 417b. The AD converter 417a is connected to the sensing section 450. A switching section 417c can be provided to switch transmission and reception. In this case, a timing controller 417d can be provided and used to control switching in the switching section 417c. Furthermore, a data correction section 417e, a synchronization section 417f, a decision section 417g, and a voltage controlled oscillator 417h (VCO) can be provided.

As shown in FIG. 72, the electronic equipment 418d used in combination with the pressure sensor 440 includes a reception section 418. The electronic equipment 418d can be e.g. an electronic device such as a mobile terminal.

In this case, the pressure sensor 440 including the transmission circuit 417 can be used in combination with the electronic equipment 418d including the reception section 418.

The electronic equipment 418d can include a Manchester encoding section 417b, a switching section 417c, a timing controller 417d, a data correction section 417e, a synchronization section 417f, a decision section 417g, a voltage controlled oscillator 417h, a memory section 418a, and a central processing unit 418b (CPU).

In this example, the pressure sensor 440 further includes a fixing part 467. The fixing part 467 fixes the film part 464 (70d) to the base section 471. The thickness dimension of the fixing part 467 can be made thicker than that of the film part 464 so as to be less likely to bend under application of external pressure.

For instance, the fixing parts 467 can be equally spaced on the peripheral edge of the film part 464. Alternatively, the fixing part 467 can be provided so as to continuously surround the entire periphery of the film part 464 (70d). The fixing part 467 can be formed from the same material as e.g. the material of the base section 471. In this case, the fixing part 467 can be formed from e.g. silicon. Alternatively, the fixing part 467 can be formed from the same material as e.g. the material of the film part 464 (70d).

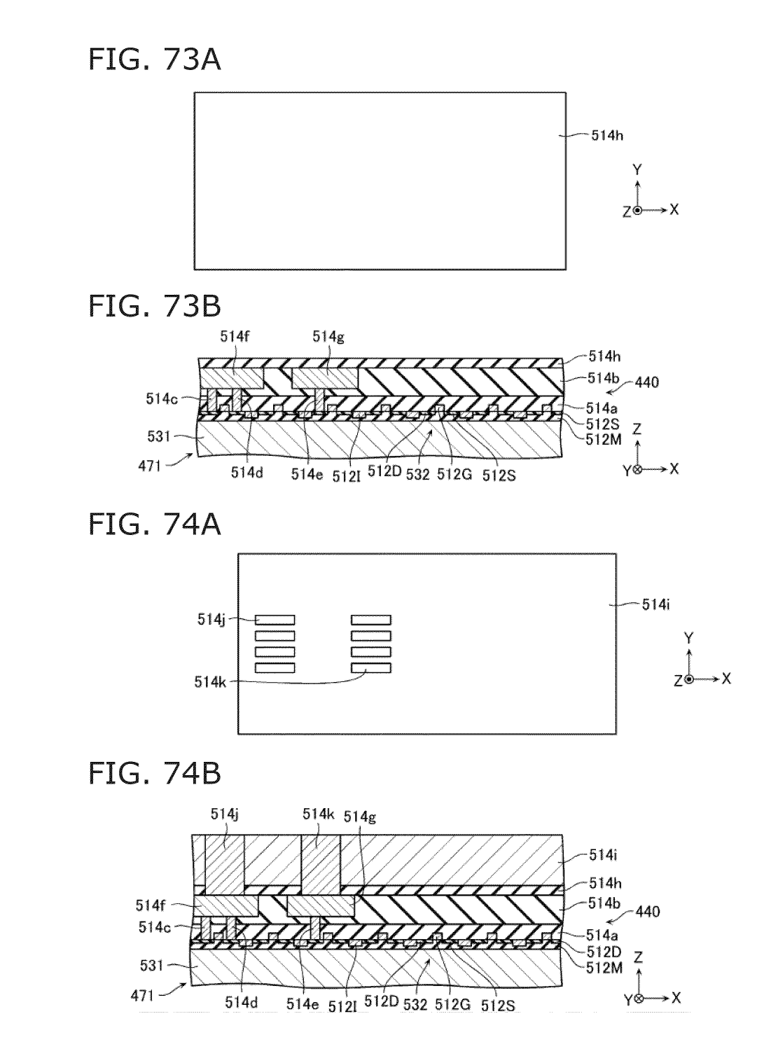

Next, a method for manufacturing the pressure sensor 440 is illustrated with reference to FIGS. 73A to 84B. FIGS. 73A to 84B are schematic plan views and schematic sectional views illustrating a method for manufacturing a pressure sensor according to the fourth embodiment.

As shown in FIGS. 73A and 73B, a semiconductor layer 512M is formed on a surface portion of a semiconductor substrate 531. Next, a device isolation insulating layer 5121 is formed in the upper surface of the semiconductor layer 512M. Next, a gate 512G is formed on the semiconductor layer 512M via an insulating layer, not shown. Next, a source 5125 and a drain 512D are formed on both sides of the gate 512G. Thus, a transistor 532 is formed. Next, an interlayer insulating film 514a is formed thereon. Furthermore, an interlayer insulating film 514b is formed.

Next, a trench and a hole are formed in part of the interlayer insulating film 514a, 514b in the region constituting a non-hollow part. Next, a conductive material is buried in the hole to form connection pillars 514c-514e. In this case, for instance, the connection pillar 514c is electrically connected to the source 5125 of one transistor 532. The connection pillar 514d is electrically connected to the drain 512D. For instance, the connection pillar 514e is electrically connected to the source 5125 of another transistor 532. Next, a conductive material is buried in the trench to form wiring parts 514f, 514g. The wiring part 514f is electrically connected to the connection pillar 514c and the connection pillar 514d. The wiring part 514g is electrically connected to the connection pillar 514e. Next, an interlayer insulating film 514h is formed on the interlayer insulating film 514b.

As shown in FIGS. 74A and 74B, an interlayer insulating film 514i made of silicon oxide (SiO₂) is formed on the interlayer insulating film 514h by e.g. CVD (chemical vapor deposition) technique. Next, a hole is formed at a prescribed position of the interlayer insulating film 514i. A conductive material (e.g., metal material) is buried therein. The upper surface is planarized by CMP (chemical mechanical polishing) technique. Thus, a connection pillar 514j connected to the wiring part 514f and a connection pillar 514k connected to the wiring part 514g are formed.

As shown in FIGS. 75A and 75B, a recess is formed in the region constituting a hollow part 570 of the interlayer insulating film 514i. A sacrificial layer 5141 is buried in the recess. The sacrificial layer 5141 can be formed from e.g. a material that can be formed at low temperature. The material that can be formed at low temperature is e.g. silicon germanium (SiGe).

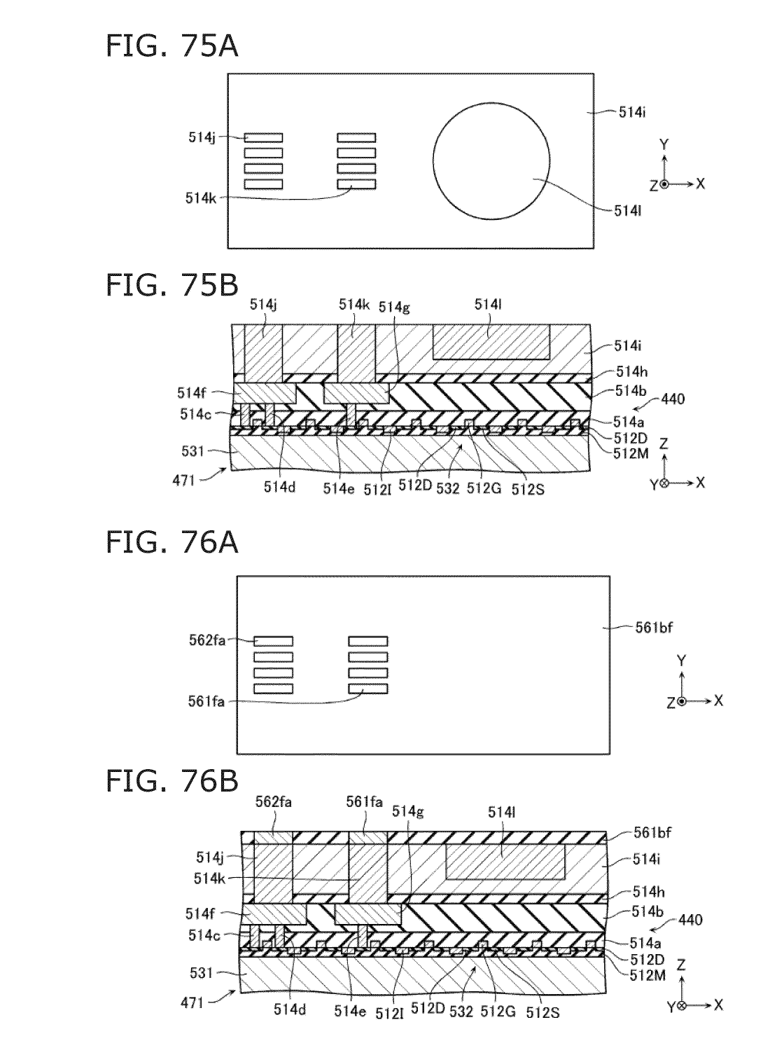

As shown in FIGS. 76A and 76B, an insulating film 561bf constituting a film part 564 (70d) is formed on the interlayer insulating film 514i and the sacrificial layer 5141. The insulating film 561bf can be formed from e.g. silicon oxide (SiO₂). A plurality of holes are provided in the insulating film 561bf. A conductive material (e.g., metal material) is buried in the plurality of holes to form a connection pillar 561fa and a connection pillar 562fa. The connection pillar 561fa is electrically connected to the connection pillar 514k. The connection pillar 562fa is electrically connected to the connection pillar 514j.

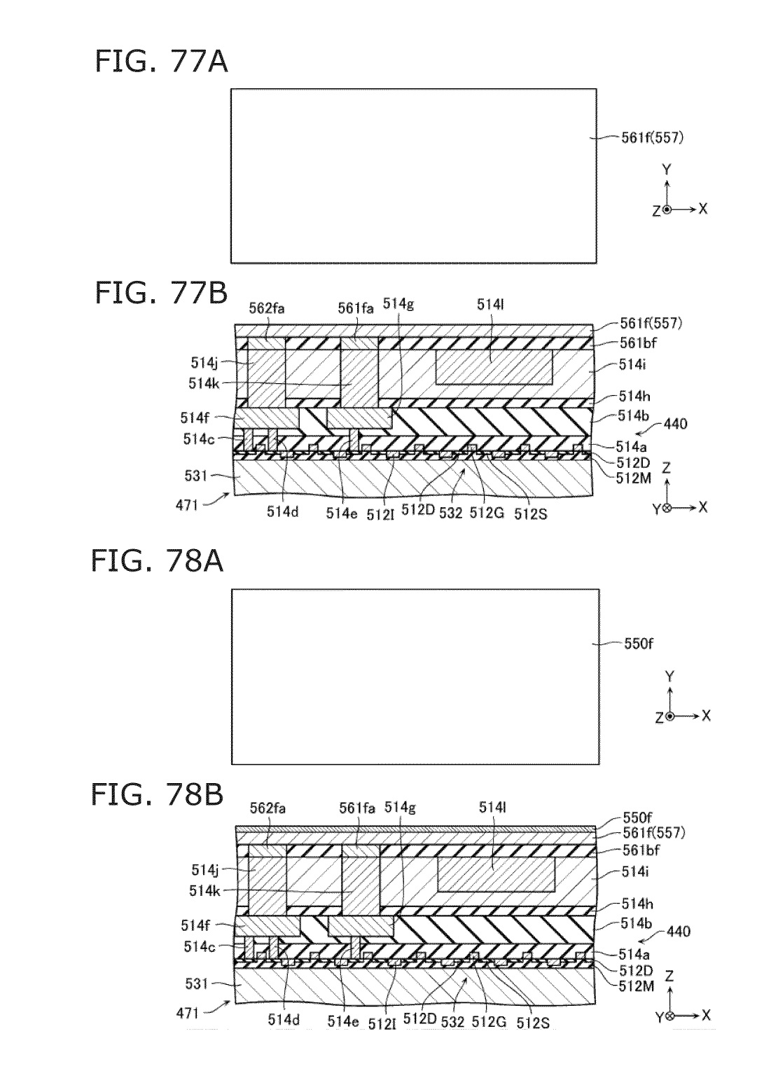

As shown in FIGS. 77A and 77B, a conductive layer 561f constituting a wiring 557 is formed on the insulating film 561bf, the connection pillar 561fa, and the connection pillar 562fa.

As shown in FIGS. 78A and 78B, a stacked film 550f is formed on the conductive layer 561f.

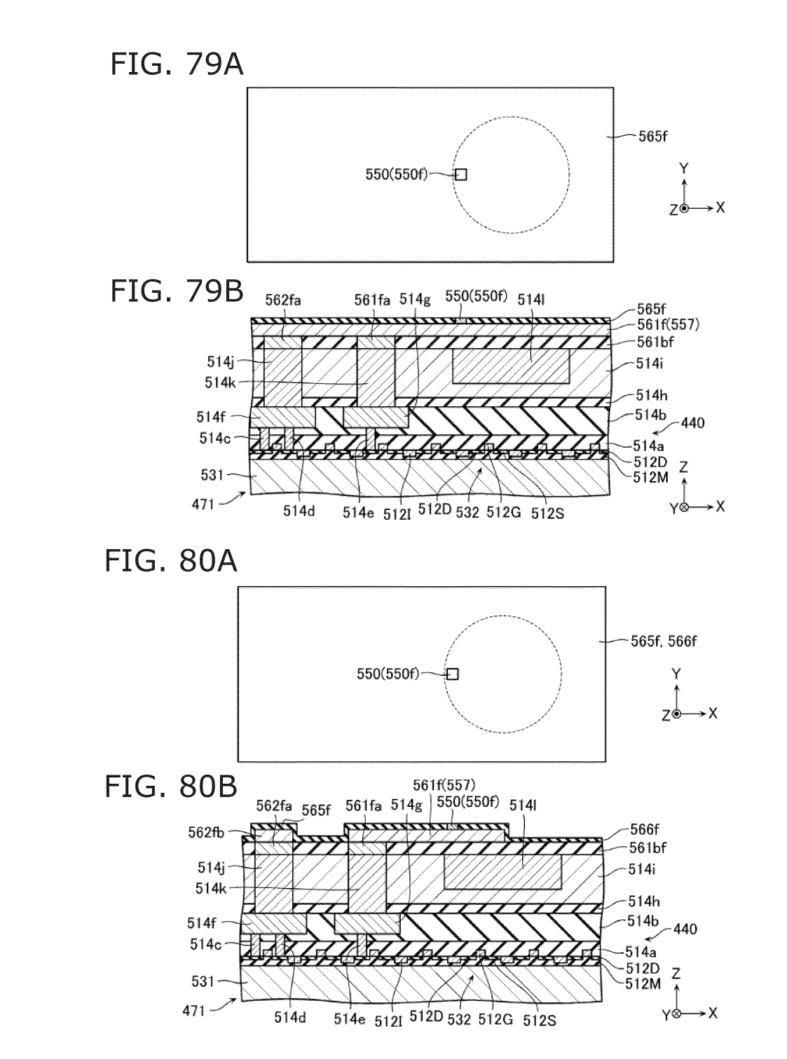

As shown in FIGS. 79A and 79B, the stacked film 550f is processed into a prescribed shape. An insulating film 565f constituting an insulating layer 565 is formed thereon. The insulating film 565f can be formed from e.g. silicon oxide (SiO₂).

As shown in FIGS. 80A and 80B, part of the insulating film 565f is removed. The conductive layer 561f is processed into a prescribed shape. Thus, a wiring 557 is formed. At this time, part of the conductive layer 561f constitutes a connection pillar 562fb electrically connected to the connection pillar 562fa. Furthermore, an insulating film 566f constituting an insulating layer 566 is formed thereon.

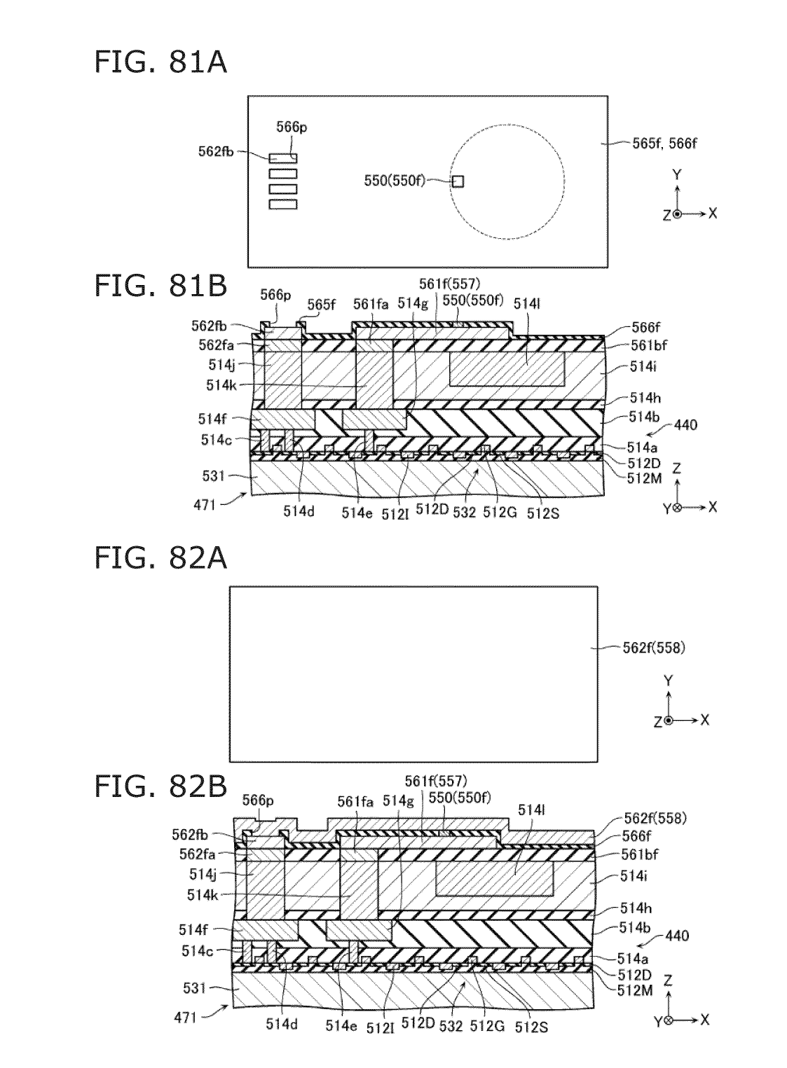

As shown in FIGS. 81A and 81B, an opening 566p is formed in the insulating film 565f. Thus, the connection pillar 562fb is exposed.

As shown in FIGS. 82A and 82B, a conductive layer 562f constituting a wiring 558 is formed on the upper surface. Part of the conductive layer 562f is electrically connected to the connection pillar 562fb.

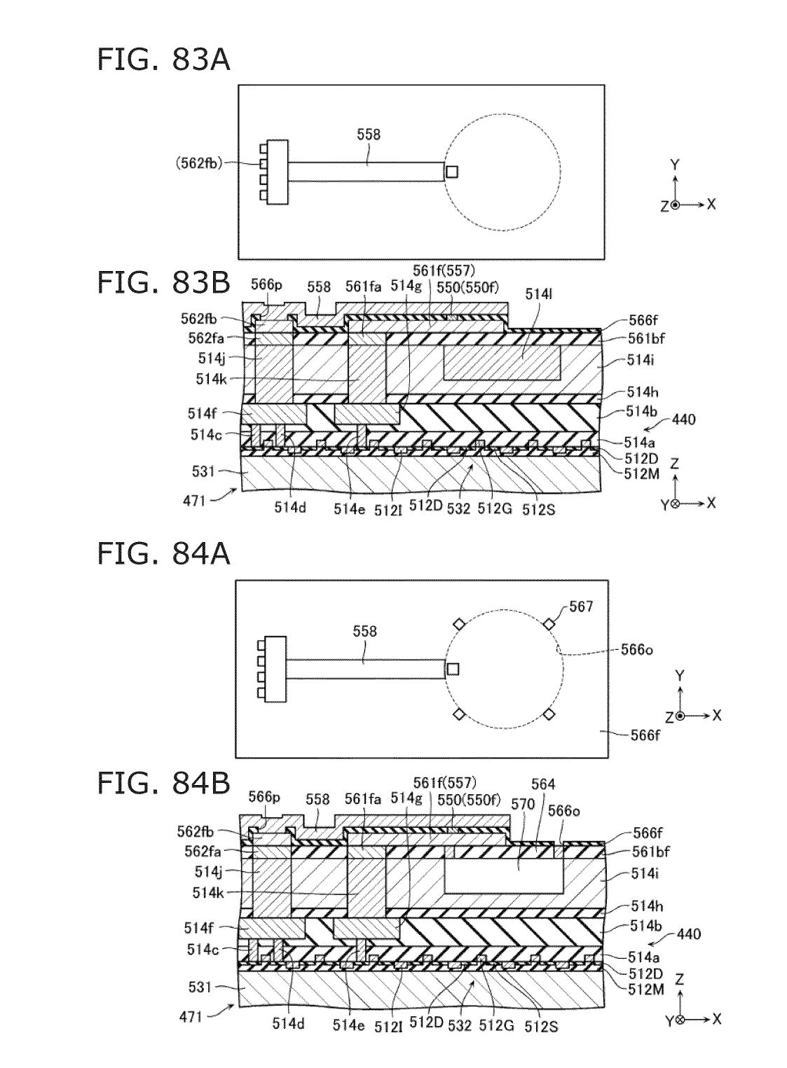

As shown in FIGS. 83A and 83B, the conductive layer 562f is processed into a prescribed shape. Thus, a wiring 558 is formed. The wiring 558 is electrically connected to the connection pillar 562fb.

As shown in FIGS. 84A and 84B, an opening 566o having a prescribed shape is formed in the insulating film 566f. The insulating film 561bf is processed through the opening 566o. Furthermore, the sacrificial layer 5141 is removed through the opening 566o. Thus, a hollow part 570 is formed. The removal of the sacrificial layer 5141 can be performed by e.g. wet etching technique.

In the case where the fixing part 567 is shaped like a ring, for instance, the space between the film part 564 and the edge of the non-hollow part above the hollow part 570 is filled with an insulating film.

Thus, a pressure sensor 440 is formed as described above.

### Fifth Embodiment

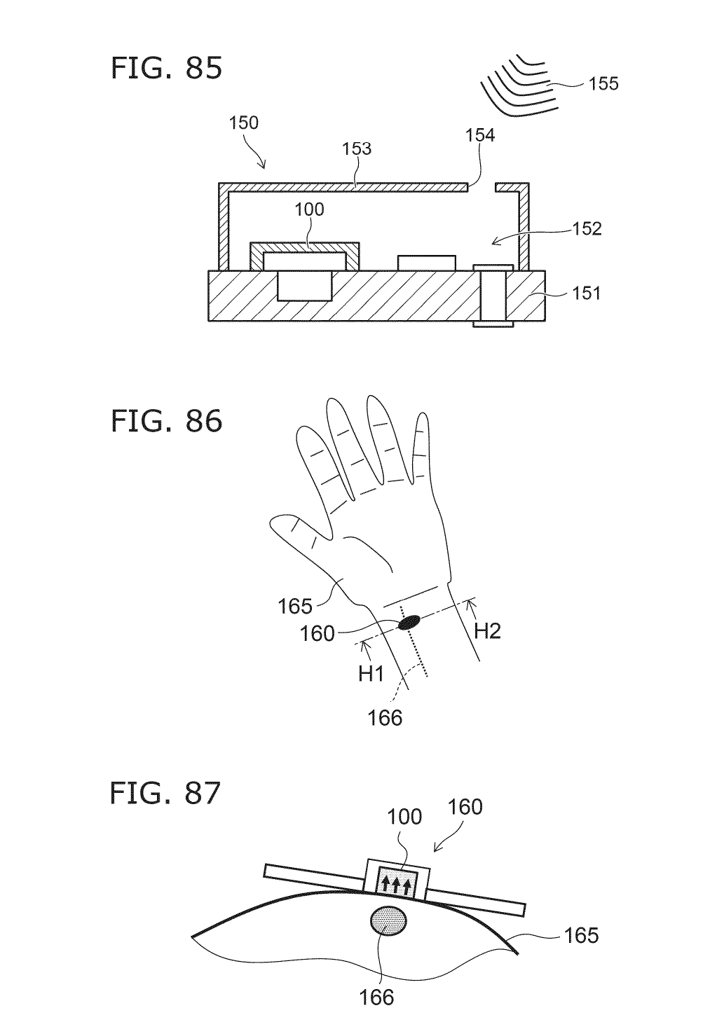

Next, a fifth embodiment is described with reference to FIG. 85. FIG. 85 is a schematic sectional view illustrating a microphone 150 according to this embodiment. The pressure sensor 100 installed with the strain sensing element 200 according to the first to third embodiments can be installed on e.g. a microphone.

The microphone 150 according to this embodiment includes a printed circuit board 151, an electronic circuit 152, and a cover 153. The pressure sensor 100 is installed on the printed circuit board 151. The electronic circuit 152 is installed on the printed circuit board 151. The cover 153 covers the pressure sensor 100 and the electronic circuit 152 in conjunction with the printed circuit board 151. The pressure sensor 100 is a pressure sensor installed with the strain sensing element 200 according to the first to third embodiments.

The cover 153 is provided with an acoustic hole 154. A sound wave 155 is incident therethrough. When a sound wave 155 is incident into the cover 153, the sound wave 155 is sensed by the pressure sensor 100. The electronic circuit 152 passes a current in e.g. the strain sensing element installed on the pressure sensor 100 to detect the change of the resistance of the pressure sensor 100. The electronic circuit 152 may amplify this current by e.g. an amplifier circuit.

The pressure sensor installed with the strain sensing element 200 according to the first to third embodiments has high sensitivity. Thus, the microphone 150 installed with this pressure sensor can detect the sound wave 155 with high sensitivity.

### Sixth Embodiment

Next, a sixth embodiment is described with reference to FIGS. 86 and 87. FIG. 86 is a schematic view illustrating a blood pressure sensor 160 according to the sixth embodiment. FIG. 87 is a schematic sectional view taken along H1-H2 of the blood pressure sensor 160. The pressure sensor 100 installed with the strain sensing element 200 according to the first to third embodiments can be installed on e.g. the blood pressure sensor 160.

As shown in FIG. 86, the blood pressure sensor 160 is affixed onto e.g. an arterial vessel 166 of a human arm 165. As shown in FIG. 87, the blood pressure sensor 160 is installed with the pressure sensor 100 installed with the strain sensing element 200 according to the first to third embodiments. Thus, the blood pressure sensor 160 can measure the blood pressure.

The pressure sensor 100 installed with the strain sensing element 200 according to the first to third embodiments has high sensitivity. Thus, the blood pressure sensor 160 installed with this pressure sensor can continuously detect the blood pressure with high sensitivity.

### Seventh Embodiment

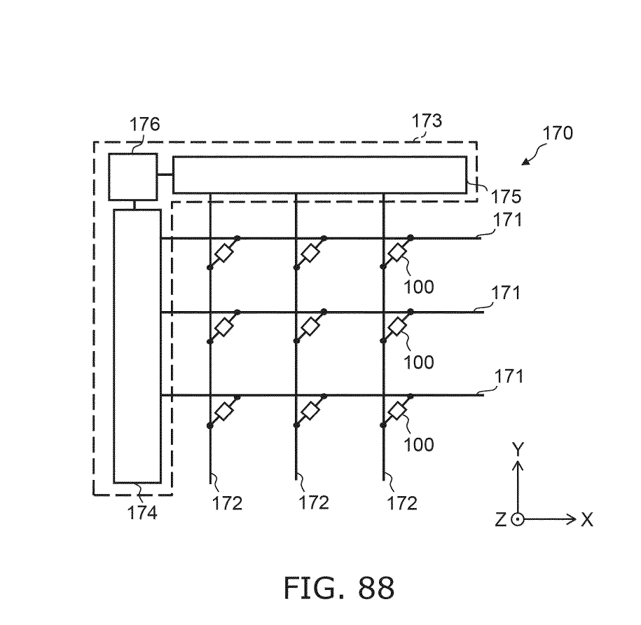

Next, a seventh embodiment is described with reference to FIG. 88. FIG. 88 is a schematic circuit diagram illustrating a touch panel 170 according to the seventh embodiment. The touch panel 170 is installed in at least one of the inside and the outside of a display, not shown.

The touch panel 170 includes a plurality of pressure sensors 100 arranged in a matrix, a plurality of first wirings 171, a plurality of second wirings 172, and a control section 173. The plurality of first wirings 171 are arranged in the Y-direction and each connected to one end of a plurality of pressure sensors 100 arranged in the X-direction. The plurality of second wirings 172 are arranged in the X-direction and each connected to the other end of a plurality of pressure sensors 100 arranged in the Y-direction. The control section 173 controls the plurality of first wirings 171 and the plurality of second wirings 172. The pressure sensor 100 is the pressure sensor according to the first to third embodiments.

The control section 173 includes a first control circuit 174 for controlling the first wirings 171, a second control circuit 175 for controlling the second wirings 172, and a third control circuit 176 for controlling the first control circuit 174 and the second control circuit 175.

For instance, the control section 173 passes a current in the pressure sensors 100 through the plurality of first wirings 171 and the plurality of second wirings 172. Here, when a touch screen, not shown, is pressed, the pressure sensor 100 changes the resistance of the strain sensing element in response to the pressure. The control section 173 detects this change of the resistance. Thus, the control section 173 identifies the position of the pressure sensor 100 having detected the pressure of pressing.

The pressure sensor 100 installed with the strain sensing element 200 according to the first to third embodiments has high sensitivity. Thus, the touch panel 170 installed with this pressure sensor can detect the pressure of pressing with high sensitivity. Furthermore, the size of the pressure sensor 100 is small. Thus, a touch panel 170 with high resolution can be manufactured.

The touch panel 170 may include a detection element for detecting a touch besides the pressure sensor 100.

Besides the fourth to seventh embodiments, the pressure sensor 100 is applicable to various pressure sensor devices such as a barometric pressure sensor and a tire pneumatic sensor.

The embodiments can provide a strain sensing element, a pressure sensor, a microphone, a blood pressure sensor, and a touch panel having high sensitivity.

In this specification, the term “electrically connected” includes not only the case of being connected in direct contact, but also the case of being connected through e.g. another conductive member.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components such as the film part, the first electrode, the second electrode, the stacked body, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all strain sensing elements, pressure sensors, and microphones practicable by an appropriate design modification by one skilled in the art based on the strain sensing elements, pressure sensors, and microphones described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A strain sensing element to be provided at a deformable film part, the element comprising:
a stacked body including a first magnetic layer, a second magnetic layer, and an intermediate layer provided between the first magnetic layer and the second magnetic layer, a magnetization direction of the first magnetic layer configured to change in accordance with a deformation of the film part;
a first electrode including a first alloy layer including a first alloy including Ta and Mo, the first electrode being electrically connected to the stacked body; and
a second electrode electrically connected to the stacked body.

2. The element according to claim 1, wherein the first alloy includes Ta₁₀₀₋ₓMoₓ (13 at. %≦x≦70 at. %).

3. The element according to claim 1, wherein the first alloy has a body-centered cubic structure.

4. The element according to claim 1, wherein an absolute value of residual stress of the first electrode is 100 megapascals or less.

5. The element according to claim 1, wherein
the stacked body is provided between the second electrode and the film part, and
the first electrode is provided between the stacked body and the film part.

6. The element according to claim 1, wherein the first electrode further includes a first intermediate metal layer including at least one of Cu and a first copper alloy, and the first copper alloy includes Cu and Ag.

7. The element according to claim 6, wherein the first alloy layer is provided between the first intermediate metal layer and the stacked body.

8. The element according to claim 6, wherein
the first electrode further includes a first metal layer provided between the first intermediate metal layer and the film part, and
the first metal layer includes a first Ta alloy including Ta and Mo.

9. The element according to claim 1, wherein the second electrode includes a second alloy layer including a second alloy including Ta and Mo.

10. The element according to claim 9, wherein
the second electrode further includes a second intermediate metal layer provided between the second alloy layer and the stacked body,
the second intermediate metal layer includes at least one of Cu and a second copper alloy, and the second copper alloy includes Cu and Ag.

11. The element according to claim 10, wherein
the second electrode further includes a second metal layer provided between the stacked body and the second intermediate metal layer, and
the second metal layer includes a second Ta alloy including Ta and Mo.

12. The element according to claim 1, wherein at least part of the first magnetic layer is amorphous.

13. The element according to claim 1, wherein the first magnetic layer includes boron.

14. The element according to claim 1, wherein boron concentration in at least part of the first magnetic layer is 5 at. % or more and 35 at. % or less.

15. The element according to claim 1, wherein the intermediate layer includes at least one of oxide, nitride, and oxynitride.

16. The element according to claim 1, wherein the intermediate layer includes magnesium oxide.

17. The element according to claim 1, wherein
the stacked body further includes an underlayer provided between the second magnetic layer and the first electrode, and
at least part of the underlayer is amorphous.

18. The element according to claim 1, wherein
the stacked body further includes an underlayer provided between the second magnetic layer and the first electrode, and
the underlayer includes a first layer including Cu and a second layer including Ta, the second layer being provided on the first layer.

19. A pressure sensor comprising:
the film part;
a support part supporting the film part; and
one or a plurality of the strain sensing elements according to claim 1 provided on the film part.

20. A microphone comprising:
the pressure sensor according to claim 19.
